(19) United States
(12) Patent Application Publication
(10) Pub. No.: US 2025/0350778 A1
(43) Pub. Date: Nov. 13, 2025

(54) Determining Motion Vector Difference Symbols Selected for Prediction

(71) Applicant: Ofinno, LLC, Reston, VA (US)

(72) Inventors: Alexey Konstantinovich Filippov, Khimki (RU); Vasily Alexeevich Rufitskiy, Vladimir (RU); Kirill Suverov, Yerevan (AM); Esmael Hejazi Dinan, McLean, VA (US)

(73) Assignee: Ofinno, LLC, Reston, VA (US)

(21) Appl. No.: 19/272,815

(22) Filed: Jul. 17, 2025

Related U.S. Application Data
(63) Continuation of application No. PCT/US2024/011806, filed on Jan. 17, 2024.
(60) Provisional application No. 63/439,521, filed on Jan. 17, 2023.
(60) Provisional application No. 63/457,717, filed on Apr. 6, 2023.

(51) Int. Cl. H04N 19/91; H04N 19/139; H04N 19/176

(52) U.S. Cl. CPC H04N 19/91; H04N 19/139; H04N 19/176

(57) ABSTRACT

A decoder determines first symbols and second symbols available for prediction of respective first and second motion vector difference (MVD) components of a first reference picture list (RPL) and a second RPL. The decoder selects, based on the first and the second symbols available for prediction, one of the first RPL or the second RPL. The decoder selects, within each of the first MVD components of the selected RPL, a subset of most significant symbols for decoding. The decoder entropy decodes, from a bitstream for each symbol of the selected subset, an indication of whether a value of the each symbol is equal to a value of a corresponding symbol of an MVD predictor. The decoder determines, for the each symbol of the selected subset, a value of the each symbol based on the indication and a value of the corresponding symbol of the MVD predictor.

### CROSS-REFERENCE TO RELATED APPLICATIONS

This application is a continuation of International Application No. PCT/US2024/011806, filed Jan. 17, 2024, which claims the benefit of U.S. Provisional Application No. 63/439,521, filed Jan. 17, 2023, and U.S. Provisional Application No. 63/457,717, filed Apr. 6, 2023, all of which are hereby incorporated by reference in their entireties.

### BRIEF DESCRIPTION OF THE DRAWINGS

Examples of several of the various embodiments of the present disclosure are described herein with reference to the drawings.

FIG. 1 illustrates an exemplary video coding/decoding system in which embodiments of the present disclosure may be implemented.

FIG. 2 illustrates an exemplary encoder in which embodiments of the present disclosure may be implemented.

FIG. 3 illustrates an exemplary decoder in which embodiments of the present disclosure may be implemented.

FIG. 4 illustrates an example quadtree partitioning of a coding tree block (CTB) in accordance with embodiments of the present disclosure.

FIG. 5 illustrates a corresponding quadtree of the example quadtree partitioning of the CTB in FIG. 4 in accordance with embodiments of the present disclosure.

FIG. 6 illustrates example binary and ternary tree partitions in accordance with embodiments of the present disclosure.

FIG. 7 illustrates an example quadtree+multi-type tree partitioning of a CTB in accordance with embodiments of the present disclosure.

FIG. 8 illustrates a corresponding quadtree+multi-type tree of the example quadtree+multi-type tree partitioning of the CTB in FIG. 7 in accordance with embodiments of the present disclosure.

FIG. 9 illustrates an example set of reference samples determined for intra prediction of a current block being encoded or decoded in accordance with embodiments of the present disclosure.

FIG. 10A illustrates the 35 intra prediction modes supported by HEVC in accordance with embodiments of the present disclosure.

FIG. 10B illustrates the 67 intra prediction modes supported by HEVC in accordance with embodiments of the present disclosure.

FIG. 11 illustrates the current block and reference samples from FIG. 9 in a two-dimensional x, y plane in accordance with embodiments of the present disclosure.

FIG. 12 illustrates an example angular mode prediction of the current block from FIG. 9 in accordance with embodiments of the present disclosure.

FIG. 13A illustrates an example of inter prediction performed for a current block in a current picture being encoded in accordance with embodiments of the present disclosure.

FIG. 13B illustrates an example horizontal component and vertical component of a motion vector in accordance with embodiments of the present disclosure.

FIG. 14 illustrates an example of bi-prediction, performed for a current block in accordance with embodiments of the present disclosure.

FIG. 15A illustrates an example location of five spatial candidate neighboring blocks relative to a current block being coded in accordance with embodiments of the present disclosure.

FIG. 15B illustrates an example location of two temporal, co-located blocks relative to a current block being coded in accordance with embodiments of the present disclosure.

FIG. 16 illustrates an example of IBC applied for screen content in accordance with embodiments of the present disclosure.

FIG. 17 illustrates an example implementation of a context-based adaptive binary arithmetic coding (CABAC) encoder in accordance with embodiments of the present disclosure.

FIG. 18A illustrates an example of IBC in accordance with embodiments of the present disclosure.

FIG. 18B illustrates example BVD candidates used to entropy encode a magnitude symbol of a BVD in accordance with embodiments of the present disclosure.

FIG. 18C illustrates an example of entropy encoding an indication of whether a value of a magnitude symbol of a BVD matches a value of the magnitude symbol of a BVD candidate used as a predictor of the BVD in accordance with embodiments of the present disclosure.

FIG. 18D illustrates an example of entropy decoding an indication of whether a value of a magnitude symbol of a BVD matches a value of the magnitude symbol of a BVD candidate used as a predictor of the BVD and using the indication to determine a magnitude symbol of the BVD in accordance with embodiments of the present disclosure.

FIG. 19 illustrates a flowchart of a method in accordance with embodiments of the present disclosure.

FIG. 20 illustrates a flowchart of a method in accordance with embodiments of the present disclosure.

FIG. 21 illustrates a flowchart of a method in accordance with embodiments of the present disclosure.

FIG. 22 illustrates a flowchart of a method in accordance with embodiments of the present disclosure.

FIG. 23A illustrates examples of candidate vectors for a translational model of motion compensation, according to some embodiments.

FIG. 23B illustrates examples of candidate vectors for a translational model of motion compensation, according to some embodiments.

FIG. 23C illustrates examples of candidate vectors for a translational model of motion compensation, according to some embodiments.

FIG. 24 illustrates an example of candidate vectors, from both L0 MVDs and/or L1 MVDs for an affine model of motion compensation, where MVD signs and/or magnitude symbols are predicted, according to some embodiments.

FIG. 25 illustrates an example of selection of bins to be predicted for a subset of non-zero MV components, with an example total bin prediction target of 6 bins, according to some embodiments.

FIG. 26 illustrates a flowchart of a method for selecting a reference picture list (RPL) for prediction of symbols of an MVD, according to some embodiments.

FIG. 27 illustrates an example of a number of bins for 6 MVD components in a first reference picture list (RPL₀) and a second reference picture list (RPL₁), according to some embodiments.

FIG. 28A illustrates an example of positions of bins of the 6 MVD components obtained for prediction from RPL₀ and RPL₁ for an example total bin prediction target of 6 bins, according to some embodiments.

FIG. 28B illustrates an example of selecting positions of bins for prediction among the 6 MVD components obtained from RPL₀ and RPL₁ according to an example total bin prediction target of 6 bins, according to some embodiments.

FIG. 29 illustrates a flowchart of a method for selecting, within each of one or more MVD components of a selected RPL, a subset of most significant symbols for prediction according to some embodiments.

FIG. 30 illustrates examples of positions of bins of MVD components obtained for prediction from RPL₀ and RPL₁, as well as additional reference blocks according to a multi-hypothesis prediction example, with a total bin prediction target of 6 bins, according to some embodiments.

FIGS. 31A-B illustrate examples of prioritizing sign and suffix bins for predicting MVDs for a 4-parameter affine motion model and a 6-parameter affine motion model, according to some embodiments.

FIGS. 32A-B illustrate examples of determining weighting values for significance levels of bin symbols from RPL₀ and RPL₁ based on a binary coding weight (BCW) or multi-hypothesis prediction (MHP) index, according to some embodiments.

FIG. 33 illustrates a flowchart of a method for selecting a reference picture list (RPL) and selecting within each MVD component of the selected RPL a subset of most significant symbols for prediction in accordance with embodiments of the present disclosure.

FIG. 34 illustrates a flowchart of a method for selecting a reference picture list (RPL) and selecting within each MVD component of the selected RPL a subset of most significant symbols for decoding in accordance with embodiments of the present disclosure.

FIG. 35 illustrates a block diagram of an example computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Representing a video sequence in digital form may require a large number of bits. The data size of a video sequence in digital form may be too large for storage and/or transmission in many applications. Video encoding may be used to compress the size of a video sequence to provide for more efficient storage and/or transmission. Video decoding may be used to decompress a compressed video sequence for display and/or other forms of consumption.

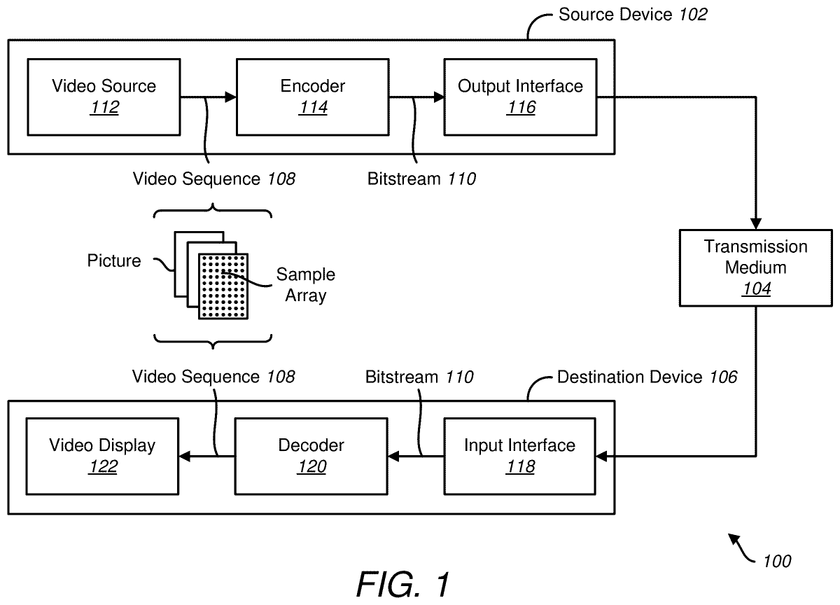

FIG. 1 illustrates an exemplary video coding/decoding system 100 in which embodiments of the present disclosure may be implemented. Video coding/decoding system 100 comprises a source device 102, a transmission medium 104, and a destination device 106. Source device 102 encodes a video sequence 108 into a bitstream 110 for more efficient storage and/or transmission. Source device 102 may store and/or transmit bitstream 110 to destination device 106 via transmission medium 104. Destination device 106 decodes bitstream 110 to display video sequence 108. Destination device 106 may receive bitstream 110 from source device 102 via transmission medium 104. Source device 102 and destination device 106 may be any one of a number of different devices, including a desktop computer, laptop computer, tablet computer, smart phone, wearable device, television, camera, video gaming console, set-top box, or video streaming device.

To encode video sequence 108 into bitstream 110, source device 102 may comprise a video source 112, an encoder 114, and an output interface 116. Video source 112 may provide or generate video sequence 108 from a capture of a natural scene and/or a synthetically generated scene. A synthetically generated scene may be a scene comprising computer generated graphics or screen content. Video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A shown in FIG. 1, a video sequence, such as video sequence 108, may comprise a series of pictures (also referred to as frames). A video sequence may achieve the impression of motion when a constant or variable time is used to successively present pictures of the video sequence. A picture may comprise one or more sample arrays of intensity values. The intensity values may be taken at a series of regularly spaced locations within a picture. A color picture typically comprises a luminance sample array and two chrominance sample arrays. The luminance sample array may comprise intensity values representing the brightness (or luma component, Y) of a picture. The chrominance sample arrays may comprise intensity values that respectively represent the blue and red components of a picture (or chroma components, Cb and Cr) separate from the brightness. Other color picture sample arrays are possible based on different color schemes (e.g., an RGB color scheme). For color pictures, a pixel may refer to all three intensity values for a given location in the three sample arrays used to represent color pictures. A monochrome picture comprises a single, luminance sample array. For monochrome pictures, a pixel may refer to the intensity value at a given location in the single, luminance sample array used to represent monochrome pictures.

Encoder 114 may encode video sequence 108 into bitstream 110. To encode video sequence 108, encoder 114 may apply one or more prediction techniques to reduce redundant information in video sequence 108. Redundant information is information that may be predicted at a decoder and therefore may not be needed to be transmitted to the decoder for accurate decoding of the video sequence. For example, encoder 114 may apply spatial prediction (e.g., intra-frame or intra prediction), temporal prediction (e.g., inter-frame prediction or inter prediction), inter-layer prediction, and/or other prediction techniques to reduce redundant information in video sequence 108. Before applying the one or more prediction techniques, encoder 114 may partition pictures of video sequence 108 into rectangular regions referred to as blocks. Encoder 114 may then encode a block using one or more of the prediction techniques.

For temporal prediction, encoder 114 may search for a block similar to the block being encoded in another picture (also referred to as a reference picture) of video sequence 108. The block determined during the search (also referred to as a prediction block) may then be used to predict the block being encoded. For spatial prediction, encoder 114 may form a prediction block based on data from reconstructed neighboring samples of the block to be encoded within the same picture of video sequence 108. A reconstructed sample refers to a sample that was encoded and then decoded. Encoder 114 may determine a prediction error (also referred to as a residual) based on the difference between a block being encoded and a prediction block. The prediction error may represent non-redundant information that may be transmitted to a decoder for accurate decoding of a video sequence.

Encoder 114 may apply a transform to the prediction error (e.g. a discrete cosine transform (DCT)) to generate transform coefficients. Encoder 114 may form bitstream 110 based on the transform coefficients and other information used to determine prediction blocks (e.g., prediction types, motion vectors, and prediction modes). In some examples, encoder 114 may perform one or more of quantization and entropy coding of the transform coefficients and/or the other information used to determine prediction blocks before forming bitstream 110 to further reduce the number of bits needed to store and/or transmit video sequence 108.

Output interface 116 may be configured to write and/or store bitstream 110 onto transmission medium 104 for transmission to destination device 106. In addition or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one more networks (e.g., the Internet) or file servers configured to store and/or transmit encoded video data.

To decode bitstream 110 into video sequence 108 for display, destination device 106 may comprise an input interface 118, a decoder 120, and a video display 122. Input interface 118 may be configured to read bitstream 110 stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode video sequence 108 from encoded bitstream 110. To decode video sequence 108, decoder 120 may generate prediction blocks for pictures of video sequence 108 in a similar manner as encoder 114 and determine prediction errors for the blocks. Decoder 120 may generate the prediction blocks using prediction types, prediction modes, and/or motion vectors received in bitstream 110 and determine the prediction errors using transform coefficients also received in bitstream 110. Decoder 120 may determine the prediction errors by weighting transform basis functions using the transform coefficients. Decoder 120 may combine the prediction blocks and prediction errors to decode video sequence 108. In some examples, decoder 120 may decode a video sequence that approximates video sequence 108 due to, for example, lossy compression of video sequence 108 by encoder 114 and/or errors introduced into encoded bitstream 110 during transmission to destination device 106.

Video display 122 may display video sequence 108 to a user. Video display 122 may comprise a cathode rate tube (CRT) display, liquid crystal display (LCD), a plasma display, light emitting diode (LED) display, or any other display device suitable for displaying video sequence 108.

It should be noted that video encoding/decoding system 100 is presented by way of example and not limitation. In the example of FIG. 1, video encoding/decoding system 100 may have other components and/or arrangements. For example, video source 112 may be external to source device 102. Similarly, video display 122 may be external to destination device 106 or omitted altogether where video sequence is intended for consumption by a machine and/or storage device. In another example, source device 102 may further comprise a video decoder and destination device 106 may comprise a video encoder. In such an example, source device 102 may be configured to further receive an encoded bitstream from destination device 106 to support two-way video transmission between the devices.

In the example of FIG. 1, encoder 114 and decoder 120 may operate according to any one of a number of proprietary or industry video coding standards. For example, encoder 114 and decoder 120 may operate according to one or more of International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC), ITU-T H.265 and MPEG-I Part 3 (also known as Versatile Video Coding (VVC)), the WebM VP8 and VP9 codecs, and AOMedia Video 1 (AV1).

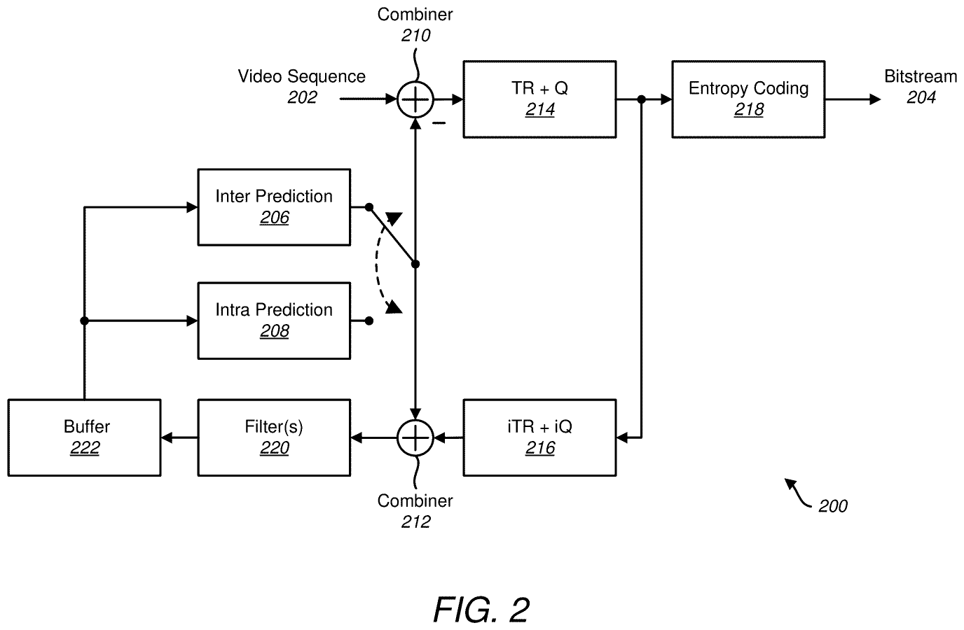

FIG. 2 illustrates an exemplary encoder 200 in which embodiments of the present disclosure may be implemented. Encoder 200 encodes a video sequence 202 into a bitstream 204 for more efficient storage and/or transmission. Encoder 200 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Encoder 200 comprises an inter prediction unit 206, an intra prediction unit 208, combiners 210 and 212, a transform and quantization unit (TR+Q) unit 214, an inverse transform and quantization unit (iTR+iQ) 216, entropy coding unit 218, one or more filters 220, and a buffer 222.

Encoder 200 may partition the pictures of video sequence 202 into blocks and encode video sequence 202 on a block-by-block basis. Encoder 200 may perform a prediction technique on a block being encoded using either inter prediction unit 206 or intra prediction unit 208. Inter prediction unit 206 may perform inter prediction by searching for a block similar to the block being encoded in another, reconstructed picture (also referred to as a reference picture) of video sequence 202. A reconstructed picture refers to a picture that was encoded and then decoded. The block determined during the search (also referred to as a prediction block) may then be used to predict the block being encoded to remove redundant information. Inter prediction unit 206 may exploit temporal redundancy or similarities in scene content from picture to picture in video sequence 202 to determine the prediction block. For example, scene content between pictures of video sequence 202 may be similar except for differences due to motion or affine transformation of the screen content over time.

Intra prediction unit 208 may perform intra prediction by forming a prediction block based on data from reconstructed neighboring samples of the block to be encoded within the same picture of video sequence 202. A reconstructed sample refers to a sample that was encoded and then decoded. Intra prediction unit 208 may exploit spatial redundancy or similarities in scene content within a picture of video sequence 202 to determine the prediction block. For example, the texture of a region of scene content in a picture may be similar to the texture in the immediate surrounding area of the region of the scene content in the same picture.

After prediction, combiner 210 may determine a prediction error (also referred to as a residual) based on the difference between the block being encoded and the prediction block. The prediction error may represent non-redundant information that may be transmitted to a decoder for accurate decoding of a video sequence.

Transform and quantization unit 214 may transform and quantize the prediction error. Transform and quantization unit 214 may transform the prediction error into transform coefficients by applying, for example, a DCT to reduce correlated information in the prediction error. Transform and quantization unit 214 may quantize the coefficients by mapping data of the transform coefficients to a predefined set of representative values. Transform and quantization unit 214 may quantize the coefficients to reduce irrelevant information in bitstream 204. Irrelevant information is information that may be removed from the coefficients without producing visible and/or perceptible distortion in video sequence 202 after decoding.

Entropy coding unit 218 may apply one or more entropy coding methods to the quantized transform coefficients to further reduce the bit rate. For example, entropy coding unit 218 may apply context adaptive variable length coding (CAVLC), context adaptive binary arithmetic coding (CABAC), and syntax-based context-based binary arithmetic coding (SBAC). The entropy coded coefficients are packed to form bitstream 204.

Inverse transform and quantization unit 216 may inverse quantize and inverse transform the quantized transform coefficients to determine a reconstructed prediction error. Combiner 212 may combine the reconstructed prediction error with the prediction block to form a reconstructed block. Filter(s) 220 may filter the reconstructed block using, for example, a deblocking filter and/or a sample-adaptive offset (SAO) filter. Buffer 222 may store the reconstructed block for prediction of one or more other blocks in the same and/or different picture of video sequence 202.

Although not shown in FIG. 2, encoder 200 further comprises an encoder control unit configured to control one or more of the units of encoder 200 shown in FIG. 2. The encoder control unit may control the one or more units of encoder 200 such that bitstream 204 is generated in conformance with the requirements of any one of a number of proprietary or industry video coding standards. For example, The encoder control unit may control the one or more units of encoder 200 such that bitstream 204 is generated in conformance with one or more of ITU-T H.263, AVC, HEVC, WC, VP8, VP9, and AV1 video coding standards.

Within the constraints of a proprietary or industry video coding standard, the encoder control unit may attempt to minimize or reduce the bitrate of bitstream 204 and maximize or increase the reconstructed video quality. For example, the encoder control unit may attempt to minimize or reduce the bitrate of bitstream 204 given a level that the reconstructed video quality may not fall below, or attempt to maximize or increase the reconstructed video quality given a level that the bit rate of bitstream 204 may not exceed. The encoder control unit may determine/control one or more of: partitioning of the pictures of video sequence 202 into blocks, whether a block is inter predicted by inter prediction unit 206 or intra predicted by intra prediction unit 208, a motion vector for inter prediction of a block, an intra prediction mode among a plurality of intra prediction modes for intra prediction of a block, filtering performed by filter(s) 220, and one or more transform types and/or quantization parameters applied by transform and quantization unit 214. The encoder control unit may determine/control the above based on how the determination/control effects a rate-distortion measure for a block or picture being encoded. The encoder control unit may determine/control the above to reduce the rate-distortion measure for a block or picture being encoded.

After being determined, the prediction type used to encode a block (intra or inter prediction), prediction information of the block (intra prediction mode if intra predicted, motion vector, etc.), and transform and quantization parameters, may be sent to entropy coding unit 218 to be further compressed to reduce the bit rate. For example, entropy coding unit 218 may apply context adaptive variable length coding (CAVLC), context adaptive binary arithmetic coding (CABAC), and syntax-based context-based binary arithmetic coding (SBAC) to compress the prediction type used to encode a block (intra or inter prediction), prediction information of the block (intra prediction mode if intra predicted, motion vector, etc.), and transform and quantization parameters. The prediction type, prediction information, and transform and quantization parameters may be packed with the prediction error to form bitstream 204.

It should be noted that encoder 200 is presented by way of example and not limitation. In other examples, encoder 200 may have other components and/or arrangements. For example, one or more of the components shown in FIG. 2 may be optionally included in encoder 200, such as entropy coding unit 218 and filters(s) 220.

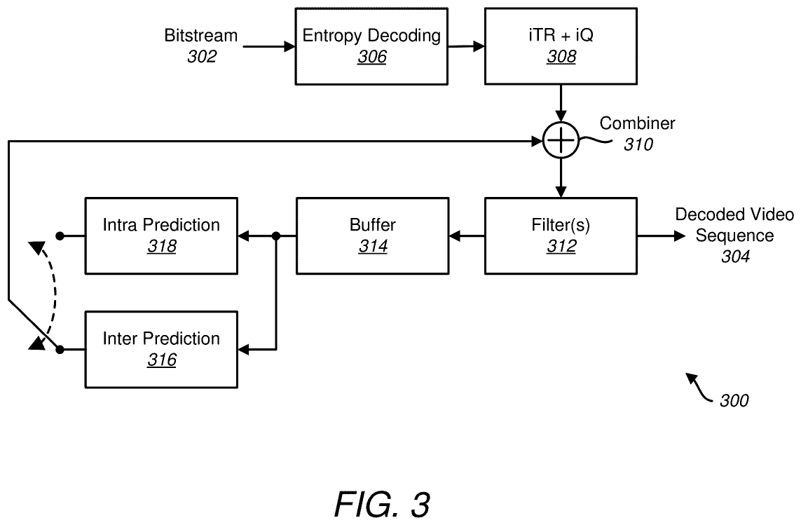

FIG. 3 illustrates an exemplary decoder 300 in which embodiments of the present disclosure may be implemented. Decoder 300 decodes a bitstream 302 into a decoded video sequence 304 for display and/or some other form of consumption. Decoder 300 may be implemented in video coding/decoding system 100 in FIG. 1 or in any one of a number of different devices, including a desktop computer, laptop computer, tablet computer, smart phone, wearable device, television, camera, video gaming console, set-top box, or video streaming device. Decoder 300 comprises an entropy decoding unit 306, an inverse transform and quantization (iTR+iQ) unit 308, a combiner 310, one or more filters 312, a buffer 314, an inter prediction unit 316, and an intra prediction unit 318.

Although not shown in FIG. 3, decoder 300 further comprises a decoder control unit configured to control one or more of the units of decoder 300 shown in FIG. 3. The decoder control unit may control the one or more units of decoder 300 such that bitstream 302 is decoded in conformance with the requirements of any one of a number of proprietary or industry video coding standards. For example, The decoder control unit may control the one or more units of decoder 300 such that bitstream 302 is decoded in conformance with one or more of ITU-T H.263, AVC, HEVC, WVC, VP8, VP9, and AV1 video coding standards.

The decoder control unit may determine/control one or more of: whether a block is inter predicted by inter prediction unit 316 or intra predicted by intra prediction unit 318, a motion vector for inter prediction of a block, an intra prediction mode among a plurality of intra prediction modes for intra prediction of a block, filtering performed by filter(s) 312, and one or more inverse transform types and/or inverse quantization parameters to be applied by inverse transform and quantization unit 308. One or more of the control parameters used by the decoder control unit may be packed in bitstream 302.

Entropy decoding unit 306 may entropy decode the bitstream 302. For example, entropy decoding unit 306 may apply context adaptive variable length coding (CAVLC), context adaptive binary arithmetic coding (CABAC), and syntax-based context-based binary arithmetic coding (SBAC) to decompress the prediction type used to encode a block (intra or inter prediction), prediction information of the block (intra prediction mode if intra predicted, motion vector, etc.), and transform and quantization parameters. Inverse transform and quantization unit 308 may inverse quantize and inverse transform the quantized transform coefficients to determine a decoded prediction error. Combiner 310 may combine the decoded prediction error with a prediction block to form a decoded block. The prediction block may be generated by intra prediction unit 318 or inter prediction unit 316 as described above with respect to encoder 200 in FIG. 2. Filter(s) 312 may filter the decoded block using, for example, a deblocking filter and/or a sample-adaptive offset (SAO) filter. Buffer 314 may store the decoded block for prediction of one or more other blocks in the same and/or different picture of the video sequence in bitstream 302. Decoded video sequence 304 may be output from filter(s) 312 as shown in FIG. 3.

It should be noted that decoder 300 is presented by way of example and not limitation. In other examples, decoder 300 may have other components and/or arrangements. For example, one or more of the components shown in FIG. 3 may be optionally included in decoder 300, such as entropy decoding unit 306 and filters(s) 312.

It should be further noted that, although not shown in FIGS. 2 and 3, each of encoder 200 and decoder 300 may further comprise an intra block copy unit in addition to inter prediction and intra prediction units. The intra block copy unit may perform similar to an inter prediction unit but predict blocks within the same picture. For example, the intra block copy unit may exploit repeated patterns that appear in screen content. Screen content may include, for example, computer generated text, graphics, and animation.

As mentioned above, video encoding and decoding may be performed on a block-by-block basis. The process of partitioning a picture into blocks may be adaptive based on the content of the picture. For example, larger block partitions may be used in areas of a picture with higher levels of homogeneity to improve coding efficiency.

In HEVC, a picture may be partitioned into non-overlapping square blocks, referred to as coding tree blocks (CTBs), comprising samples of a sample array. A CTB may have a size of 2n×2n samples, where n may be specified by a parameter of the encoding system. For example, n may be 4, 5, or 6. A CTB may be further partitioned by a recursive quadtree partitioning into coding blocks (CBs) of half vertical and half horizontal size. The CTB forms the root of the quadtree. A CB that is not split further as part of the recursive quadtree partitioning may be referred to as a leaf-CB of the quadtree and otherwise as a non-leaf CB of the quadtree. A CB may have a minimum size specified by a parameter of the encoding system. For example, a CB may have a minimum size of 4×4, 8×8, 16×16, 32×32, or 64×64 samples. For inter and intra prediction, a CB may be further partitioned into one or more prediction blocks (PBs) for performing inter and intra prediction. A PB may be a rectangular block of samples on which the same prediction type/mode may be applied. For transformations, a CB may be partitioned into one or more transform blocks (TBs). A TB may be a rectangular block of samples that may determine an applied transform size.

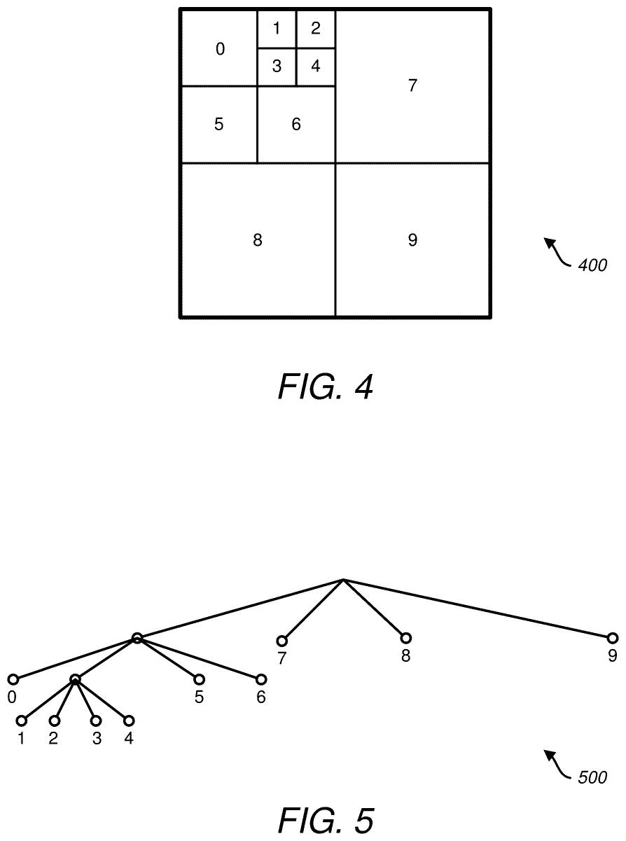

FIG. 4 illustrates an example quadtree partitioning of a CTB 400. FIG. 5 illustrates a corresponding quadtree 500 of the example quadtree partitioning of CTB 400 in FIG. 4. As shown in FIGS. 4 and 5, CTB 400 is first partitioned into four CBs of half vertical and half horizontal size. Three of the resulting CBs of the first level partitioning of CTB 400 are leaf-CBs. The three leaf CBs of the first level partitioning of CTB 400 are respectively labeled 7, 8, and 9 in FIGS. 4 and 5. The non-leaf CB of the first level partitioning of CTB 400 is partitioned into four sub-CBs of half vertical and half horizontal size. Three of the resulting sub-CBs of the second level partitioning of CTB 400 are leaf CBs. The three leaf CBs of the second level partitioning of CTB 400 are respectively labeled 0, 5, and 6 in FIGS. 4 and 5. Finally, the non-leaf CB of the second level partitioning of CTB 400 is partitioned into four leaf CBs of half vertical and half horizontal size. The four leaf CBs are respectively labeled 1, 2, 3, and 4 in FIGS. 4 and 5.

Altogether, CTB 400 is partitioned into 10 leaf CBs respectively labeled 0-9. The resulting quadtree partitioning of CTB 400 may be scanned using a z-scan (left-to-right, top-to-bottom) to form the sequence order for encoding/decoding the CB leaf nodes. The numeric label of each CB leaf node in FIGS. 4 and 5 may correspond to the sequence order for encoding/decoding, with CB leaf node 0 encoded/decoded first and CB leaf node 9 encoded/decoded last. Although not shown in FIGS. 4 and 5, it should be noted that each CB leaf node may comprise one or more PBs and TBs.

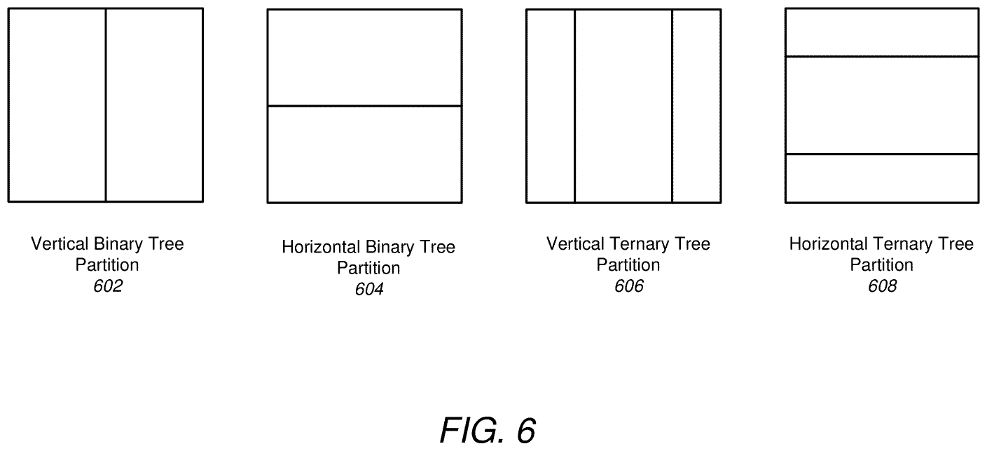

In VVC, a picture may be partitioned in a similar manner as in HEVC. A picture may be first partitioned into non-overlapping square CTBs. The CTBs may then be partitioned by a recursive quadtree partitioning into CBs of half vertical and half horizontal size. In VVC, a quadtree leaf node may be further partitioned by a binary tree or ternary tree partitioning into CBs of unequal sizes. FIG. 6 illustrates example binary and ternary tree partitions. A binary tree partition may divide a parent block in half in either the vertical direction 602 or horizontal direction 604. The resulting partitions may be half in size as compared to the parent block. A ternary tree partition may divide a parent block into three parts in either the vertical direction 606 or horizontal direction 608. The middle partition may be twice as large as the other two end partitions in a ternary tree partition.

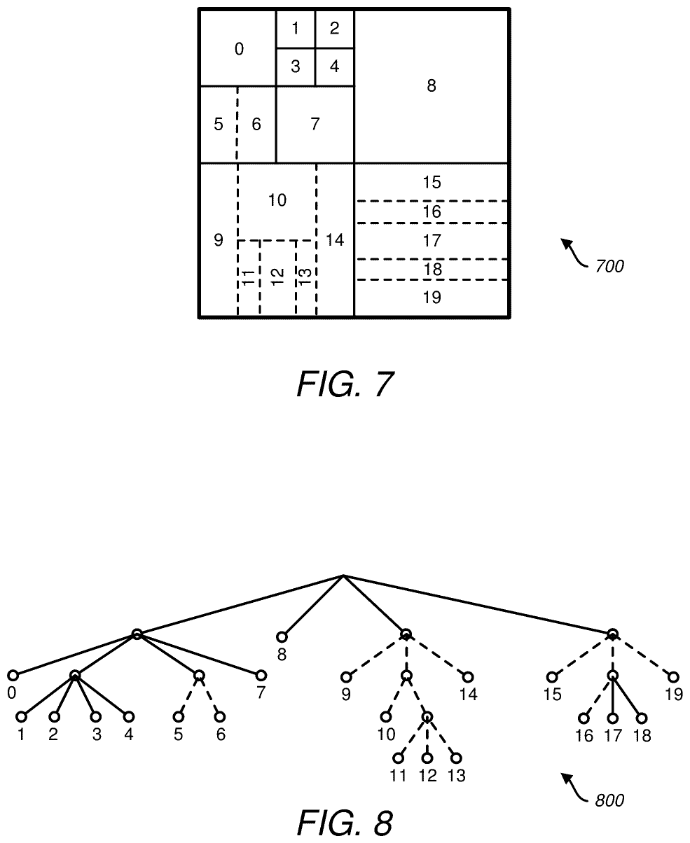

Because of the addition of binary and ternary tree partitioning, in VVC the block partitioning strategy may be referred to as quadtree+multi-type tree partitioning. FIG. 7 illustrates an example quadtree+multi-type tree partitioning of a CTB 700. FIG. 8 illustrates a corresponding quadtree+multi-type tree 800 of the example quadtree+multi-type tree partitioning of CTB 700 in FIG. 7. In both FIGS. 7 and 8, quadtree splits are shown in solid lines and multi-type tree splits are shown in dashed lines. For ease of explanation, CTB 700 is shown with the same quadtree partitioning as CTB 400 described in FIG. 4. Therefore, description of the quadtree partitioning of CTB 700 is omitted. The description of the additional multi-type tree partitions of CTB 700 is made relative to three leaf-CBs shown in FIG. 4 that have been further partitioned using one or more binary and ternary tree partitions. The three leaf-CBs in FIG. 4 that are shown in FIG. 7 as being further partitioned are leaf-CBs 5, 8, and 9.

Starting with leaf-CB 5 in FIG. 4, FIG. 7 shows this leaf-CB partitioned into two CBs based on a vertical binary tree partitioning. The two resulting CBs are leaf-CBs respectively labeled 5 and 6 in FIGS. 7 and 8. With respect to leaf-CB 8 in FIG. 4, FIG. 7 shows this leaf-CB partitioned into three CBs based on a vertical ternary tree partition. Two of the three resulting CBs are leaf-CBs respectively labeled 9 and 14 in FIGS. 7 and 8. The remaining, non-leaf CB is partitioned first into two CBs based on a horizontal binary tree partition, one of which is a leaf-CB labeled 10 and the other of which is further partitioned into three CBs based on a vertical ternary tree partition. The resulting three CBs are leaf-CBs respectively labeled 11, 12, and 13 in FIGS. 7 and 8. Finally, with respect to leaf-CB 9 in FIG. 4, FIG. 7 shows this leaf-CB partitioned into three CBs based on a horizontal ternary tree partition. Two of the three CBs are leaf-CBs respectively labeled 15 and 19 in FIGS. 7 and 8. The remaining, non-leaf CB is partitioned into three CBs based on another horizontal ternary tree partition. The resulting three CBs are all leaf-CBs respectively labeled 16, 17, and 18 in FIGS. 7 and 8.

Altogether, CTB 700 is partitioned into 20 leaf CBs respectively labeled 0-19. The resulting quadtree+multi-type tree partitioning of CTB 700 may be scanned using a z-scan (left-to-right, top-to-bottom) to form the sequence order for encoding/decoding the CB leaf nodes. The numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and TBs.

In addition to specifying various blocks (e.g., CTB, CB, PB, TB), HEVC and WVC further define various units. While blocks may comprise a rectangular area of samples in a sample array, units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bitstream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

It should be noted that the term block may be used to refer to any of a CTB, CB, PB, TB, CTU, CU, PU, or TU in the context of HEVC and WC. It should be further noted that the term block may be used to refer to similar data structures in the context of other video coding standards. For example, the term block may refer to a macroblock in AVC, a macroblock or sub-block in VP8, a superblock or sub-block in VP9, or a superblock or sub-block in AV1.

In intra prediction, samples of a block to be encoded (also referred to as the current block) may be predicted from samples of the column immediately adjacent to the left-most column of the current block and samples of the row immediately adjacent to the top-most row of the current block. The samples from the immediately adjacent column and row may be jointly referred to as reference samples. Each sample of the current block may be predicted by projecting the position of the sample in the current block in a given direction (also referred to as an intra prediction mode) to a point along the reference samples. The sample may be predicted by interpolating between the two closest reference samples of the projection point if the projection does not fall directly on a reference sample. A prediction error (also referred to as a residual) may be determined for the current block based on differences between the predicted sample values and the original sample values of the current block.

At an encoder, this process of predicting samples and determining a prediction error based on a difference between the predicted samples and original samples may be performed for a plurality of different intra prediction modes, including non-directional intra prediction modes. The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block using the intra prediction mode indicated by the encoder and combining the predicted samples with the prediction error.

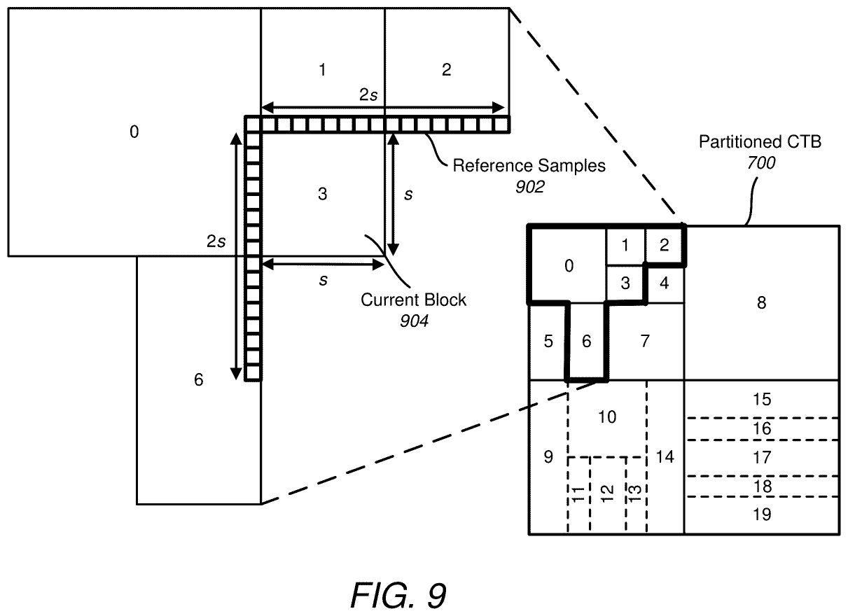

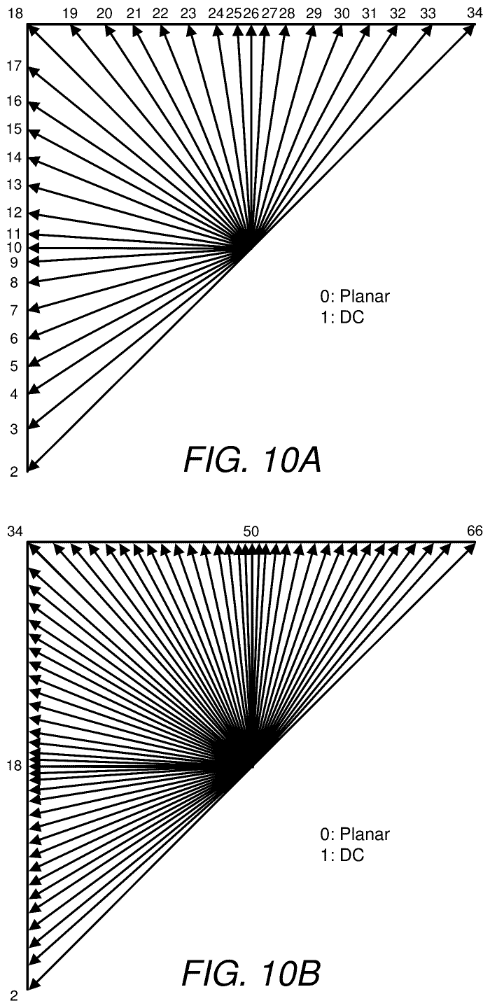

FIG. 9 illustrates an example set of reference samples 902 determined for intra prediction of a current block 904 being encoded or decoded. In FIG. 9, current block 904 corresponds to block 3 of partitioned CTB 700 in FIG. 7. As explained above, the numeric labels 0-19 of the blocks of partitioned CTB 700 may correspond to the sequence order for encoding/decoding the blocks and are used as such in the example of FIG. 9.

Given current block 904 is of w×h samples in size, reference samples 902 may extend over 2w samples of the row immediately adjacent to the top-most row of current block 904, 2h samples of the column immediately adjacent to the left-most column of current block 904, and the top left neighboring corner sample to current block 904. In the example of FIG. 9, current block 904 is square, so w=h=s. For constructing the set of reference samples 902, available samples from neighboring blocks of current block 904 may be used. Samples may not be available for constructing the set of reference samples 902 if, for example, the samples would lie outside the picture of the current block, the samples are part of a different slice of the current block (where the concept of slices are used), and/or the samples belong to blocks that have been inter coded and constrained intra prediction is indicated. When constrained intra prediction is indicated, intra prediction may not be dependent on inter predicted blocks.

In addition to the above, samples that may not be available for constructing the set of reference samples 902 include samples in blocks that have not already been encoded and reconstructed at an encoder or decoded at a decoder based on the sequence order for encoding/decoding. This restriction may allow identical prediction results to be determined at both the encoder and decoder. In FIG. 9, samples from neighboring blocks 0, 1, and 2 may be available to construct reference samples 902 given that these blocks are encoded and reconstructed at an encoder and decoded at a decoder prior to coding of current block 904. This assumes there are no other issues, such as those mentioned above, preventing the availability of samples from neighboring blocks 0, 1, and 2. However, the portion of reference samples 902 from neighboring block 6 may not be available due to the sequence order for encoding/decoding.

Unavailable ones of reference samples 902 may be filled with available ones of reference samples 902. For example, an unavailable reference sample may be filled with a nearest available reference sample determined by moving in a clock-wise direction through reference samples 902 from the position of the unavailable reference. If no reference samples are available, reference samples 902 may be filled with the mid-value of the dynamic range of the picture being coded.

It should be noted that reference samples 902 may be filtered based on the size of current block 904 being coded and an applied intra prediction mode. It should be further noted that FIG. 9 illustrates only one exemplary determination of reference samples for intra prediction of a block. In some proprietary and industry video coding standards, reference samples may be determined in a different manner than discussed above. For example, multiple reference lines may be used in other instances, such as used in WC.

After reference samples 902 are determined and optionally filtered, samples of current block 904 may be intra predicted based on reference samples 902. Most encoders/decoders support a plurality of intra prediction modes in accordance with one or more video coding standards. For example, HEVC supports 35 intra prediction modes, including a planar mode, a DC mode, and 33 angular modes. WVC supports 67 intra prediction modes, including a planar mode, a DC mode, and 65 angular modes. Planar and DC modes may be used to predict smooth and gradually changing regions of a picture. Angular modes may be used to predict directional structures in regions of a picture.

FIG. 10A illustrates the 35 intra prediction modes supported by HEVC. The 35 intra prediction modes are identified by indices 0 to 34. Prediction mode 0 corresponds to planar mode. Prediction mode 1 corresponds to DC mode. Prediction modes 2-34 correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B illustrates the 67 intra prediction modes supported by VVC. The 67 intra prediction modes are identified by indices 0 to 66. Prediction mode 0 corresponds to planar mode. Prediction mode 1 corresponds to DC mode. Prediction modes 2-66 correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Because blocks in WVC may be non-square, some of the intra prediction modes illustrated in FIG. 10B may be adaptively replaced by wide-angle directions.

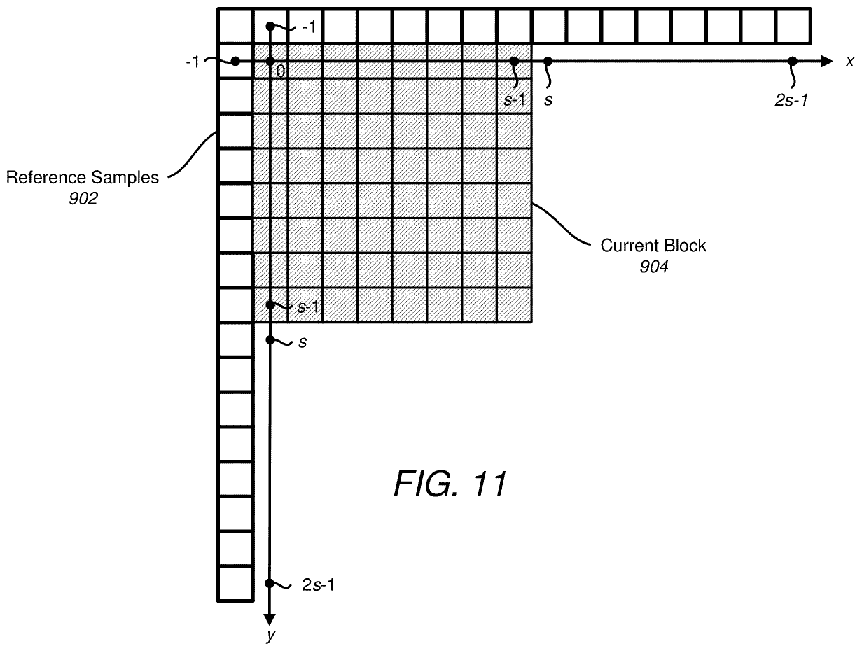

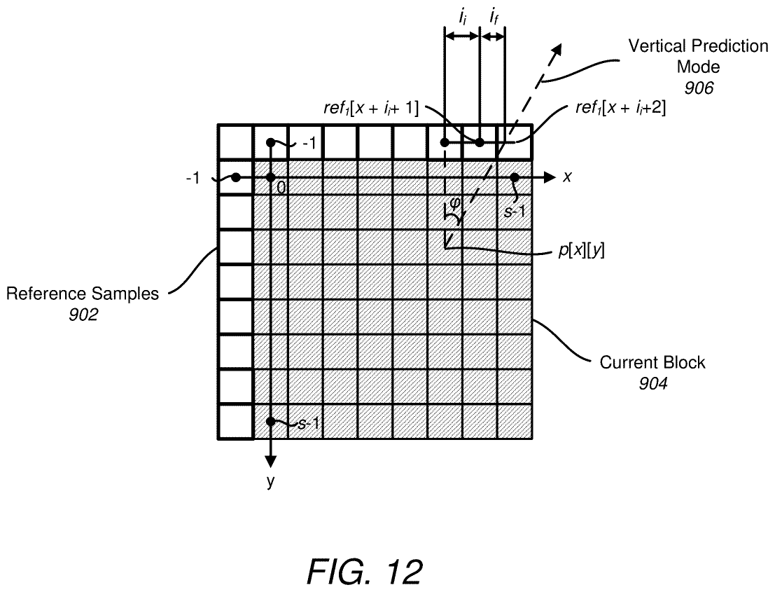

To further describe the application of intra prediction modes to determine a prediction of a current block, reference is made to FIGS. 11 and 12. In FIG. 11, current block 904 and reference samples 902 from FIG. 9 are shown in a two-dimensional x, y plane, where a sample may be referenced as p[x][y]. In order to simplify the prediction process, reference samples 902 may be placed in two, one-dimensional arrays. Reference samples 902 above current block 904 may be placed in the one-dimensional array ref₁[x]:

$${ref}_{1} [ x ] = p [ - 1 + x ] [ - 1 ] , ( x \geq 0 ) \qquad ( 1 )$$

Reference samples 902 to the left of current block 904 may be placed in the one-dimensional array ref₂[x]:

$${ref}_{2} [ y ] = p [ - 1 ] [ - 1 + y ] , ( y \geq 0 ) \qquad ( 2 )$$

For planar mode, a sample at location [x][y] in current block 904 may be predicted by calculating the mean of two interpolated values. The first of the two interpolated values may be based on a horizontal linear interpolation at location [x][y] in current block 904. The second of the two interpolated values may be based on a vertical linear interpolation at location [x][y] in current block 904. The predicted sample p[x][y] in current block 904 may be calculated as

$$p [ x ] [ y ] = \frac{1}{2 \cdot s} ( h [ x ] [ y ] + v [ x ] [ y ] + s ) \qquad ( 3 )$$

$$where$$

$$h [ x ] [ y ] = ( s - x - 1 ) \cdot {ref}_{2} [ y ] + ( x + 1 ) \cdot {ref}_{1} [ s ] \qquad ( 4 )$$

may be the horizonal linear interpolation at location [x][y] in current block 904 and

$$v [ x ] ⌈ y ] = ( s - y - 1 ) \cdot {ref}_{1} [ x ] + ( y + 1 ) \cdot {ref}_{2} [ s ] \qquad ( 5 )$$

may be the vertical linear interpolation at location [x][y] in current block 904.

For DC mode, a sample at location [x][y] in current block 904 may be predicted by the mean of the reference samples 902. The predicted value sample p[x][y] in current block 904 may be calculated as

$$p [ x ] ⌈ y ] = \frac{1}{2 \cdot s} ( {\sum }_{x = 0}^{s - 1} {ref}_{1} [ x ] + {\sum }_{y = 0}^{s - 1} {ref}_{2} [ y ] ) \qquad ( 6 )$$

For angular modes, a sample at location [x][y] in current block 904 may be predicted by projecting the location [x][y] in a direction specified by a given angular mode to a point on the horizontal or vertical line of samples comprising reference samples 902. The sample at location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC) and relative to the x-axis for horizontal prediction modes (e.g., modes 2-18 in HEVC and modes 2-34 in VVC).

FIG. 12 illustrates a prediction of a sample at location [x][y] in current block 904 for a vertical prediction mode 906 given by an angle q. For vertical prediction modes, the location [x][y] in current block 904 is projected to a point (referred to herein as the “projection point”) on the horizontal line of reference samples ref₁[x]. Reference samples 902 are only partially shown in FIG. 12 for ease of illustration. Because the projection point falls at a fractional sample position between two reference samples in the example of FIG. 12, the predicted sample p[x][y] in current block 904 may be calculated by linearly interpolating between the two reference samples as follows

$$p [ x ] [ y ] = ( 1 - {i}_{f} ) \cdot {ref}_{1} [ x + {i}_{i} + 1 ] + {i}_{f} \cdot {ref}_{1} [ x + {i}_{i} + 2 ] \qquad ( 7 )$$

where iᵢ is the integer part of the horizontal displacement of the projection point relative to the location [x][y] and may calculated as a function of the tangent of the angle φ of the vertical prediction mode 906 as follows

$${i}_{i} = ⌊ ( y + 1 ) \cdot tan φ ⌋ , \qquad ( 8 )$$

and i_{f} is the fractional part of the horizontal displacement of the projection point relative to the location [x][y] and may be calculated as

$${i}_{f} = ( ( y + 1 ) \cdot tan φ ) - ⌊ ( y + 1 ) \cdot tan φ ⌋ . \qquad ( 9 )$$

where └⋅┘ is the integer floor.

For horizontal prediction modes, the position [x][y] of a sample in current block 904 may be projected onto the vertical line of reference samples ref₂[y]. Sample prediction for horizontal prediction modes is given by:

$$p [ x ] [ y ] = ( 1 - {i}_{f} ) \cdot {ref}_{2} [ y + {i}_{i} + 1 ] + {i}_{f} \cdot {ref}_{2} [ y + {i}_{i} + 2 ] \qquad ( 10 )$$

where iᵢ is the integer part of the vertical displacement of the projection point relative to the location [x][y] and may be calculated as a function of the tangent of the angle φ of the horizontal prediction mode as follows

$${i}_{i} = ⌊ ( x + 1 ) \cdot tan φ ⌋ , \qquad ( 11 )$$

and i_{f} is the fractional part of the vertical displacement of the projection point relative to the location [x][y] and may be calculated as

$${i}_{f} = ( ( x + 1 ) \cdot tan φ ) - ⌊ ( x + 1 ) \cdot tan φ ⌋ . \qquad ( 12 )$$

where └⋅┘ is the integer floor.

The interpolation functions of (7) and (10) may be implemented by an encoder or decoder, such as encoder 200 in FIG. 2 or decoder 300 in FIG. 3, as a set of two-tap finite impulse response (FIR) filters. The coefficients of the two-tap FIR filters may be respectively given by (1−i_{f}) and i_{f}. In the above angular intra prediction examples, the predicted sample p[x][y] may be calculated with some predefined level of sample accuracy, such as 1/32 sample accuracy. For 1/32 sample accuracy, the set of two-tap FIR interpolation filters may comprise up to 32 different two-tap FIR interpolation filters-one for each of the 32 possible values of the fractional part of the projected displacement if. In other examples, different levels of sample accuracy may be used.

In an embodiment, the two-tap interpolation FIR filter may be used for predicting chroma samples. For luma samples, a different interpolation technique may be used. For example, for luma samples a four-tap FIR filter may be used to determine a predicted value of a luma sample. For example, the four tap FIR filter may have coefficients determined based on if, similar to the two-tap FIR filter. For 1/32 sample accuracy, a set of 32 different four-tap FIR filters may comprise up to 32 different four-tap FIR filters—one for each of the 32 possible values of the fractional part of the projected displacement i_{f}. In other examples, different levels of sample accuracy may be used. The set of four-tap FIR filters may be stored in a look-up table (LUT) and referenced based on if. The value of the predicted sample p[x][y], for vertical prediction modes, may be determined based on the four-tap FIR filter as follows:

$$p [ x ] [ y ] = {\sum }_{i = 0}^{3} fT [ i ] * ref [ x + iIdx + i ] \qquad ( 13 )$$

where ft[i], i=0 . . . 3, are the filter coefficients. The value of the predicted sample p[x][y], for horizontal prediction modes, may be determined based on the four-tap FIR filter as follows:

$$p [ x ] [ y ] = {\sum }_{i = 0}^{3} fT [ i ] * ref [ y + iIdx + i ] . \qquad ( 14 )$$

It should be noted that supplementary reference samples may be constructed for the case where the position [x][y] of a sample in current block 904 to be predicted is projected to a negative x coordinate, which happens with negative vertical prediction angles φ. The supplementary reference samples may be constructed by projecting the reference samples in ref₂[y] in the vertical line of reference samples 902 to the horizontal line of reference samples 902 using the negative vertical prediction angle φ. Supplemental reference samples may be similarly for the case where the position [x][y] of a sample in current block 904 to be predicted is projected to a negative y coordinate, which happens with negative horizontal prediction angles φ. The supplementary reference samples may be constructed by projecting the reference samples in ref₁[x] on the horizontal line of reference samples 902 to the vertical line of reference samples 902 using the negative horizontal prediction angle q.

An encoder may predict the samples of a current block being encoded, such as current block 904, for a plurality of intra prediction modes as explained above. For example, the encoder may predict the samples of the current block for each of the 35 intra prediction modes in HEVC or 67 intra prediction modes in VVC. For each intra prediction mode applied, the encoder may determine a prediction error for the current block based on a difference (e.g., sum of squared differences (SSD), sum of absolute differences (SAD), or sum of absolute transformed differences (SATD)) between the prediction samples determined for the intra prediction mode and the original samples of the current block. The encoder may select one of the intra prediction modes to encode the current block based on the determined prediction errors. For example, the encoder may select an intra prediction mode that results in the smallest prediction error for the current block. In another example, the encoder may select the intra prediction mode to encode the current block based on a rate-distortion measure (e.g., Lagrangian rate-distortion cost) determined using the prediction errors. The encoder may send an indication of the selected intra prediction mode and its corresponding prediction error to a decoder for decoding of the current block.

Similar to an encoder, a decoder may predict the samples of a current block being decoded, such as current block 904, for an intra prediction mode as explained above. For example, the decoder may receive an indication of an angular intra prediction mode from an encoder for a block. The decoder may construct a set of reference samples and perform intra prediction based on the angular intra prediction mode indicated by the encoder for the block in a similar manner as discussed above for the encoder. The decoder would add the predicted values of the samples of the block to a residual of the block to reconstruct the block. In another embodiment, the decoder may not receive an indication of an angular intra prediction mode from an encoder for a block. Instead, the decoder may determine an intra prediction mode through other, decoder-side means.

Although the description above was primarily made with respect to intra prediction modes in HEVC and VVC, it will be understood that the techniques of the present disclosure described above and further below may be applied to other intra prediction modes, including those of other video coding standards like VP8, VP9, AV1, and the like.

As explained above, intra prediction may exploit correlations between spatially neighboring samples in the same picture of a video sequence to perform video compression. Inter prediction is another coding tool that may be used to exploit correlations in the time domain between blocks of samples in different pictures of the video sequence to perform video compression. In general, an object may be seen across multiple pictures of a video sequence. The object may move (e.g., by some translation and/or affine motion) or remain stationary across the multiple pictures. A current block of samples in a current picture being encoded may therefore have a corresponding block of samples in a previously decoded picture that accurately predicts the current block of samples. The corresponding block of samples may be displaced from the current block of samples due to movement of an object, represented in both blocks, across the respective pictures of the blocks. The previously decoded picture may be referred to as a reference picture and the corresponding block of samples in the reference picture may be referred to as a reference block or motion compensated prediction. An encoder may use a block matching technique to estimate the displacement (or motion) and determine the reference block in the reference picture.

Similar to intra prediction, once a prediction for a current block is determined and/or generated using inter prediction, an encoder may determine a difference between the current block and the prediction. The difference may be referred to as a prediction error or residual. The encoder may then store and/or signal in a bitstream the prediction error and other related prediction information for decoding or other forms of consumption. A decoder may decode the current block by predicting the samples of the current block using the prediction information and combining the predicted samples with the prediction error.

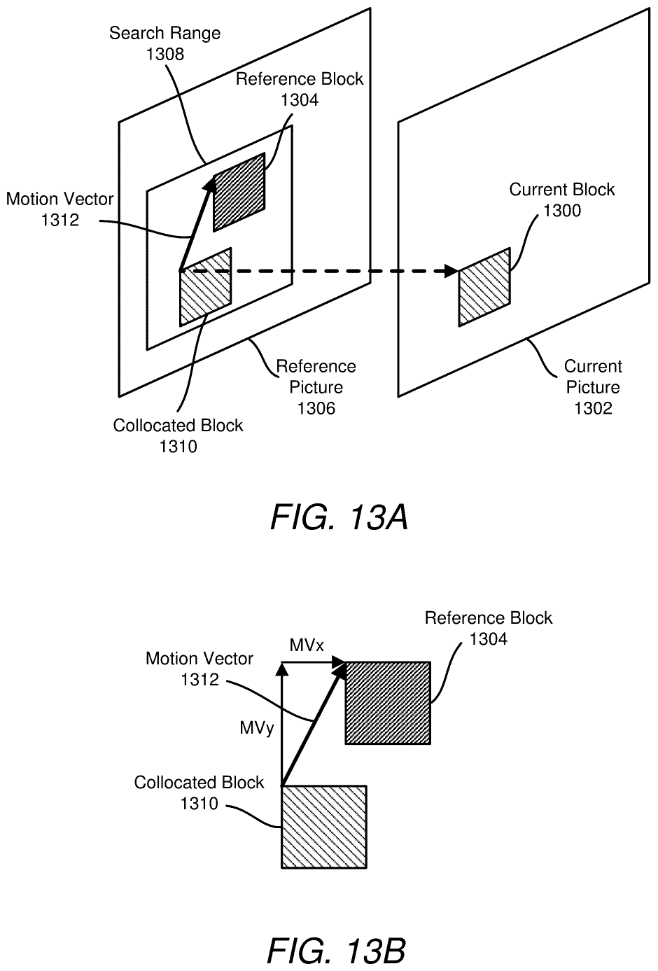

FIG. 13A illustrates an example of inter prediction performed for a current block 1300 in a current picture 1302 being encoded. An encoder, such as encoder 200 in FIG. 2, may perform inter prediction to determine and/or generate a reference block 1304 in a reference picture 1306 to predict current block 1300. Reference pictures, like reference picture 1306, are prior decoded pictures available at the encoder and decoder. Availability of a prior decoded picture may depend on whether the prior decoded picture is available in a decoded picture buffer at the time current block 1300 is being encoded or decoded. The encoder may, for example, search one or more reference pictures for a reference block that is similar to current block 1300. The encoder may determine a “best matching” reference block from the blocks tested during the searching process as reference block 1304. The encoder may determine that reference block 1304 is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), or sum of absolute transformed differences (SATD)) between the prediction samples of reference block 1304 and the original samples of current block 1300.

The encoder may search for reference block 1304 within a search range 1308. Search range 1308 may be positioned around the collocated position (or block) 1310 of current block 1300 in reference picture 1306. In some instances, search range 1308 may at least partially extend outside of reference picture 1306. When extending outside of reference picture 1306, constant boundary extension may be used such that the values of the samples in the row or column of reference picture 1306, immediately adjacent to the portion of search range 1308 extending outside of reference picture 1306, are used for the “sample” locations outside of reference picture 1306. All or a subset of potential positions within search range 1308 may be searched for reference block 1304. The encoder may utilize any one of a number of different search implementations to determine and/or generate reference block 1304. For example, the encoder may determine a set of a candidate search positions based on motion information of neighboring blocks to current block 1300.

One or more reference pictures may be searched by the encoder during inter prediction to determine and/or generate the best matching reference block. The reference pictures searched by the encoder may be included in one or more reference picture lists. For example, in HEVC and VVC, two reference picture lists may be used, a reference picture list 0 and a reference picture list 1. A reference picture list may include one or more pictures. Reference picture 1306 of reference block 1304 may be indicated by a reference index pointing into a reference picture list comprising reference picture 1306.

The displacement between reference block 1304 and current block 1300 may be interpreted as an estimate of the motion between reference block 1304 and current block 1300 across their respective pictures. The displacement may be represented by a motion vector 1312. For example, motion vector 1312 may be indicated by a horizontal component (MVx) and a vertical component (MVy) relative to the position of current block 1300. FIG. 13B illustrates the horizontal component and vertical component of motion vector 1312. A motion vector, such as motion vector 1312, may have fractional or integer resolution. A motion vector with fractional resolution may point between two samples in a reference picture to provide a better estimation of the motion of current block 1300. For example, a motion vector may have 1/2, 1/4, 1/8, 1/16, or 1/32 fractional sample resolution. When a motion vector points to a non-integer sample value in the reference picture, interpolation between samples at integer positions may be used to generate the reference block and its corresponding samples at fractional positions. The interpolation may be performed by a filter with two or more taps.

Once reference block 1304 is determined and/or generated for current block 1300 using inter prediction, the encoder may determine a difference (e.g., a corresponding sample-by-sample difference) between reference block 1304 and current block 1300. The difference may be referred to as a prediction error or residual. The encoder may then store and/or signal in a bitstream the prediction error and the related motion information for decoding or other forms of consumption. The motion information may include motion vector 1312 and a reference index pointing into a reference picture list comprising reference picture 1306. In other instances, the motion information may include an indication of motion vector 1312 and an indication of the reference index pointing into the reference picture list comprising reference picture 1306. A decoder may decode current block 1300 by determining and/or generating reference block 1304, which forms the prediction of current block 1300, using the motion information and combining the prediction with the prediction error.

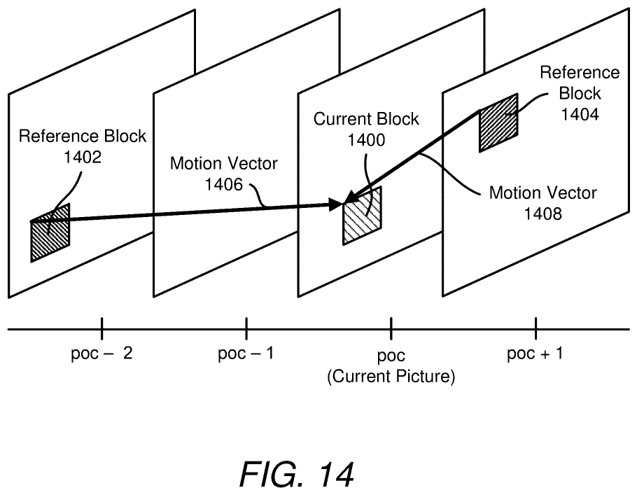

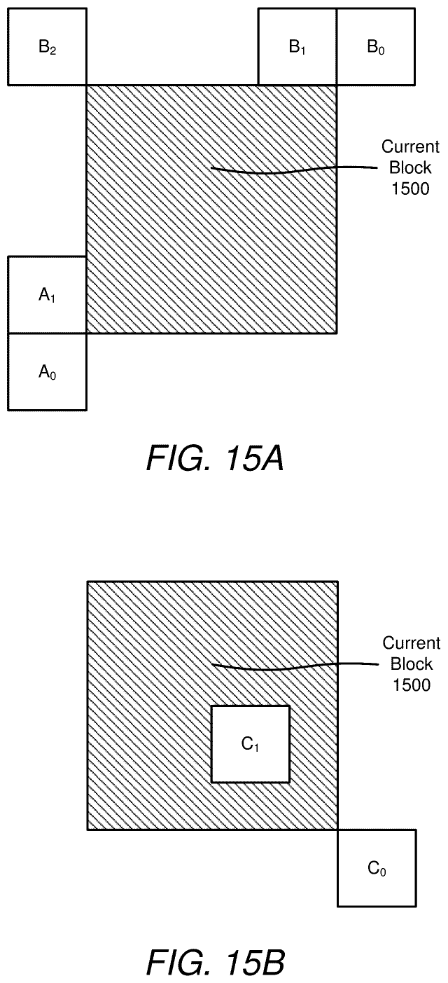

In FIG. 13A, inter prediction is performed using one reference picture 1306 as the source of the prediction for current block 1300. Because the prediction for current block 1300 comes from a single picture, this type of inter prediction is referred to as uni-prediction. FIG. 14 illustrates another type of inter prediction, referred to as bi-prediction, performed for a current block 1400. In bi-prediction, the source of the prediction for a current block 1400 comes from two pictures. Bi-prediction may be useful, for example, where the video sequence comprises fast motion, camera panning or zooming, or scene changes. Bi-prediction may also be useful to capture fade outs of one scene or fade outs from one scene to another, where two pictures are effectively displayed simultaneously with different levels of intensity.

Whether uni-prediction or both uni-prediction and bi-prediction are available for performing inter prediction may depend on a slice type of current block 1400. For P slices, only uni-prediction may be available for performing inter prediction. For B slices, either uni-prediction or bi-prediction may be used. When uni-prediction is performed, an encoder may determine and/or generate a reference block for predicting current block 1400 from reference picture list 0. When bi-prediction is performed, an encoder may determine and/or generate a first reference block for predicting current block 1400 from reference picture list 0 and determine and/or generate a second reference block for predicting current block 1400 from reference picture list 1.

In FIG. 14, inter-prediction is performed using bi-prediction, where two reference blocks 1402 and 1404 are used to predict current block 1400. Reference block 1402 may be in a reference picture of one of reference picture list 0 or 1, and reference block 1404 may be in a reference picture of the other one of reference picture list 0 or 1. As shown in FIG. 14, reference block 1402 is in a picture that precedes the current picture of current block 1400 in terms of picture order count (POC), and reference block 1402 is in a picture that proceeds the current picture of current block 1400 in terms of POC. In other examples, the reference pictures may both precede or proceed the current picture in terms of POC. POC is the order in which pictures are output from, for example, a decoded picture buffer and is the order in which pictures are generally intended to be displayed. However, it should be noted that pictures that are output are not necessarily displayed but may undergo different processing or consumption, such as transcoding. In other examples, the two reference blocks determined and/or generated using bi-prediction may come from the same reference picture. In such an instance, the reference picture may be included in both reference picture list 0 and reference picture list 1.

A configurable weight and offset value may be applied to the one or more inter prediction reference blocks. An encoder may enable the use of weighted prediction using a flag in a picture parameter set (PPS) and signal the weighting and offset parameters in the slice segment header for the current block. Different weight and offset parameters may be signaled for luma and chroma components.

Once reference blocks 1402 and 1404 are determined and/or generated for current block 1400 using inter prediction, the encoder may determine a difference between current block 1400 and each of reference blocks 1402 and 1404. The differences may be referred to as prediction errors or residuals. The encoder may then store and/or signal in a bitstream the prediction errors and their respective related motion information for decoding or other forms of consumption. The motion information for reference block 1402 may include motion vector 1406 and the reference index pointing into the reference picture list comprising the reference picture of reference block 1402. In other instances, the motion information for reference block 1402 may include an indication of motion vector 1406 and an indication of the reference index pointing into the reference picture list comprising the reference picture of reference block 1402. The motion information for reference block 1404 may include motion vector 1408 and the reference index pointing into the reference picture list comprising the reference picture of reference block 1404. In other instances, the motion information for reference block 1404 may include an indication of motion vector 1408 and an indication of the reference index pointing into the reference picture list comprising the reference picture of reference block 1404. A decoder may decode current block 1400 by determining and/or generating reference blocks 1402 and 1404, which together form the prediction of current block 1400, using their respective motion information and combining the predictions with the prediction errors.

In HEVC, VVC, and other video compression schemes, motion information may be predictively coded before being stored or signaled in a bitstream. The motion information for a current block may be predictively coded based on the motion information of neighboring blocks of the current block. In general, the motion information of the neighboring blocks is often correlated with the motion information of the current block because the motion of an object represented in the current block is often the same or similar to the motion of objects in the neighboring blocks. Two of the motion information prediction techniques in HEVC and VVC include advanced motion vector prediction (AMVP) and inter prediction block merging.

An encoder, such as encoder 200 in FIG. 2, may code a motion vector using the AMVP tool as a difference between the motion vector of a current block being coded and a motion vector predictor (MVP). An encoder may select the MVP from a list of candidate MVPs. The candidate MVPs may come from previously decoded motion vectors of neighboring blocks in the current picture of the current block or blocks at or near the collocated position of the current block in other reference pictures. Both the encoder and decoder may generate or determine the list of candidate MVPs.

After the encoder selects an MVP from the list of candidate MVPs, the encoder may signal, in a bitstream, an indication of the selected MVP and a motion vector difference (MVD). The encoder may indicate the selected MVP in the bitstream by an index pointing into the list of candidate MVPs. The MVD may be calculated based on the difference between the motion vector of the current block and the selected MVP. For example, for a motion vector represented by a horizontal component (MVx) and a vertical displacement (MVy) relative to the position of the current block being coded, the MVD may be represented by two components calculated as follows:

$${MVD}_{x} = {MV}_{x} - {MVP}_{x} \qquad ( 15 )$$

$${MVD}_{y} = {MV}_{y} - {MVP}_{y} \qquad ( 16 )$$

where MVDx and MVDy respectively represent the horizontal and vertical components of the MVD, and MVPx and MVPy respectively represent the horizontal and vertical components of the MVP. A decoder, such as decoder 300 in FIG. 3, may decode the motion vector by adding the MVD to the MVP indicated in the bitstream. The decoder may then decode the current block by determining and/or generating the reference block, which forms the prediction of the current block, using the decoded motion vector and combining the prediction with the prediction error.

In HEVC and VVC, the list of candidate MVPs for AMVP may comprise two candidates referred to as candidates A and B. Candidates A and B may include up to two spatial candidate MVPs derived from five spatial neighboring blocks of the current block being coded, one temporal candidate MVP derived from two temporal, co-located blocks when both spatial candidate MVPs are not available or are identical, or zero motion vectors when the spatial, temporal, or both candidates are not available. FIG. 15A illustrates the location of the five spatial candidate neighboring blocks relative to a current block 1500 being encoded. The five spatial candidate neighboring blocks are respectively denoted A₀, A₁, B₀, B₁, and B₂. FIG. 15B illustrates the location of the two temporal, co-located blocks relative to current block 1500 being coded. The two temporal, co-located blocks are denoted C₀ and C₁ and are included in a reference picture that is different from the current picture of current block 1500.

An encoder, such as encoder 200 in FIG. 2, may code a motion vector using the inter prediction block merging tool also referred to as merge mode. Using merge mode, the encoder may reuse the same motion information of a neighboring block for inter prediction of a current block. Because the same motion information of a neighboring block is used, no MVD needs to be signaled and the signaling overhead for signaling the motion information of the current block may be small in size. Similar to AMVP, both the encoder and decoder may generate a candidate list of motion information from neighboring blocks of the current block. The encoder may then determine to use (or inherit) the motion information of one neighboring block's motion information in the candidate list for predicting the motion information of the current block being coded. The encoder may signal, in the bitstream, an indication of the determined motion information from the candidate list. For example, the encoder may signal an index pointing into the list of candidate motion information to indicate the determined motion information.

In HEVC and VVC, the list of candidate motion information for merge mode may comprise up to four spatial merge candidates that are derived from the five spatial neighboring blocks used in AMVP as shown in FIG. 15A, one temporal merge candidate derived from two temporal, co-located blocks used in AMVP as shown in FIG. 15B, and additional merge candidates including bi-predictive candidates and zero motion vector candidates.

It should be noted that inter prediction may be performed in other ways and variants than those described above. For example, motion information prediction techniques other than AMVP and merge mode are possible. In addition, although the description above was primarily made with respect to inter prediction modes in HEVC and WVC, it will be understood that the techniques of the present disclosure described above and further below may be applied to other inter prediction modes, including those of other video coding standards like VP8, VP9, AV1, and the like. In addition, history based motion vector prediction (HMVP), combined intra/inter prediction mode (CIIP), and merge mode with motion vector difference (MMVD) as described in VVC may also be performed and are within the scope of the present disclosure.

In inter prediction, a block matching technique may be applied to determine a reference block in a different picture than the current block being encoded. Block matching techniques have also been applied to determine a reference block in the same picture as a current block being encoded. However, it has been determined that for camera-captured videos, a reference block in the same picture as the current block determined using block matching may often not accurately predict the current block. For screen content video this is generally not the case. Screen content video may include, for example, computer generated text, graphics, and animation. Within screen content, there is often repeated patterns (e.g., repeated patterns of text and graphics) within the same picture. Therefore, a block matching technique applied to determine a reference block in the same picture as a current block being encoded may provide efficient compression for screen content video.

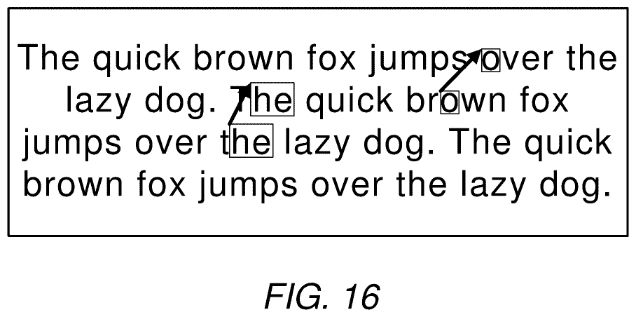

HEVC and VVC both include a prediction technique to exploit the correlation between blocks of samples within the same picture of screen content video. This technique is referred to as intra block copy (IBC) or current picture referencing (CPR). Similar to inter prediction, an encoder may apply a block matching technique to determine a displacement vector (referred to as a block vector (BV) that indicates the relative displacement from the current block to a reference block (or intra block compensated prediction) that “best matches” the current block. The encoder may determine the best matching reference block from blocks tested during a searching process similar to inter prediction. The encoder may determine that a reference block is the best matching reference block based on one or more cost criterion, such as a rate-distortion criterion (e.g., Lagrangian rate-distortion cost). The one or more cost criterion may be based on, for example, a difference (e.g., sum of squared differences (SSD), sum of absolute differences (SAD), sum of absolute transformed differences (SATD), or difference determined based on a hash function) between the prediction samples of the reference block and the original samples of the current block. A reference block may correspond to prior decoded blocks of samples of the current picture. The reference block may comprise decoded blocks of samples of the current picture prior to being processed by in-loop filtering operations, like deblocking or SAO filtering. FIG. 16 illustrates an example of IBC applied for screen content. The rectangular portions with arrows beginning at their boundaries are current blocks being encoded and the rectangular portions that the arrows point to are the reference blocks for predicting the current blocks.

Once a reference block is determined and/or generated for a current block using IBC, the encoder may determine a difference (e.g., a corresponding sample-by-sample difference) between the reference block and the current block. The difference may be referred to as a prediction error or residual. The encoder may then store and/or signal in a bitstream the prediction error and the related prediction information for decoding or other forms of consumption. The prediction information may include a BV. In other instances, the prediction information may include an indication of the BV. A decoder, such as decoder 300 in FIG. 3, may decode the current block by determining and/or generating the reference block, which forms the prediction of the current block, using the prediction information and combining the prediction with the prediction error.

In HEVC, VVC, and other video compression schemes, a BV may be predictively coded before being stored or signaled in a bitstream. The BV for a current block may be predictively coded based on the BV of neighboring blocks of the current block. For example, an encoder may predictively code a BV using the merge mode as explained above for inter prediction or a similar technique as AMVP also explained above for inter prediction. The technique similar to AMVP may be referred to as BV prediction and difference coding.

For BV prediction and difference coding, an encoder, such as encoder 200 in FIG. 2, may code a BV as a difference between the BV of a current block being coded and a BV predictor (BVP). An encoder may select the BVP from a list of candidate BVPs. The candidate BVPs may come from previously decoded BVs of neighboring blocks of the current block in the current picture. Both the encoder and decoder may generate or determine the list of candidate BVPs.

After the encoder selects a BVP from the list of candidate BVPs, the encoder may signal, in a bitstream, an indication of the selected BVP and a BV difference (BVD). The encoder may indicate the selected BVP in the bitstream by an index pointing into the list of candidate BVPs. The BVD may be calculated based on the difference between the BV of the current block and the selected BVP. For example, for a BV represented by a horizontal component (BVₓ) and a vertical component (BV_{y}) relative to the position of the current block being coded, the BVD may represented by two components calculated as follows:

$${BVD}_{x} = {BV}_{x} - {BVP}_{x} \qquad ( 17 )$$

$${BVD}_{y} = {BV}_{y} - {BVP}_{y} \qquad ( 18 )$$

where BVDₓ and BVD_{y} respectively represent the horizontal and vertical components of the BVD, and BVPₓ and BVP_{y} respectively represent the horizontal and vertical components of the BVP. A decoder, such as decoder 300 in FIG. 3, may decode the BV by adding the BVD to the BVP indicated in the bitstream. The decoder may then decode the current block by determining and/or generating the reference block, which forms the prediction of the current block, using the decoded BV and combining the prediction with the prediction error.

In HEVC and VVC, the list of candidate BVPs may comprise two candidates referred to as candidates A and B. Candidates A and B may include up to two spatial candidate BVPs derived from five spatial neighboring blocks of the current block being encoded, or one or more of the last two coded BVs when spatial neighboring candidates are not available (e.g., because they are coded in intra or inter mode). The location of the five spatial candidate neighboring blocks relative to a current block being encoded using IBC are the same as those shown in FIG. 15A for inter prediction. The five spatial candidate neighboring blocks are respectively denoted A₀, A₁, B₀, B₁, and B₂.

As explained above with respect to FIGS. 2 and 3, entropy coding may be performed at the end of the video encoding process and at the beginning of the video decoding process. Entropy coding is a technique for compressing a sequence of symbols by representing symbols with greater probability of occurring using fewer bits than symbols with less probability of occurring. When the compressed sequence of symbols is represented in bits {0, 1}, Shannon's information theory provides that the optimal average code length for a symbol with probability p is-log 2p.

Arithmetic coding is one method of entropy coding. Arithmetic coding is based on recursive interval subdivision. To arithmetically encode a symbol that takes a value from an m-ary source alphabet, an initial coding interval may be divided into m disjoint subintervals. Each of the m disjoint subintervals may have a width proportional to the probability of the symbol having a different one of the values in the m-ary source alphabet. The probabilities of the symbol having the different values in the m-ary source alphabet may be referred to as a probability model for the symbol. The symbol is arithmetically encoded by choosing the subinterval corresponding to the actual value of the symbol as the new coding interval. By recursively applying this interval-subdivision scheme to each symbol sᵢ of a given sequence s={s₁, s₂, . . . , s_{N}), the encoder may determine a value in the range of the final coding interval, after the Nth interval subdivision, as the arithmetic code word for the sequence s. Each successive symbol of the sequence s that is encoded reduces the size of the coding interval in accordance with the probability model of the symbol. The more likely symbol values reduce the size of the coding interval by less than the unlikely symbol values and hence add fewer bits to the arithmetic code word for the sequence s in accordance with the general principle of entropy coding.

Arithmetic decoding is based on the same recursive interval subdivision. To arithmetically decode a symbol that takes a value from an m-ary source alphabet, an initial coding interval may be divided into m disjoint subintervals. Each of the m disjoint subintervals may have a width proportional to the probability of the symbol having a different one of the values in the m-ary source alphabet. The probabilities of the symbol having the different values in the m-ary source alphabet may be referred to as a probability model for the symbol as mentioned above. The symbol is arithmetically decoded from an arithmetic code word by determining the symbol value corresponding to the subinterval in which the arithmetic code word falls within. This subinterval then becomes the new coding interval. The decoder may sequentially decode each symbol sᵢ of a sequence s={s₁, s₂, . . . , s_{N}) by recursively applying this interval-subdivision scheme N times and determining which subinterval the arithmetic code word falls within during each iteration.

For each symbol arithmetically coded, a different probability model may be used to subdivide the coding interval. For example, the probability model for a symbol may be determined by a fixed selection (e.g., based on a position of the symbol in a sequence of symbols) or by an adaptive selection from among two or more probability models (e.g., based on information related to the symbol). It is also possible for two or more symbols in a sequence of symbols to use a joint probability model. Selection of a probability model for a symbol is referred to as context modeling. Arithmetic coding that employs context modeling may be referred to more specifically as context-based arithmetic coding. In addition to probability model selection for a symbol, the selected probability model may be updated based on the actual coded value of the symbol. For example, the probability of the actual coded value of the symbol may be increased in the probability model while the probability of all other values may be decreased. Arithmetic coding that employs both context modeling and probability model adaptation may be referred to more specifically as context-based adaptive arithmetic coding.

The above description provides only one example of arithmetic coding. Other variations of arithmetic coding may be possible as would be appreciated by a person of ordinary skill in the art. For example, during arithmetic coding, a renormalization operation may be performed to ensure that the precision needed to represent the range and lower bound of a subinterval does not exceed the finite precision of registers used to store these values. In addition, other simplifications to the coding process may be made to decrease complexity, increase speed, and/or reduce power requirements of the implementation of the coding process in either hardware, software, or some combination of the two. For example, probabilities of symbols and lower bounds and ranges of subintervals may be approximated or quantized in such implementations.

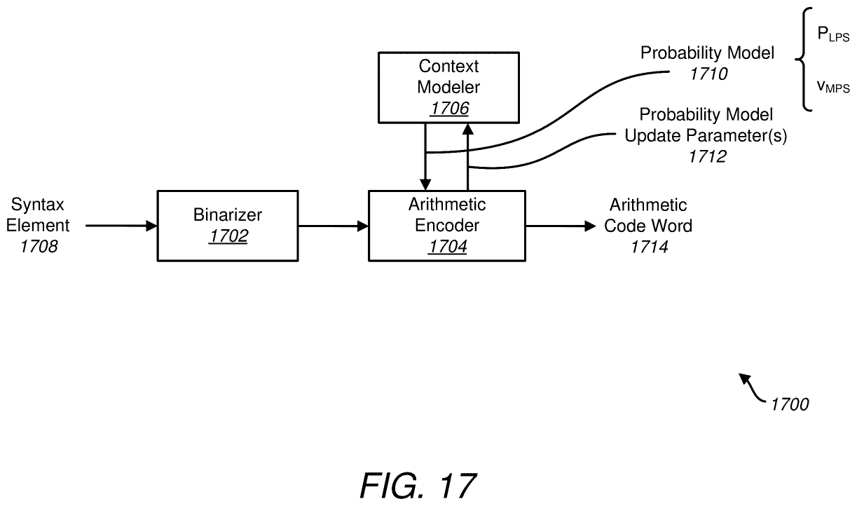

FIG. 17 illustrates an example implementation of a context-based adaptive binary arithmetic coding (CABAC) encoder 1700 in accordance with embodiments of the present disclosure. CABAC encoder 1700 may be implemented in a video encoder, such as encoder 200 in FIG. 2, for entropy encoding syntax elements of a video sequence. As illustrated in FIG. 17, CABAC encoder 1700 includes a binarizer 1702, an arithmetic encoder 1704, and a context modeler 1706.

CABAC encoder 1700 may receive a syntax element 1708 for arithmetic encoding. Syntax elements, such as syntax element 1708, may be generated at a video encoder and may describe how a video signal may be reconstructed at a video decoder. For a coding unit (CU), the syntax elements may comprise an intra prediction mode based on the CU being intra predicted, motion data (e.g., MVD and MVP related data) based on the CU being inter predicted, or displacement data (e.g., BVD and BVP related data) based on the CU being predicted using IBC.

Binarizer 1702 may first map the value of syntax element 1708 to a sequence of binary symbols (also referred to as bins). Binarizer 1702 may define a unique mapping of values of syntax element 1708 to sequences of binary symbols. Binarization of syntax elements may help to improve probability modeling and implementation of arithmetic encoding. Binarizer 1702 may implement one or more binarization processes, such as unary, truncated unary, k-th order truncated Rice, k-th order exponential-Golomb (EGk), fixed-length, or some combination of two or more of these binarization processes. Binarizer 1702 may select a binarization process based on a type of syntax element 1708 and/or one or more syntax elements processed by CABAC encoder 1700 before syntax element 1708. Based on syntax element 1708 already being represented by a sequence of one or more binary symbols, binarizer 1702 may not process syntax element 1708. In another example, binarizer 1702 may not be used and syntax element 1708 represented by a sequence of one or more non-binary symbols may be directly encoded by CABAC encoder 1700.

After binarizer 1702 optionally maps the value of syntax element 1708 to a sequence of binary symbols, one or more of the binary symbols may be processed by arithmetic encoder 1704. Arithmetic encoder 1704 may process each of the one or more binary symbols in one of at least two modes: regular arithmetic encoding mode or bypass arithmetic encoding mode.

Arithmetic encoder 1704 may process binary symbols that do not have a uniform (or approximately uniform) probability distribution in regular arithmetic encoding mode (e.g., binary symbols that do not have a probability distribution of 0.5 for each of their two possible values). In regular arithmetic encoding mode, arithmetic encoder 1704 may perform arithmetic encoding as described above. For example, arithmetic encoder 1704 may subdivide a current coding interval into m disjoint subintervals. Each of the m disjoint subintervals may have a width proportional to the probability of the binary symbol having a different one of the values in an m-ary source alphabet. In the case of a binary symbol, m is equal to two and the current coding interval may be subdivided into two disjoint intervals that each have a width proportional to the probability of a different one of the two possible values {0, 1} for the binary symbol being encoded. The probabilities of the two possible values for the binary symbol may be indicated by a probability model 1710 for the binary symbol. Arithmetic encoder 1704 may then encode the binary symbol by choosing the subinterval corresponding to the actual value of the binary symbol as the new coding interval for the next binary symbol to be encoded.

Arithmetic encoder 1704 may receive probability model 1710 from context modeler 1706. Context modeler 1706 may determine probability model 1710 for the binary symbol by a fixed selection (e.g., based on a position of the binary symbol in the sequence of binary symbols representing syntax element 1708) or by an adaptive selection from among two or more probability models (e.g., based on information related to the binary symbol). As shown in FIG. 17, probability model 1710 may comprise two parameters: the probability P_{LPS} of the least probable symbol (LPS) and the value v_{MPS} of the most probable symbol (MPS). In other examples, probability model 1710 may comprise the probability P_{MPS} of the MPS in addition or alternatively to the probability P_{LPS} of the LPS. Similarly, in other examples, probability model 1710 may comprise the value v_{LPS} of the LPS in addition or alternatively to the value v_{MPS} of the MPS. After arithmetic encoder 1704 encodes the binary symbol, arithmetic encoder 1704 may provide one or more probability model update parameters 1712 to context modeler 1706. Context modeler 1706 may adapt probability model 1710 based on the one or more probability model update parameters 1712. For example, the one or more probability model update parameters 1712 may comprise the actual coded value of the binary symbol. Context modeler 1706 may update probability model 1710 by increasing P_{LPS} if the actual coded value of the binary symbol is not equal to v_{MPS} and by decreasing P_{LPS} otherwise.

Arithmetic encoder 1704 may process binary symbols that have (or are assumed to have) a uniform (or approximately uniform) probability distribution in bypass arithmetic encoding mode. Because binary symbols processed by arithmetic encoder 1704 in bypass arithmetic encoding mode have (or are assumed to have) a uniform (or approximately uniform) probability distribution, arithmetic encoder 1704 may bypass probability model determination and adaptation performed in regular arithmetic encoding mode when encoding these binary symbols to speed up the encoding process. In addition, subdivision of the current coding interval may be simplified given the uniform (or assumed uniform) probability distribution. For example, the current coding interval may be partitioned into two disjoint subintervals of equal width, which may be realized using a simple implementation that may further speed up the encoding process. Arithmetic encoder 1704 encodes the binary symbol by choosing the subinterval corresponding to the value of the binary symbol as the new coding interval for the next binary symbol to be encoded. The resulting increase in encoding speed for binary symbols encoded by arithmetic encoder 1704 in bypass arithmetic encoding mode is often important because CABAC encoding may have throughput limitations.

After processing a number of binary symbols (e.g., corresponding to one or more syntax elements), arithmetic encoder 1704 may determine a value in the range of the final coding interval as an arithmetic code word 1714 for the binary symbols. Arithmetic encoder 1704 may then output arithmetic code word 1714. For example, arithmetic encoder 1704 may output arithmetic code word 1714 to a bitstream that may be received and processed by a video decoder.

In existing approaches, two syntax elements that are coded in bypass arithmetic coding mode are the magnitude of the motion vector difference (MVD) and the magnitude of the block vector difference (BVD). These syntax elements may be respectively determined as part of advanced motion vector prediction (AMVP) for inter prediction and AMVP for intra block copy (IBC) as explained above. Although the bypass arithmetic coding mode may be used to speed up the arithmetic coding process, compression of the symbols of these syntax elements coded in bypass arithmetic encoding mode is limited because their probability distributions are uniformly distributed (or at least assumed to be uniformly distributed). From information theory, a symbol cannot be compressed at a rate less than its entropy without loss of information, and a symbol with a uniform probability distribution has maximum entropy. Thus, symbols coded using the bypass arithmetic encoding mode generally require more bits to encode than symbols encoded using the regular arithmetic encoding mode.

Example embodiments described herein are directed to apparatuses and methods for improving the compression efficiency of one or more magnitude symbols of a BVD. Instead of entropy coding a magnitude symbol of the BVD, embodiments of the present disclosure may entropy code an indication of whether a value of the magnitude symbol of the BVD matches a value of the magnitude symbol of a BVD candidate used as a predictor of the BVD. The BVD predictor may be selected from among a plurality of BVD candidates based on costs of the plurality of BVD candidates. The cost of each BVD candidate in the plurality of BVD candidates may be calculated based on a difference between a template of a current block and a template of a candidate reference block. The candidate reference block may be displaced relative to the current block by a sum of the BVD candidate and a block vector predictor (BVP). The indication of whether the value of the magnitude symbol of the BVD matches the value of the magnitude symbol of the BVD predictor may have a non-uniform probability distribution and therefore provide improved compression efficiency over coding the magnitude symbol of the BVD based on a uniform probability distribution.

Example embodiments described herein are further directed to apparatuses and methods for improving the compression efficiency of one or more magnitude symbols of an MVD. Instead of entropy coding a magnitude symbol of the MVD, embodiments of the present disclosure may entropy code an indication of whether a value of the magnitude symbol of the MVD matches a value of the magnitude symbol of an MVD candidate used as a predictor of the MVD. The MVD predictor may be selected from among a plurality of MVD candidates based on costs of the plurality of MVD candidates. The cost of each MVD candidate in the plurality of MVD candidates may be calculated based on a difference between a template of a current block and a template of a candidate reference block. The candidate reference block may be displaced relative to a co-location of the current block in a reference frame by a sum of the MVD candidate and a motion vector predictor (MVP). The indication of whether the value of the magnitude symbol of the MVD matches the value of the magnitude symbol of the MVD predictor may have a non-uniform probability distribution and therefore provide improved compression efficiency over coding the magnitude symbol of the MVD based on a uniform probability distribution.

As explained above, HEVC and VVC both include a prediction technique to exploit the correlation between blocks of samples within the same picture. This technique is referred to as intra block copy (IBC). IBC is also included in the Enhanced Compression Model (ECM) software algorithm that is currently under coordinated exploration study by the Joint Video Exploration Team (JVET) of ITU-T Video Coding Experts Group (VCEG) and ISO/IEC MPEG as a potential enhanced video coding technology beyond the capabilities of VVC.

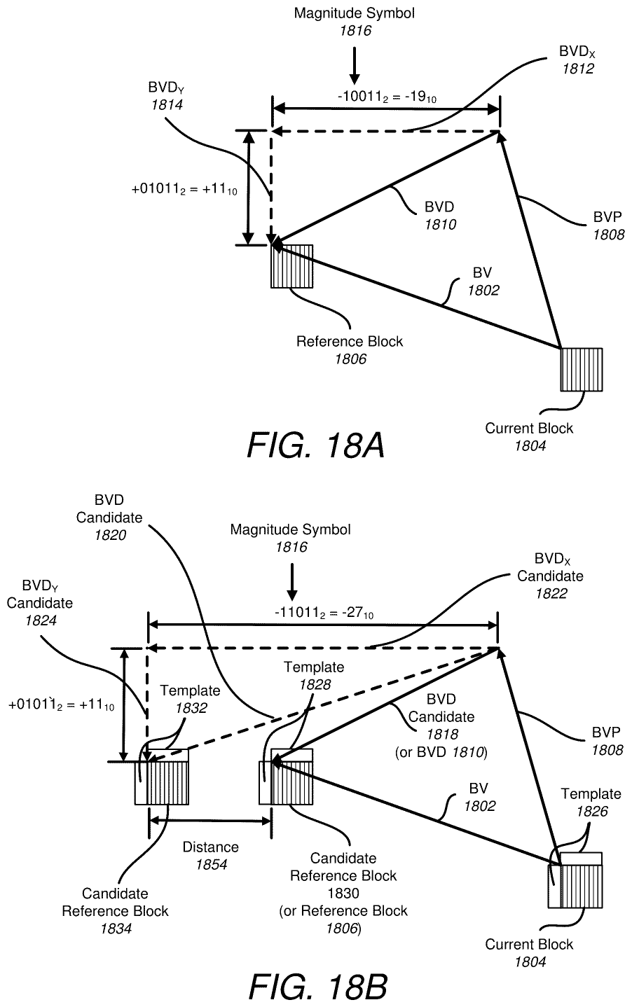

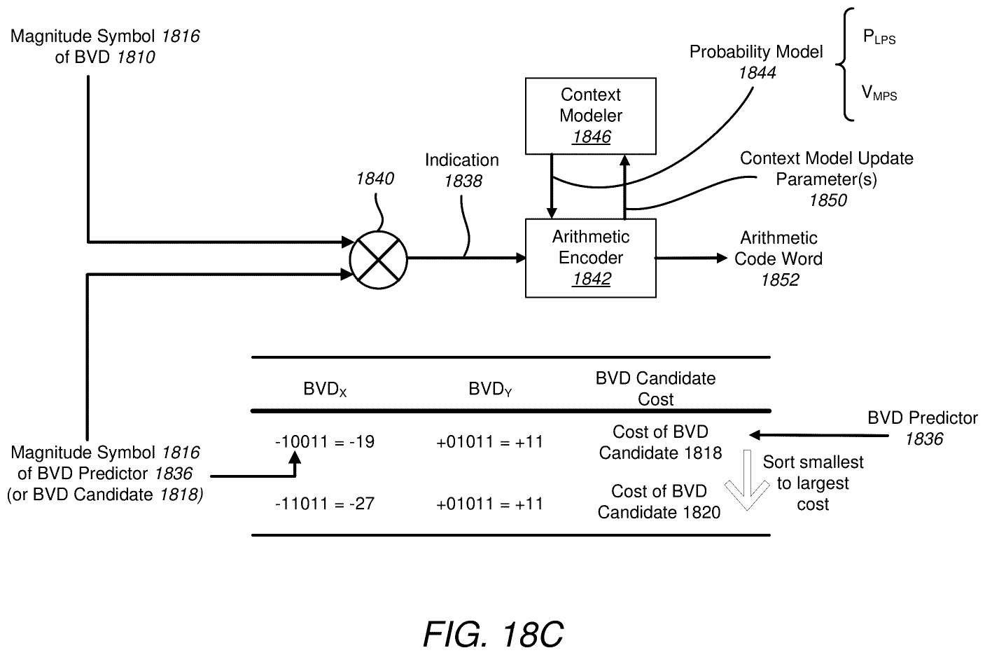

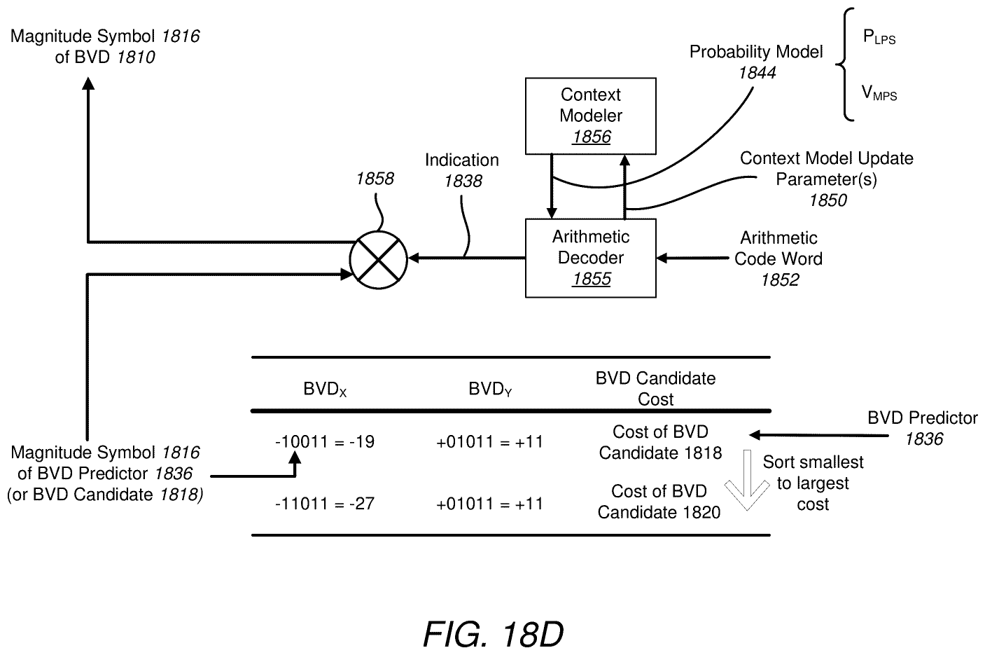

FIG. 18A illustrates an example of IBC in accordance with embodiments of the present disclosure. During IBC, an encoder may determine a block vector (BV) 1802 that indicates the displacement from a current block 1804 to a reference block (or intra block compensated prediction) 1806. The encoder may determine reference block 1806 from among one or more reference blocks tested during a searching process. For example, for each of the one or more reference blocks tested during a searching process, the encoder may determine a difference (e.g., sum of squared differences (SSD), sum of absolute differences (SAD), sum of absolute transformed differences (SATD), or difference determined based on a hash function) between the samples of the reference block and the samples of current block 1804. The encoder may determine reference block 1806 from among the one or more reference blocks based on reference block 1806 having the smallest difference from current block 1804 among the one or more reference blocks or based on some other criteria. Reference block 1806 and the one or more other reference blocks tested during the searching process may comprise decoded (or reconstructed) samples. The decoded (or reconstructed) samples may not have been processed by in-loop filtering operations, like deblocking or SAO filtering.

Once reference block 1806 is determined for current block 1804, the encoder may use reference block 1806 to predict current block 1804. For example, the encoder may determine or use a difference (e.g., a corresponding sample-by-sample difference) between reference block 1806 and current block 1804. The difference may be referred to as a prediction error or residual. The encoder may then signal the prediction error and the related prediction information in a bitstream. The prediction information may include BV 1802. In other instances, the prediction information may include an indication of BV 1802. A decoder, such as decoder 300 in FIG. 3, may receive the bitstream and decode current block 1804 by determining reference block 1806, which forms the prediction of current block 1804, using the prediction information and combining the prediction with the prediction error.

BV 1802 may be predictively encoded before being signaled in a bit stream. BV 1802 may be predictively encoded based on the BVs of neighboring blocks of current block 1804 or BVs of other blocks. For example, the encoder may predictively encode BV 1802 using the merge mode or AMVP as explained above. For AMVP, the encoder may encode BV 1802 as a difference between BV 1802 and a BV predictor (BVP) 1808 as shown in FIG. 18A. The encoder may select BVP 1808 from a list of candidate BVPs. The candidate BVPs may come from previously decoded BVs of neighboring blocks of current block 1804 or other sources. Both the encoder and decoder may generate or determine the list of candidate BVPs.

After the encoder selects BVP 1808 from the list of candidate BVPs, the encoder may signal, in a bitstream, an indication of BVP 1808 and a BV difference (BVD) 1810. The encoder may indicate BVP 1808 in the bitstream by an index, pointing into the list of candidate BVPs, or one or more flags. BVD 1810 may be calculated based on the difference between BV 1802 and BVP 1808. BVD 1810 may comprise a horizontal component (BVDₓ) 1812 and a vertical component (BVD_{y}) 1814 that may be respectively determined in accordance with (17) and (18) above. The two components BVDₓ 1812 and BVD_{y} 1814 each comprise a magnitude and sign. As shown in FIG. 18A, BVDₓ 1812 has a magnitude of 10011 in fixed length binary (or 19 in base 10) and a negative sign (the positive horizontal direction points to the right in the example of FIG. 18A). As further shown in FIG. 18A, BVD_{y} 1814 has a magnitude of 01011 in fixed length binary (or 11 in base 10) and a positive sign (the positive vertical direction points down in the example of FIG. 18A). The encoder may indicate BVD 1810 in the bitstream via its two components BVDₓ 1812 and BVD_{y} 1814.

The decoder may decode BV 1802 by adding BVD 1810 to BVP 1808. The decoder may then decode current block 1804 by determining reference block 1806, which forms the prediction of current block 1804, using BV 1802 and combining the prediction with the prediction error. The decoder may determine reference block 1806 by adding BV 1802 to the location of current block 1804, which may give the location of reference block 1806.

As explained above, the magnitude of BVD 1810 is encoded in bypass arithmetic encoding mode in existing technologies. Although the bypass arithmetic encoding mode may be used to speed up the arithmetic encoding process, compression of the magnitude symbols of BVD 1810 encoded in bypass arithmetic encoding mode is limited because their probability distributions are uniformly distributed (or at least assumed to be uniformly distributed). From information theory, a symbol cannot be compressed at a rate less than its entropy without loss of information, and a symbol with uniform probability distribution has maximum entropy. Thus, symbols encoded using the bypass arithmetic encoding mode generally require more bits to encode than symbols encoded using the regular arithmetic encoding mode.

Example embodiments described herein may improve the compression efficiency of one or more magnitude symbols of BVD 1810. For example, instead of directly entropy encoding a magnitude symbol of BVD 1810, the encoder may entropy encode an indication of whether a value of the magnitude symbol of BVD 1810 matches a value of the same magnitude symbol of a BVD candidate used as a predictor of BVD 1810. The indication of whether the value of the magnitude symbol of BVD 1810 matches the value of the magnitude symbol of the BVD predictor may have a non-uniform probability distribution and therefore provide improved compression efficiency. The encoder may select the BVD predictor from among a plurality of BVD candidates based on costs of the plurality of the BVD candidates. The BVD candidates may include a BVD candidate for each possible value of the magnitude symbol of BVD 1810. For example, a magnitude symbol of BVD 1810 represented in binary form has only two possible values. Therefore, the BVD candidates may include two BVD candidates for this representation (one for each possible value of the magnitude symbol in BVD 1810 being encoded): a first BVD candidate equal to BVD 1810 itself and a second BVD candidate equal to BVD 1810 but with the opposite (or other) value of the magnitude symbol of BVD 1810. The cost for each BVD candidate in the plurality of BVD candidates may be calculated based on a difference between a template of current block 1804 and a template of a candidate reference block. The candidate reference block may be displaced relative to the current block by a sum of the BVD candidate and BVP 1808.

To provide a more specific example, FIG. 18A indicates an example magnitude symbol 1816 of BVD 1810 to be entropy encoded. Magnitude symbol 1816 of BVD 1810 is the second most significant bit in the fixed length binary representation of horizontal component BVDₓ 1812 of BVD 1810 and has a binary value of “0”. As explained above, instead of directly entropy encoding magnitude symbol 1816 of BVD 1810, the encoder may entropy encode an indication of whether the value of magnitude symbol 1816 of BVD 1810 matches the value of the same magnitude symbol of a BVD candidate used as a predictor of BVD 1810. The encoder may select the BVD predictor from among a plurality of BVD candidates based on costs of the plurality of BVD candidates. The BVD candidates may include a BVD candidate for each of the two possible values {0, 1} of magnitude symbol 1816 of BVD 1810: a first BVD candidate 1818 equal to BVD 1810 itself and a second BVD candidate 1820 equal to BVD 1810 but with the opposite (or other) value of magnitude symbol 1816 of BVD 1810.

FIG. 18B illustrates both BVD candidates used to entropy encode magnitude symbol 1816 of BVD 1810. More specifically, FIG. 18B illustrates BVD candidate 1818 equal to BVD 1810 itself and BVD candidate 1820 equal to BVD 1810 but with the opposite (or other) value of magnitude symbol 1816 of BVD 1810. With the opposite (or other) value of magnitude symbol 1816 of BVD candidate 1818, BVD candidate 1820 has a horizontal component BVDₓ 1822 with a magnitude of 11011 in fixed length binary (or 27 in base 10) and a negative sign. The vertical component BVD_{y} 1824 of BVD candidate 1820 has the same magnitude of 01011 in fixed length binary (or 11 in base 10) and positive sign as vertical component BVD_{y} 1814 of BVD candidate 1818 (or BVD 1810).

The cost for each BVD candidate in the plurality of BVD candidates may be calculated based on a difference between a template of current block 1804 and a template of a candidate reference block displaced relative to current block 1804 by a sum of the BVD candidate and BVP 1808. For example, the encoder may determine a cost for BVD candidate 1818 based on a difference between a template 1826 of current block 1804 and a template 1828 of a candidate reference block 1830 displaced relative to current block 1804 by a sum of BVD candidate 1818 and BVP 1808. The encoder may determine the difference between template 1826 and template 1828 based on a difference (e.g., sum of squared differences (SSD), sum of absolute differences (SAD), sum of absolute transformed differences (SATD), mean removal SAD, or mean removal SSD) between samples of template 1826 and samples of template 1828. The encoder may similarly determine a cost for BVD candidate 1820 based on a difference between template 1826 of current block 1804 and a template 1832 of a candidate reference block 1834 displaced relative to current block 1804 by a sum of BVD candidate 1820 and BVP 1808. The encoder may determine the difference between template 1826 and template 1832 based on a difference (e.g., SSD, SAD, SATD, mean removal SAD, or mean removal SSD) between samples of template 1826 and samples of template 1828. Templates 1826, 1828, and 1832 may comprise one or more samples to the left and/or above their respective blocks. For example, templates 1826, 1828, and 1832 may comprise samples from one or more columns to left of their respective block and/or from one or more rows above their respective block. FIG. 18B illustrates one example position and shape (L-shape rotated clockwise 90 degrees) of templates 1826, 1828, and 1832.

After determining the costs of each of the plurality of BVD candidates, the encoder may select one of the plurality of BVD candidates as a BVD predictor. For example, the encoder may select the BVD candidate with the smallest cost among the plurality of BVD candidates as the BVD predictor. FIG. 18C illustrates a table with the components (horizontal and vertical) and costs of each BVD candidate 1818 and 1820 in respective rows. In this example, BVD candidates 1818 and 1820 are assumed to be the only BVD candidates. In other example, more BVD candidates may be used. The rows of the table are sorted by the costs of BVD candidates 1818 and 1820, with the BVD candidate with the smallest cost on top. In this example, BVD candidate 1818 has the smallest cost among BVD candidates 1818 and 1820. The encoder may therefore select BVD candidate 1818 as the BVD predictor 1836 for BVD 1810.

After selecting BVD candidate 1818 as BVD predictor 1836, the encoder may entropy encode an indication 1838 of whether the value of magnitude symbol 1816 of BVD 1810 matches the value of magnitude symbol 1816 in BVD predictor 1836. Magnitude symbol 1816 of BVD predictor 1836 has a value of “0”, which matches the value of magnitude symbol 1816 of BVD 1810. In this example, indication 1838 would indicate that the value of magnitude symbol 1816 of BVD 1810 matches the value of magnitude symbol 1816 of BVD predictor 1836. In one example, indication 1838 may be a single bit that has the value: “0” when the value of magnitude symbol 1816 of BVD 1810 matches the value of magnitude symbol 1816 of BVD predictor 1836; and “1” when the value of magnitude symbol 1816 of BVD 1810 does not match the value of magnitude symbol 1816 of BVD predictor 1836. Logic 1840 may be used to determine indication 1838. In one example, logic 1840 may implement a logical exclusive or (XOR) function. It should be noted that in other examples where magnitude symbol 1816 is non-binary, indication 1838 may indicate the first candidate among the plurality of candidates (e.g., as sorted based on their respective costs) that has a value of magnitude symbol 1816 that matches the value of magnitude symbols 1816 in BVD 1810.

In the example of FIG. 18C, the encoder may entropy encode indication 1838 using arithmetic encoder 1842. Based on the method of determining indication 1838 as described above, indication 1838 may have a non-uniform probability distribution. Therefore, arithmetic encoder 1842 may process indication 1838 in regular arithmetic encoding mode as described above. For example, arithmetic encoder 1842 may subdivide a current coding interval into m disjoint subintervals. Each of the m disjoint subintervals may have a width proportional to the probability of the symbol being encoded having a different one of the values in an m-ary source alphabet. In the case of indication 1838, which is binary, m is equal to two and the current coding interval may be subdivided into two disjoint intervals that each have a width proportional to the probability of a different one of the two possible values {0, 1} for indication 1838 being encoded. The probabilities of the two possible values for indication 1838 may be indicated by a probability model 1844 for indication 1838. Arithmetic encoder 1842 may then encode indication 1838 by choosing the subinterval corresponding to the actual value of indication 1838 as the new coding interval for the next binary symbol to be encoded.

Arithmetic encoder 1842 may receive probability model 1844 from context modeler 1846. Context modeler 1846 may determine probability model 1844 for indication 1838 by a fixed selection or an adaptive selection from among two or more probability models. For example, context modeler 1846 may determine probability model 1844 by a fixed selection or an adaptive selection from among two or more probability models based on a position of magnitude symbol 1816 in BVDₓ 1812 of BVD 1810 or an index of (e.g., a value indicating) the position of magnitude symbol 1816 in BVDₓ 1812 of BVD 1810. The position (or index of the position) of magnitude symbol 1816 in BVDₓ 1812 of BVD 1810 provides an indication of the distance 1854 (illustrated in FIG. 18B) between the two candidate BVDs. The likelihood of the value of magnitude symbol 1816 of BVD predictor 1836 matching the value of magnitude symbol 1816 of BVD 1810 may be related to distance 1854. More particularly, the extent of the difference between respective templates of the candidate BVDs is likely to be larger for greater values of distance 1854 between the candidate BVDs. In turn, the larger the difference between respective templates of the BVD candidates, the more likely the costs of the BVD candidates accurately reflect the BVD candidate with a value of magnitude symbol 1816 that matches the value of magnitude symbol 1816 of BVD 1810. Thus, the position (or index of the position) of magnitude symbol 1816 in BVDₓ 1812 of BVD 1810 may be helpful in selecting probability model 1844 for indication 1838.

For adaptive selection from among two or more probability models, context modeler 1846 may compare the position (or index of the position) of magnitude symbol 1816 in BVDₓ 1812 of BVD 1810 to one or more thresholds. For example, context modeler 1846 may compare the position (or index of the position) of magnitude symbol 1816 in BVDₓ 1812 of BVD 1810 to a first threshold. Based on the position (or index of the position) of magnitude symbol 1816 in BVDₓ 1812 of BVD 1810 being less than the threshold, context modeler 1846 may select a first probability model for indication 1838. Based on the position (or index of the position) of magnitude symbol 1816 in BVDₓ 1812 of BVD 1810 being greater than the threshold, context modeler 1846 may select a second probability model for indication 1838. In another example, based on the position (or index of the position) of magnitude symbol 1816 in BVDₓ 1812 of BVD 1810 being greater than the threshold, context modeler 1846 may compare the position (or index of the position) of magnitude symbol 1816 in BVDₓ 1812 of BVD 1810 to a second threshold. Based on the position (or index of the position) of magnitude symbol 1816 in BVDₓ 1812 of BVD 1810 being less than the second threshold, context modeler 1846 may select a second probability model for indication 1838. Based on the position (or index of the position) of magnitude symbol 1816 in BVDₓ 1812 of BVD 1810 being greater than the second threshold, context modeler 1846 may select a third probability model for indication 1838.

In another example, context modeler 1846 may determine probability model 1844 by a fixed selection or an adaptive selection from among two or more probability models based on the change in value of BVD 1810 (or BVDₓ 1812 of BVD 1810) for an incremental change in value of magnitude symbol 1816 of BVD 1810. The change in value of BVD 1810 (or BVDₓ 1812 of BVD 1810) for an incremental change in value of magnitude symbol 1816 of BVD 1810 may be determined as 2⁽ⁿ⁻¹⁾, where n is the bit position of magnitude symbol 1816 in BVDₓ 1812 of BVD 1810. In the example of FIG. 18, n=4 and therefore the change in value of BVD 1810 (or BVDₓ 1812 of BVD 1810) for an incremental change in value of magnitude symbol 1816 of BVD 1810 may be determined as 2⁽ⁿ⁻¹⁾ or 8. The change in value of BVD 1810 (or BVDₓ 1812 of BVD 1810) for an incremental change in value of magnitude symbol 1816 of BVD 1810 provides an indication of the distance 1854 (illustrated in FIG. 18B) between the two candidate BVDs. As mentioned above, the likelihood of the value of magnitude symbol 1816 of BVD predictor 1836 matching the value of magnitude symbol 1816 of BVD 1810 may be related to distance 1854. More particularly, the extent of the difference between respective templates of the candidate BVDs is likely to be larger for greater values of distance 1854 between the candidate BVDs. In turn, the larger the difference between respective templates of the BVD candidates, the more likely the costs of the BVD candidates accurately reflect the BVD candidate with a value of magnitude symbol 1816 that matches the value of magnitude symbol 1816 of BVD 1810. Thus, the change in value of BVD 1810 (or BVDₓ 1812 of BVD 1810) for an incremental change in value of magnitude symbol 1816 of BVD 1810 may be helpful in selecting probability model 1844 for indication 1838.

For adaptive selection from among two or more probability models, context modeler 1846 may compare the value of BVD 1810 (or BVDₓ 1812 of BVD 1810) for an incremental change in value of magnitude symbol 1816 of BVD 1810 to one or more thresholds. For example, context modeler 1846 may compare the value of BVD 1810 (or BVDₓ 1812 of BVD 1810) for an incremental change in value of magnitude symbol 1816 of BVD 1810 to a first threshold. Based on the value of BVD 1810 (or BVDₓ 1812 of BVD 1810) for an incremental change in value of magnitude symbol 1816 of BVD 1810 being less than the threshold, context modeler 1846 may select a first probability model for indication 1838. Based on the value of BVD 1810 (or BVDₓ 1812 of BVD 1810) for an incremental change in value of magnitude symbol 1816 of BVD 1810 being greater than the threshold, context modeler 1846 may select a second probability model for indication 1838. In another example, based on the value of BVD 1810 (or BVDₓ 1812 of BVD 1810) for an incremental change in value of magnitude symbol 1816 of BVD 1810 being greater than the threshold, context modeler 1846 may compare the value of BVD 1810 (or BVDₓ 1812 of BVD 1810) for an incremental change in value of magnitude symbol 1816 of BVD 1810 to a second threshold. Based on the value of BVD 1810 (or BVDₓ 1812 of BVD 1810) for an incremental change in value of magnitude symbol 1816 of BVD 1810 being less than the second threshold, context modeler 1846 may select a second probability model for indication 1838. Based on the value of BVD 1810 (or BVDₓ 1812 of BVD 1810) for an incremental change in value of magnitude symbol 1816 of BVD 1810 being greater than the second threshold, context modeler 1846 may select a third probability model for indication 1838.

As shown in FIG. 18C, probability model 1844 may comprise two parameters: the probability P_{LPS} of the least probable symbol (LPS) for indication 1838 and the value v_{MPS} of the most probable symbol (MPS) for indication 1838. In other examples, probability model 1844 may comprise the probability P_{MPS} of the MPS for indication 1838 in addition or alternatively to the probability P_{LPS} of the LPS for indication 1838. Similarly, in other examples, probability model 1844 may comprise the value v_{LPS} of the LPS for indication 1838 in addition or alternatively to the value v_{MPS} of the MPS for indication 1838. After arithmetic encoder 1842 encodes indication 1838, arithmetic encoder 1842 may provide one or more probability model update parameters 1850 to context modeler 1846. Context modeler 1846 may adapt probability model 1844 based on the one or more probability model update parameters 1850. For example, the one or more probability model update parameters 1850 may comprise the actual coded value of indication 1838. Context modeler 1846 may update probability model 1844 by increasing P_{LPS} for indication 1838 if the actual coded value of indication 1838 is not equal to v_{MPS} and by decreasing P_{LPS} for indication 1838 otherwise.

After processing a number of binary symbols (e.g., corresponding to one or more syntax elements), arithmetic encoder 1842 may determine a value in the range of the final coding interval as an arithmetic code word 1852 for the binary symbols. Arithmetic encoder 1842 may then output arithmetic code word 1852. For example, arithmetic encoder 1842 may output arithmetic code word 1852 to a bitstream that may be received and processed by a video decoder.

FIG. 18D illustrates an example of a decoder (e.g., decoder 300 in FIG. 3) that may receive arithmetic code word 1852, arithmetically decode indication 1838 from arithmetic code word 1852, and use indication 1838 to determine magnitude symbol 1816 of BVD 1810 in accordance with embodiments of the present disclosure.

The decoder may receive arithmetic code word 1852 in a bitstream. The decoder may provide arithmetic code word 1852 to an arithmetic decoder 1855. Based on the method of determining indication 1838 as described above, indication 1838 may have a non-uniform probability distribution. Therefore, arithmetic decoder 1855 may process indication 1838 in regular arithmetic decoding mode. For example, arithmetic decoder 1855 may perform recursive interval subdivision as explained above to decode symbols encoded by arithmetic code word 1852. For example, arithmetic decoder 1855 may arithmetically decode a symbol that takes a value from an m-ary source alphabet by dividing an initial coding interval into m disjoint subintervals. Each of the m disjoint subintervals may have a width proportional to the probability of the symbol having a different one of the values in the m-ary source alphabet. In the case of binary symbols like indication 1838, m is equal to two and the initial coding interval may be subdivided into two disjoint intervals that each have a width proportional to the probability of a different one of the two possible values {0, 1}. The probabilities of the symbol having the different values in the m-ary source alphabet may be referred to as a probability model for the symbol as mentioned above. The symbol is arithmetically decoded from arithmetic code word 1852 by determining the symbol value corresponding to the subinterval in which the arithmetic code word falls within. The decoder may sequentially decode each symbol sᵢ of a sequence s={s₁, s₂, . . . , s_{N}) encoded by arithmetic code word 1852 by recursively applying this interval-subdivision scheme N times and determining which subinterval arithmetic code word 1852 falls within during each iteration.

When decoding the symbol corresponding to indication 1838, arithmetic decoder 1855 may receive probability model 1844 for indication 1838 from context modeler 1846. Context modeler 1856 may determine probability model 1844 for indication 1838 by a fixed selection or by an adaptive selection from among two or more probability models in the same manner as described above for context modeler 1846 in FIG. 18C.

As shown in FIG. 18D, after arithmetic decoder 1855 decodes indication 1838, arithmetic decoder 1855 may provide one or more probability model update parameters 1850 to context modeler 1856. Context modeler 1856 may adapt probability model 1844 based on the one or more probability model update parameters 1850. For example, the one or more probability model update parameters 1850 may comprise the actual decoded value of indication 1838. Context modeler 1856 may update probability model 1844 by increasing P_{LPS} for indication 1838 if the actual decoded value of indication 1838 is not equal to v_{MPS} and by decreasing P_{LPS} for indication 1838 otherwise.

After entropy decoding indication 1838, the decoder may determine the value of magnitude symbol 1816 of BVD 1810 based on the value of magnitude symbol 1816 of BVD predictor 1836 and the value of indication 1838. For example, the decoder may determine the value of magnitude symbol 1816 of BVD 1810 as being equal to the magnitude symbol of BVD predictor 1836 based on indication 1838 indicating that the value of magnitude symbol 1816 of BVD 1810 matches the value of magnitude symbol 1816 of BVD predictor 1836. Conversely, the decoder may determine the value of magnitude symbol 1816 of BVD 1810 as being not equal to (or equal to the opposite value of) magnitude symbol 1816 of BVD predictor 1836 based on indication 1838 indicating that the value of magnitude symbol 1816 of BVD 1810 does not match the value of magnitude symbol 1816 of BVD predictor 1836. Magnitude symbol 1816 of BVD predictor 1810 has a value of “0”, which matches the value of magnitude symbol 1816 of BVD 1810. In this example, indication 1838 would indicate that the value of magnitude symbol 1816 of BVD 1810 matches the value of magnitude symbol 1816 of BVD predictor 1836. In one example, indication 1838 may be a single bit that has the value: “0” when the value of magnitude symbol 1816 of BVD 1810 matches the value of magnitude symbol 1816 of BVD predictor 1836; and “1” when the value of magnitude symbol 1816 of BVD 1810 does not match the value of magnitude symbol 1816 of BVD predictor 1836. Logic 1858 may be used to determine magnitude symbol 1816 of BVD 1810. In one example, logic 1858 may implement a logical XOR function. It should be noted that in other examples where magnitude symbol 1816 is non-binary, indication 1838 may indicate the first candidate among the plurality of candidates (e.g., as sorted based on their respective costs) that has a value of magnitude symbol 1816 that matches the value of magnitude symbols 1816 in BVD 1810.

The decoder may determine the value of magnitude symbol 1816 of BVD predictor 1836 in the same manner as the encoder described above. More specifically, the decoder may select BVD predictor 1836 from among a plurality of BVD candidates based on costs of the plurality of the BVD candidates. The BVD candidates may include a BVD candidate for each possible value of the magnitude symbol of BVD 1810. For example, a magnitude symbol of BVD 1810 represented in binary form has only two possible values. Therefore, the BVD candidates may include at least two BVD candidates for this representation (one for each possible value of the magnitude symbol in BVD 1810 being encoded): a first BVD candidate equal to BVD 1810 itself and a second BVD candidate equal to BVD 1810 but with the opposite (or other) value of the magnitude symbol of BVD 1810. The cost for each BVD candidate in the plurality of BVD candidates may be calculated as described above with respect to the encoder based on a difference between a template of current block 1804 and a template of a candidate reference block. The candidate reference block may be displaced relative to the current block by a sum of the BVD candidate and BVP 1808. The decoder may select the BVD candidate with the lost cost as BVD predictor 1836.

It should be noted that the approach discussed above with respect to FIG. 18 to entropy code an indication of whether a value of a magnitude symbol of a BVD matches a value of the magnitude symbol of a BVD candidate used as a predictor of the BVD may be applied to multiple magnitude symbols of the BVD. For example, the above approach may be further applied to one or more magnitude symbols of BVDₓ 1812 other than magnitude symbol 1816. For each additional magnitude symbol of BVDₓ 1812 that the approach discussed above with respect to FIG. 18 is applied, additional candidate BVPs may be determined. For example, applying the approach discussed above with respect to FIG. 18 to N magnitude symbols of BVDₓ 1812 (where N is an integer value), 2^{N} different BVP candidates may be determined-one for each possible combination of values for the N magnitude symbols of BVDₓ 1812. Cost values may be further determined for each of the BVP candidates and sorted to determine a BVP predictor for encoding each of the N magnitude symbols of BVDₓ 1812.

It should be further noted that the approach discussed above with respect to FIG. 18 to entropy code an indication of whether a value of a magnitude symbol of a BVD matches a value of the magnitude symbol of a BVD candidate used as a predictor of the BVD may be applied to one or more magnitude symbols of BVD_{y} 1814 in addition or alternatively to one or more magnitude symbols of BVDₓ 1812.

It should be further noted that, although components BVD_{y} 1814 and BVDₓ 1812 of BVD 1810 and components of BVD candidates were described above as being represented using fixed-length binary, other binarizations of components BVD_{y} 1814 and BVDₓ 1812 of BVD 1810 and components of BVD candidates may be possible. For example, components BVD_{y} 1814 and BVDₓ 1812 of BVD 1810 may be represented using unary, truncated unary, k-th order truncated Rice, k-th order exponential-Golomb (EGk), or some combination of two or more of these binarization processes. For EGk, each codeword includes a unary prefix of length L_{N}+1 and a suffix of length L_{N}+k, where L_{N}=[log₂(N»k)+1)]. For EGk representations of components BVD_{y} 1814 and BVDₓ 1812 of BVD 1810 and components of BVD candidates, any magnitude symbols coded using the approach discussed above with respect to FIG. 18 may be in the respective suffix of one or more of components BVD_{y} 1814 and BVDₓ 1812 of BVD 1810 and components of BVD candidates.

It should be further noted that the approach discussed above with respect to FIG. 18 may be further applied to one or more magnitude symbols of an MVD used in inter prediction in addition or alternatively to one or more magnitude symbols of a BVD used in IBC. For inter prediction, the terms BV, BVP, BVD, and BVD candidate used in FIG. 18 may be replaced by the terms MV, MVP, MVD, and MVD as would be appreciated by a person of ordinary skill in the art based on the present disclosure.

It should be further noted that the approach discussed above with respect to FIG. 18 is applied to IBC and inter prediction based on a translational motion model for the prediction block. In other examples, the approach discussed above with respect to FIG. 18 may be applied to IBC and inter prediction based on an affine motion model for the prediction block.

Finally, it should be noted that the approach discussed above with respect to FIG. 18 to entropy code an indication of whether a value of a magnitude symbol of a BVD matches a value of the magnitude symbol of a BVD candidate used as a predictor of the BVD may be applied to multiple magnitude symbols of the BVD. For example, the above approach may be further applied to one or more magnitude symbols of BVDₓ 1812 other than magnitude symbol 1816 and/or to one or more magnitude symbols of BVD_{y} 1814. For each additional magnitude symbol of BVDₓ 1812 and/or BVD_{y} 1814 that the approach discussed above with respect to FIG. 18 is applied, additional candidate BVPs may be determined. For example, applying the approach discussed above with respect to FIG. 18 to N magnitude symbols of BVDₓ 1812 and/or BVD_{y} 1814 (where N is an integer value), 2^{N} different BVP candidates may be determined-one for each possible combination of values for the N magnitude symbols of BVDₓ 1812 and/or BVD_{y} 1814. Cost values may be further determined for each of the BVP candidates to determine a BVD predictor for encoding each of the N magnitude symbols of BVDₓ 1812 and/or BVD_{y} 1814.

In some implementations, the number of magnitude symbols of a BVD that the approach discussed above with respect to FIG. 18 is applied may be limited to a certain number of magnitude symbols of the BVD. For example, applying the approach discussed above with respect to FIG. 18 to N magnitude symbols of a BVD (where N is an integer value), 2^{N} different BVP candidates may need to be determined (one for each possible combination of values for the N magnitude symbols of the BVD) along with a respective cost value for each of the 2^{N} different BVP candidates. In other words, the number of BVP candidates and cost values that need to be determined may increase exponentially with the number of magnitude symbols of a BVD. Therefore, applying the approach discussed above with respect to FIG. 18 to a large number of magnitude symbols of a BVD may be computationally prohibitive at an encoder and/or decoder. When the number of magnitude symbols of a BVD to be predicted according to the approach discussed above with respect to FIG. 18 is limited to a number less than the total number of magnitude symbols available across both components of the BVD for such prediction, determining how to divide the number of magnitude symbols to be predicted across both components of the BVD is needed.

Example embodiments described herein are directed to apparatuses and methods for determining a number N_{XBP} of most significant symbols of a first magnitude component of a block vector difference (BVD) that are to be predicted based on a number N_{BP} of symbols that are to be predicted across both the first magnitude component of the BVD and a second magnitude component of the BVD. The number N_{BP} may be limited to a number less than the total number of symbols that are available to be predicted across both the first magnitude component of the BVD and the second magnitude component of the BVD. The first magnitude component may be a horizontal magnitude component of the BVD or a vertical magnitude component of the BVD, and the second magnitude component may be the other of the two magnitude components not assigned to the first magnitude component. Embodiments of the present disclosure may further apply the method of FIG. 18 to each of the N_{XBP} most significant symbols of the first magnitude component of the BVD that are to be predicted. For example, embodiments of the present disclosure may, for each of the N_{XBP} most significant symbols of the first magnitude component of the BVD that are to be predicted, entropy encode an indication of whether a value of the most significant symbol of the first magnitude component of the BVD matches a value of the most significant symbol of the first magnitude component of a BVD predictor in accordance with the approach discussed above with respect to FIG. 18.

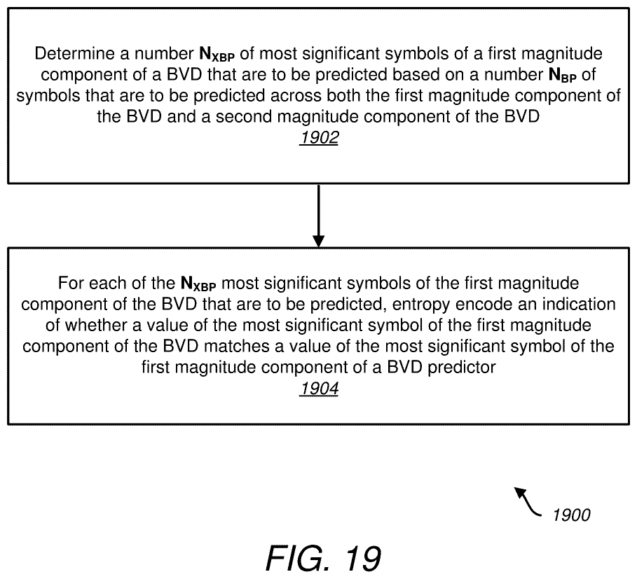

FIG. 19 illustrates a flowchart 1900 of a method that may be implemented by an encoder, such as encoder 200 in FIG. 2, in accordance with embodiments of the present disclosure.

The method of flowchart 1900 begins at 1902. At 1902, the encoder may determine a number N_{XBP} of most significant symbols of a first magnitude component of a block vector difference (BVD) that are to be predicted based on a number N_{BP} of symbols that are to be predicted across both the first magnitude component of the BVD and a second magnitude component of the BVD. The first magnitude component may be a horizontal magnitude component of the BVD or a vertical magnitude component of the BVD, and the second magnitude component may be the other of the two magnitude components not assigned to the first magnitude component. The symbols to be predicted may be predicted according to the approach discussed above with respect to FIG. 18.

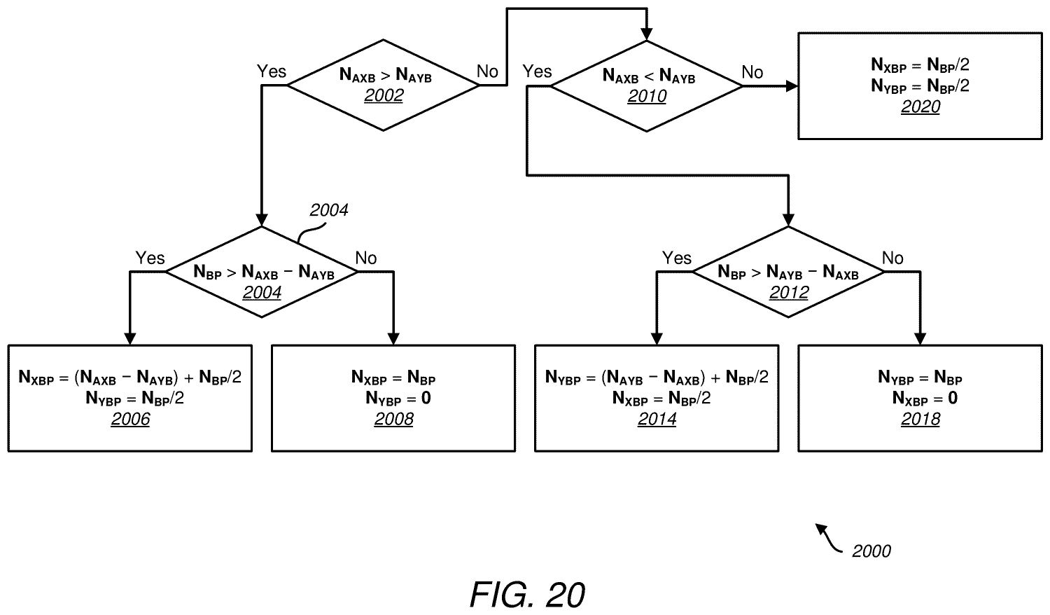

The number N_{BP} may be limited to a number less than the total number of symbols that are available to be predicted across both the first magnitude component of the BVD and the second magnitude component of the BVD (e.g., to limit complexity at the encoder and/or decoder). For example, referring back to FIG. 18, the number N_{BP} may specify the number of symbols that are to be predicted, according to the approach discussed with respect to FIG. 18, across both the horizontal magnitude component BVDₓ 1812 of BVD 1810 and the vertical magnitude component BVD_{y} 1814 of BVD 1810. In one example, the number N_{BP} may be determined based on a size of a block to be predicted (e.g., the number N_{BP} may be smaller for smaller block sizes). The number of symbols available to be predicted across the binary representation of BVDₓ 1812 shown in FIG. 18 may be equal to the total number of symbols in its binary representation or 5 symbols (or bits), and the number of symbols available to be predicted across the binary representation of BVD_{y} 1814 shown in FIG. 18 may also be equal to the total number of symbols in its binary representation or 5 symbols (or bits). The total number of symbols that are available to be predicted across both BVDₓ 1812 and BVD_{y} 1814 may therefore be equal to 5+5 or 10 symbols (or bits). Assuming the number N_{BP} of symbols is equal to 3 symbols, the number N_{BP} is less than the total number symbols (i.e., 10) that are available to be predicted across both BVDₓ 1812 and BVD_{y} 1814. At 1902, the encoder may determine the number N_{XBP} of most significant symbols of one of the two magnitude components of BVDₓ 1812 and BVD_{y} 1814 (referred to as the “first magnitude component” at 1902) that are to be predicted based on the number N_{BP}. For example, at 1902, the encoder may determine the number N_{XBP} of most significant symbols of the first magnitude component to be equal to a number of symbols that is less than or equal to the number of symbols specified by N_{BP}. In other words, at 1902, the encoder may determine the number N_{XBP} of most significant symbols of the first magnitude component to be equal to 0, 1, 2, or 3. If all 3 of the number N_{BP} of symbols that are to be predicted across both the first magnitude component of the BVD and the second magnitude component of the BVD are allocated to the first magnitude component, no magnitude symbols of the second magnitude component may be predicted according the approach discussed above with respect to FIG. 18. Further details with respect to how the encoder may determine the number N_{XBP} of most significant symbols of the first magnitude component to be predicted based on the number N_{BP} of symbols that are to be predicted across both the first magnitude component of the BVD and the second magnitude component of the BVD are provided with respect to FIG. 20 described below.

At 1904, the encoder may, for each of the N_{XBP} most significant symbols of the first magnitude component of the BVD that are to be predicted, entropy encoding an indication of whether a value of the most significant symbol of the first magnitude component of the BVD matches a value of the most significant symbol of the first magnitude component of a BVD predictor in accordance with the approach discussed above with respect to FIG. 18.

FIG. 20 illustrates a flowchart 2000 of an example method for performing 1902 of FIG. 19 in accordance with embodiments of the present disclosure. It should be noted that one or more of the steps of the method of flowchart 2000 may be optional and may be omitted in other embodiments. It should be also noted that the order of the steps shown in flowchart 2000 is not necessarily the only order for carrying out the method of flowchart 2000. In other embodiments, the order of the steps of flowchart 2000 may be modified.

The method of flowchart 2000 begins at 2002. At 2002, the encoder may determine whether a number N_{AXB} of symbols of the first magnitude component of the BVD that are available to be predicted is greater than a number N_{AYB} of symbols of the second magnitude component of the BVD that are available to be predicted. As mentioned above with respect to FIG. 19, the first magnitude component may be a horizontal magnitude component of the BVD or a vertical magnitude component of the BVD, and the second magnitude component may be the other of the two magnitude components not assigned to the first magnitude component.

In an example, N_{AXB} and N_{AYB} may be determined based on (e.g., equal to) the number of symbols used to represent the first magnitude component and the number of symbols used to represent the second magnitude component, respectively. For example, in the binary representation of the horizontal magnitude component BVDₓ 1812 of BVD 1810 in FIG. 18, 5 symbols (or bits) are used to represent BVDₓ 1812.

Assuming N_{AXB} corresponds to BVDₓ 1812, N_{AXB} may be determined to be equal to 5 symbols (or bits) or the number of symbols used to represent BVDₓ 1812.

In another example, N_{AXB} and N_{AYB} may be determined based on (e.g., equal to) the number of symbols of a suffix used to represent the first magnitude component and the number of symbols of a suffix used to represent the second magnitude component, respectively. In this example, symbols of the first magnitude component of the BVD that are available to be predicted may be limited to symbols of the suffix of the code word used to represent the first magnitude component, and symbols of the second magnitude component of the BVD that are available to be predicted may be limited to symbols of the suffix of the code word used to represent the second magnitude component. In another example, symbols of the first magnitude component of the BVD that are available to be predicted may be limited to symbols of the suffix of the code word used to represent the first magnitude component less some predetermined amount, and symbols of the second magnitude component of the BVD that are available to be predicted may be limited to symbols of the suffix of the code word used to represent the second magnitude component less some predetermined amount.

In general, the first and second magnitude components may be represented by one of a wide range of codes that include two parts: a prefix and a suffix as mentioned above. Such codes include, for example, Rice codes and Golomb codes (e.g., Golomb-Rice codes or Exponential Golomb codes). For example, referring back to FIG. 18, the magnitude of horizontal component BVDₓ 1812 of BVD 1810 may be binarized using a Golomb-Rice code. Golomb-Rice codes have the structure discussed above, with a prefix that that indicates a range of values and a suffix that indicates a precise value within the range of values. A Golomb-Rice code C_{gr k}(v) of order k includes a unary coded prefix and k suffix bits. The k suffix bits are a binary representation of an integer 0≤i<2^{k}. An example of a Golomb-Rice code for k=4 is given in Table 1 below. In the table and the following explanation, x₀, x₁, . . . , xₙ denote bits of the code word with xₙϵ{0, 1}.

TABLE 1

| v | C_{gr 4}(v) |
|---|---|
| 0, . . . , 15 | 1 x₃, x₂, x₁, x₀ |
| 16, . . . , 31 | 0 1 x₃, x₂, x₁, x₀ |
| 32, . . . , 47 | 0 0 1 x₃, x₂, x₁, x₀ |
| . | . |
| . | . |
| . | . |

The number of prefix bits is denoted by nₚ, the number of suffix bits is denoted by nₛ. For the Golomb-Rice code, the number of suffix bits is nₛ=k. When encoding a value v, the number of prefix bits is determined by:

$${n}_{p} = 1 + ⌊ \frac{v}{{2}^{k}} ⌋ . \qquad ( 19 )$$

└x┘ is the integer part of x. The suffix is the nₛ-bit representation of:

$${v}_{s} = v - {2}^{k} ( {n}_{p} - 1 ) . \qquad ( 20 )$$

The Golomb-Rice codes discussed above use a suffix of fixed length. The length of the suffix may also be determined by the length of the prefix. Exponential Golomb codes (Exp-Golomb) use this approach and can further be used to binarize the magnitude of horizontal component BVDₓ 1812 of BVD 1810. A kth-order Exp-Golomb code C_{eg k}(V) includes a unary prefix code and a suffix of variable length. The number of bits in the suffix nₛ is determined by the value no as follows:

$${n}_{s} = k + {n}_{p} - 1 . \qquad ( 21 )$$

The number of prefix bits nₚ of C_{eg k}(v) is determined from the value v by:

$${2}^{k} ( {2}^{{n}_{p} - 1} - 1 ) \leq v \leq {2}^{k} ( {2}^{{n}_{p}} - 1 ) . \qquad ( 22 )$$

The suffix is then the nₛ-bit representation of:

$${v}_{s} = v - {2}^{k} ( {2}^{{n}_{p}} - 1 ) . \qquad ( 23 )$$

An example of Exp-Golomb codes for k=1 is given in Table 2 below.

TABLE 2

| v | C_{gr 4}(v) |
|---|---|
| 0, 1 | 1 x₀ |
| 2,. . . , 5 | 0 1 x₁, x₀ |
| 6, . . . , 13 | 0 0 1 x₂, x₁, x₀ |
| 14, . . . , 29 | 0 0 0 1 x₃, x₂, x₁, x₀ |
| . | . |
| . | . |
| . | . |

In the example of FIG. 18, the magnitude of horizontal component BVDₓ 1812 of BVD 1810 has a value of 19 in base 10, which may be represented by a Golomb-Rice code or an Exp-Golomb code. For example, the magnitude of BVDₓ 1812 may be represented by the Exp-Golomb code of order k=4 with a prefix of “0001” and a suffix of “0101”. The prefix “0001” indicates that the magnitude of BVDₓ 1812 falls within the range of values 14-29, and the suffix “0101” indicates that the magnitude of BVDₓ 1812 has the precise value of 19 within the range of values of 14-29. In the example of FIG. 18, the magnitude of vertical component BVD_{y} 1814 of BVD 1810 has a value of 11 in base 10, which may be represented by a Golomb-Rice code or an Exp-Golomb code. For example, the magnitude of BVD_{y} 1814 may be represented by the Exp-Golomb code of order k=4 with a prefix of “001” and a suffix of “101”. The prefix “001” indicates that the magnitude of BVD_{y} 1814 falls within the range of values 6-13, and the suffix “101” indicates that the magnitude of BVD_{y} 1814 has the precise value of 11 within the range of values of 6-13.

Referring back to FIG. 20 and in another example, the encoder may determine, at 2002, whether N_{AXB} is greater than N_{AYB} based on the number of symbols of a prefix of a code word used to represent the first magnitude component and a number of symbols of a prefix of a code word used to represent the second magnitude component, respectively. For example, based on the number of symbols in the prefix of the code word used to represent the first magnitude component being greater than the number of symbols in the prefix of the code word used to represent the second magnitude component, the encoder may determine that N_{AXB} is greater than N_{AYB}. In this example, symbols of the first magnitude component of the BVD that are available to be predicted may be limited to symbols of a suffix of the code word used to represent the first magnitude component, and symbols of the second magnitude component of the BVD that are available to be predicted may be limited to symbols of a suffix of the code word used to represent the second magnitude component. The number of symbols of a prefix provides an indication of the number of symbols of the suffix.

Based on determining that N_{AXB} is greater than N_{AYB} at 2002, the encoder may proceed to 2004. At 2004, the encoder may determine whether N_{BP} is greater than the difference between N_{AXB} and N_{AYB} (i.e., N_{AXB}−N_{AYB}). Based on determining that N_{BP} is greater than the difference between N_{AXB} and N_{AYB} at 2004, the encoder may proceed to 2006. At 2006, the encoder may determine N_{XBP} based on (e.g., equal to) a sum of: the difference between N_{AXB} and N_{AYB} (i.e., N_{AXB}−N_{AYB}); and N_{BP}/2 or the floor or ceiling of N_{BP}/2. At 2006, the encoder may further determine a number N_{YBP} of most significant symbols of the second magnitude component of the BVD that are to be predicted to be equal to N_{BP}/2 or the floor or ceiling of N_{BP}/2. The encoder may, for each of the N_{YBP} most significant symbols of the second magnitude component of the BVD that are to be predicted, entropy encode an indication of whether a value of the most significant symbol of the second magnitude component of the BVD matches a value of the most significant symbol of the second magnitude component of the BVD predictor in accordance with the approach discussed above with respect to FIG. 18. Based on determining that N_{BP} is not greater than the difference between N_{AXB} and N_{AYB} at 2004, the encoder may proceed to 2008. At 2008, the encoder may determine N_{XBP} based on (e.g., equal to) N_{BP}. At 2008, the encoder may further determine N_{YBP} equal to 0.

Based on determining that N_{AXB} is not greater than N_{AYB} at 2002, the encoder may proceed to 2010. At 2010, the encoder may determine whether N_{AXB} is less than N_{AYB}.

Based on determining that N_{AXB} is less than N_{AYB} at 2010, the encoder may proceed to 2012. At 2012, the encoder may determine whether N_{BP} is greater than the difference between N_{AYB} and N_{AXB} (i.e., N_{AYB}−N_{AXB}). Based on determining that N_{BP} is greater than the difference between N_{AYB} and N_{AXB} at 2012, the encoder may proceed to 2014. At 2014, the encoder may determine N_{YBP} based on (e.g., equal to) a sum of: the difference between N_{AYB} and N_{AXB} (i.e., N_{AYB}−N_{AXB}); and N_{BP}/2 or the floor or ceiling of N_{BP}/2. The encoder may, for each of the N_{YBP} most significant symbols of the second magnitude component of the BVD that are to be predicted, entropy encode an indication of whether a value of the most significant symbol of the second magnitude component of the BVD matches a value of the most significant symbol of the second magnitude component of the BVD predictor in accordance with the approach discussed above with respect to FIG. 18. At 2014, the encoder may further determine N_{XBP} equal to N_{BP}/2 or the floor or ceiling of N_{BP}/2. Based on determining that N_{BP} is not greater than the difference between N_{AXB} and N_{AYB} at 2012, the encoder may proceed to 2018. At 2018, the encoder may determine N_{YBP} based on (e.g., equal to) N_{BP}. At 2018, the encoder may further determine N_{XBP} equal to 0.

Based on determining that N_{AXB} is not less than N_{AYB} at 2010, the encoder may proceed to 2020. At 2020, the encoder may determine N_{XBP} equal to N_{BP}/2 or the floor or ceiling of N_{BP}/2 and N_{YBP} equal to N_{BP}/2 or the floor or ceiling of N_{BP}/2.

It should be noted that, in the case that N_{BP} is equal to zero, the encoder may determine both N_{XBP} and N_{YBP} equal to zero. For example, the encoder may, prior to performing the method of flowchart 2000, determine if N_{BP} is equal to zero and, if N_{BP} is equal to zero, determine both N_{XBP} and N_{YBP} equal to zero. In general, the method of flowchart 2000 may assign more of the number N_{BP} of symbols that are to be predicted across both the first magnitude component of the BVD and the second magnitude component of the BVD, the magnitude component of the BVD with more significant symbols available to be predicted according to the approach discussed above with respect to FIG. 18. This is because the compression efficiency of the approach discussed above with respect to FIG. 18 is likely to be greater for these symbols.

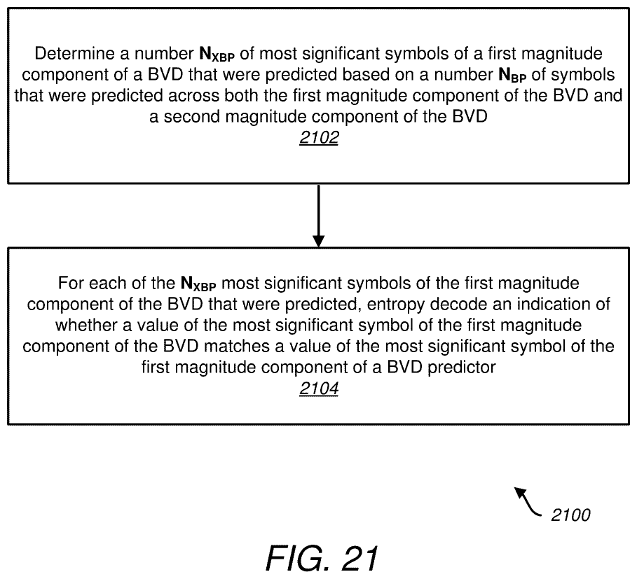

FIG. 21 illustrates a flowchart 2100 of a method that may be implemented by an decoder, such as decoder 300 in FIG. 3, in accordance with embodiments of the present disclosure.

The method of flowchart 2100 begins at 2102. At 2102, the decoder may determine a number N_{XBP} of most significant symbols of a first magnitude component of a block vector difference (BVD) that were predicted based on a number N_{BP} of symbols that were predicted across both the first magnitude component of the BVD and a second magnitude component of the BVD. The first magnitude component may be a horizontal magnitude component of the BVD or a vertical magnitude component of the BVD, and the second magnitude component may be the other of the two magnitude components not assigned to the first magnitude component. The symbols that were predicted may have been predicted according to the approach discussed above with respect to FIG. 18.

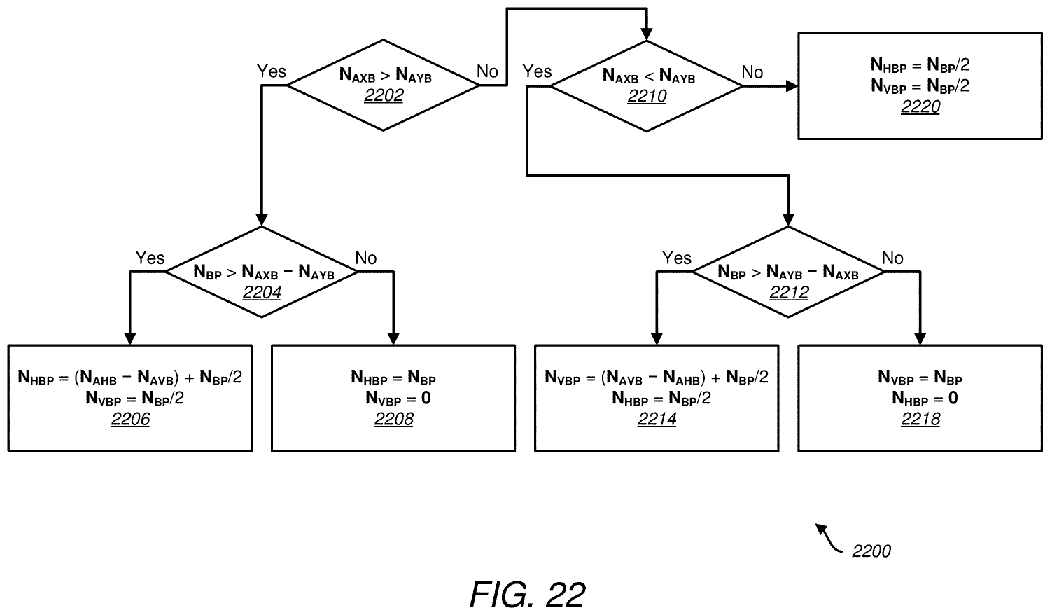

The number N_{BP} may be limited to a number less than the total number of symbols that were available to be predicted across both the first magnitude component of the BVD and the second magnitude component of the BVD (e.g., to limit complexity at the encoder and/or decoder). For example, referring back to FIG. 18, the number N_{BP} may specify the number of symbols that were predicted, according to the approach discussed with respect to FIG. 18, across both the horizontal magnitude component BVDₓ 1812 of BVD 1810 and the vertical magnitude component BVD_{y} 1814 of BVD 1810. In one example, the number N_{BP} may be determined based on a size of a block to be predicted (e.g., the number N_{BP} may be smaller for smaller block sizes). The number of symbols that were available to be predicted across the binary representation of BVDₓ 1812 shown in FIG. 18 may be equal to the total number of symbols in its binary representation or 5 symbols (or bits), and the number of symbols that were available to be predicted across the binary representation of BVD_{y} 1814 shown in FIG. 18 may also be equal to the total number of symbols in its binary representation or 5 symbols (or bits). The total number of symbols that were available to be predicted across both BVDₓ 1812 and BVD_{y} 1814 may therefore be equal to 5+5 or 10 symbols (or bits). Assuming the number N_{BP} of symbols is equal to 3 symbols, the number N_{BP} is less than the total number of symbols (i.e., 10) that were available to be predicted across both BVDₓ 1812 and BVD_{y} 1814. At 2102, the decoder may determine the number N_{XBP} of most significant symbols of one of the two magnitude components of BVDₓ 1812 and BVD_{y} 1814 (referred to as the “first magnitude component” at 2102) that were predicted based on the number N_{BP}. For example, at 2102, the decoder may determine the number N_{XBP} of most significant symbols of the first magnitude component to be equal to a number of symbols that is less than or equal to the number of symbols specified by N_{BP}. In other words, at 2102, the decoder may determine the number N_{XBP} of most significant symbols of the first magnitude component to be equal to 0, 1, 2, or 3. If all 3 of the number N_{BP} of symbols that were predicted across both the first magnitude component of the BVD and the second magnitude component of the BVD were allocated to the first magnitude component, no magnitude symbols of the second magnitude component may have been predicted according the approach discussed above with respect to FIG. 18. Further details with respect to how the decoder may determine the number N_{XBP} of most significant symbols of the first magnitude component that were predicted based on the number N_{BP} of symbols that were predicted across both the first magnitude component of the BVD and the second magnitude component of the BVD are provided with respect to FIG. 22 described below.

At 2104, the decoder may, for each of the N_{XBP} most significant symbols of the first magnitude component of the BVD that were predicted, entropy decode an indication of whether a value of the most significant symbol of the first magnitude component of the BVD matches a value of the most significant symbol of the first magnitude component of a BVD predictor in accordance with the approach discussed above with respect to FIG. 18. Although not show in FIG. 21, the method of flowchart 2100 may further determine a value of the most significant symbol of the first magnitude component of the BVD based on the value of the most significant symbol of the first magnitude component of the BVD predictor and the indication.

FIG. 22 illustrates a flowchart 2200 of an example method for performing 2102 of FIG. 21 in accordance with embodiments of the present disclosure. It should be noted that one or more of the steps of the method of flowchart 2200 may be optional and may be omitted in other embodiments. It should be also noted that the order of the steps shown in flowchart 2200 is not necessarily the only order for carrying out the method of flowchart 2200. In other embodiments, the order of the steps of flowchart 2200 may be modified.

The method of flowchart 2200 begins at 2202. At 2202, the decoder may determine whether a number N_{AXB} of symbols of the first magnitude component of the BVD that were available to be predicted is greater than a number N_{AYB} of symbols of the second magnitude component of the BVD that were available to be predicted. As mentioned above with respect to FIG. 19, the first magnitude component may be a horizontal magnitude component of the BVD or a vertical magnitude component of the BVD, and the second magnitude component may be the other of the two magnitude components not assigned to the first magnitude component.

In an example, N_{AXB} and N_{AYB} may be determined based on (e.g., equal to) the number of symbols used to represent the first magnitude component and the number of symbols used to represent the second magnitude component, respectively. For example, in the binary representation of the horizontal magnitude component BVDₓ 1812 of BVD 1810 in FIG. 18, 5 symbols (or bits) are used to represent BVDₓ 1812. Assuming N_{AXB} corresponds to BVDₓ 1812, N_{AXB} may be determined to be equal to 5 symbols (or bits) or the number of symbols used to represent BVDₓ 1812.

In another example, N_{AXB} and N_{AYB} may be determined based on (e.g., equal to) the number of symbols of a suffix used to represent the first magnitude component and the number of symbols of a suffix used to represent the second magnitude component, respectively. In this example, symbols of the first magnitude component of the BVD that were available to be predicted may be limited to symbols of the suffix of the code word used to represent the first magnitude component, and symbols of the second magnitude component of the BVD that were available to be predicted may be limited to symbols of the suffix of the code word used to represent the second magnitude component. In another example, symbols of the first magnitude component of the BVD that were available to be predicted may be limited to symbols of the suffix of the code word used to represent the first magnitude component less some predetermined amount, and symbols of the second magnitude component of the BVD that were available to be predicted may be limited to symbols of the suffix of the code word used to represent the second magnitude component less some predetermined amount.

In general, the first and second magnitude components may be represented by one of a wide range of codes that include two parts: a prefix and a suffix as mentioned above. Such codes include, for example, Rice codes and Golomb codes (e.g., Golomb-Rice codes or Exponential Golomb codes). For example, referring back to FIG. 18, the magnitude of horizontal component BVDₓ 1812 of BVD 1810 may be binarized using a Rice code or a Golomb code.

In another example, the decoder may determine, at 2202, whether N_{AXB} is greater than N_{AYB} based on the number of symbols of a prefix of a code word used to represent the first magnitude component and a number of symbols of a prefix of a code word used to represent the second magnitude component, respectively. For example, based on the number of symbols in the prefix of the code word used to represent the first magnitude component being greater than the number of symbols in the prefix of the code word used to represent the second magnitude component, the decoder may determine that N_{AXB} is greater than N_{AYB}. In this example, symbols of the first magnitude component of the BVD that were available to be predicted may be limited to symbols of a suffix of the code word used to represent the first magnitude component, and symbols of the second magnitude component of the BVD that were available to be predicted may be limited to symbols of a suffix of the code word used to represent the second magnitude component. The number of symbols of a prefix provides an indication of the number of symbols of the suffix.

Based on determining that N_{AXB} is greater than N_{AYB} at 2202, the decoder may proceed to 2204. At 2204, the decoder may determine whether N_{BP} is greater than the difference between N_{AXB} and N_{AYB} (i.e., N_{AXB}−N_{AYB}). Based on determining that N_{BP} is greater than the difference between N_{AXB} and N_{AYB} at 2204, the decoder may proceed to 2206. At 2206, the decoder may determine N_{XBP} based on (e.g., equal to) a sum of: the difference between N_{AXB} and N_{AYB} (i.e., N_{AXB}−N_{AYB}); and N_{BP}/2 or the floor or ceiling of N_{BP}/2. At 2206, the decoder may further determine a number N_{YBP} of most significant symbols of the second magnitude component of the BVD that were predicted to be equal to N_{BP}/2 or the floor or ceiling of N_{BP}/2. The decoder may, for each of the N_{YBP} most significant symbols of the second magnitude component of the BVD that were predicted, entropy decode an indication of whether a value of the most significant symbol of the second magnitude component of the BVD matches a value of the most significant symbol of the second magnitude component of the BVD predictor in accordance with the approach discussed above with respect to FIG. 18. The decoder may further determine a value of the most significant symbol of the second magnitude component of the BVD based on the value of the most significant symbol of the second magnitude component of the BVD predictor and the indication. Based on determining that N_{BP} is not greater than the difference between N_{AXB} and N_{AYB} at 2204, the decoder may proceed to 2208. At 2208, the decoder may determine N_{XBP} based on (e.g., equal to) N_{BP}. At 2208, the decoder may further determine N_{YBP} equal to 0.

Based on determining that N_{AXB} is not greater than N_{AYB} at 2202, the decoder may proceed to 2210. At 2210, the decoder may determine whether N_{AXB} is less than N_{AYB}.

Based on determining that N_{AXB} is less than N_{AYB} at 2210, the decoder may proceed to 2212. At 2212, the decoder may determine whether N_{BP} is greater than the difference between N_{AYB} and N_{AXB} (i.e., N_{AYB}−N_{AXB}). Based on determining that N_{BP} is greater than the difference between N_{AYB} and N_{AXB} at 2212, the decoder may proceed to 2214. At 2214, the decoder may determine N_{YBP} based on (e.g., equal to) a sum of: the difference between N_{AYB} and N_{AXB} (i.e., N_{AYB}−N_{AXB}); and N_{BP}/2 or the floor or ceiling of N_{BP}/2. The decoder may, for each of the N_{YBP} most significant symbols of the second magnitude component of the BVD that were predicted, entropy decode an indication of whether a value of the most significant symbol of the second magnitude component of the BVD matches a value of the most significant symbol of the second magnitude component of the BVD predictor in accordance with the approach discussed above with respect to FIG. 18. The decoder may further determine a value of the most significant symbol of the second magnitude component of the BVD based on the value of the most significant symbol of the second magnitude component of the BVD predictor and the indication. At 2214, the decoder may further determine N_{XBP} equal to N_{BP}/2 or the floor or ceiling of N_{BP}/2. Based on determining that N_{BP} is not greater than the difference between N_{AXB} and N_{AYB} at 2212, the decoder may proceed to 2218. At 2218, the decoder may determine N_{YBP} based on (e.g., equal to) N_{BP}. At 2218, the decoder may further determine N_{XBP} equal to 0.

Based on determining that N_{AXB} is not less than N_{AYB} at 2210, the decoder may proceed to 2220. At 2220, the decoder may determine N_{XBP} equal to N_{BP}/2 or the floor or ceiling of N_{BP}/2 and N_{YBP} equal to N_{BP}/2 or the floor or ceiling of N_{BP}/2.

It should be noted that, in the case that N_{BP} is equal to zero, the decoder may determine both N_{XBP} and N_{YBP} equal to zero. For example, the decoder may, prior to performing the method of flowchart 2200, determine if N_{BP} is equal to zero and, if N_{BP} is equal to zero, determine both N_{XBP} and N_{YBP} equal to zero.

It should be noted that the methods discussed above with respect to FIGS. 19-22 may be further applied to one or more magnitude symbols of an MVD used in inter prediction in addition or alternatively to one or more magnitude symbols of a BVD used in IBC, as will be further described below. For inter prediction, the terms BV, BVP, BVD, and BVD candidate may be replaced by the terms MV, MVP, MVD, and MVD as would be appreciated by a person of ordinary skill in the art based on the present disclosure.

In some examples, various models for motion compensation may be used for prediction. Such models may include uni-prediction in which a block of reference samples is filtered horizontally and vertically, in accordance with sub-sample shift indicated by a MV (Motion Vector). The result may be used as a predicted block. Another example model may include bi-prediction, in which samples of two uni-predicted blocks are linearly combined. Another example model may include affine prediction (which may be uni- or bi-prediction), in which MVs are defined individually for subblocks of the reference blocks. Derivation of subblock MVs may be controlled by 2 or 3 control points, position of these points are represented by 3 MVs per each reference block.

In some examples, motion vector sign derivation (MVSD) may be used in which signs are predicted for either L0 or L1, but not both. In case L0 has at least one non-zero component of a MVD, signs of L0 MVDs are predicted, and signs of L1 are coded explicitly. However, in case all of MVDs of L0 are zero, prediction of signs for L1 MVDs is performed.

In existing technologies, although a sign is the most significant bin of an integer number in different formats (including exponential Golomb code), it may be more beneficial to predict sign and suffix bins of MVDs in addition to MVD signs, if the magnitudes of MVDs or MVD components significantly differ from each other. In existing approaches, motion vector sign derivation (MVSD) may be used in which signs are predicted for either L0 or L1, but not both. In case L0 has at least one non-zero component of a MVD, signs of L0 MVDs are predicted, and signs of L1 are coded explicitly. However, in case all of MVDs of L0 are zero, prediction of signs for L1 MVDs is performed. Additionally, for motion vector sign derivation (MSVD), the hardware used for performing template matching (TM) operations may stall due to the lack of MVD signs, although MVD suffix bins are still available for prediction. In further examples, when signs and most significant suffix bins of MVDs are predicted (similar to predicting signs and suffix bins of BVDs as discussed further above), the bin selection needs to not only consider the significance of both MVD signs and MVD suffix bins, but also consider the reference lists from which they are from. Existing approaches do not provide for, e.g., predicting MVD sign and suffix bins of multiple MVD components from multiple reference picture lists, which limits potential prediction performance for MVDs, particularly when affine prediction modes are enabled.

Embodiments of the present disclosure are directed to apparatuses and methods for selecting a reference picture list (RPL) and selecting within each MVD component of the selected RPL a subset of most significant symbols for prediction or decoding. In an example embodiment, an encoder may determine first symbols available for prediction of motion vector difference (MVD) components of MVDs of a first reference picture list (RPL) from RPLs. The encoder may further determine second symbols available for prediction of MVD components of MVDs of a second RPL from the RPLs. The encoder may further select, based on the first symbols and the second symbols, the first RPL from the first RPL and the second RPL. The encoder may further select, within each of the MVD components of the first RPL, a subset of most significant symbols for prediction. And, the encoder may further entropy encode, in a bitstream for each symbol of the selected subset, an indication of whether a value of each symbol is equal to a value of a corresponding symbol of an MVD predictor. In another example embodiment, a decoder may determine first symbols available for prediction of motion vector difference (MVD) components of MVDs of a first reference picture list (RPL) from RPLs. The decoder may further determine second symbols available for prediction of MVD components of MVDs of a second RPL from the RPLs. The decoder may further select, based on the first symbols and the second symbols, the first RPL from the first RPL and the second RPL. The decoder may further select, within each of the MVD components of the first RPL, a subset of most significant symbols for decoding. The decoder may further entropy decode, from a bitstream for each symbol of the selected subset, an indication of whether a value of each symbol is equal to a value of a corresponding symbol of an MVD predictor. And, the decoder may further determine, for each symbol of the selected subset, a value of each symbol based on the indication and a value of the corresponding symbol of the MVD predictor.

These and other features of the present disclosure are described further below.

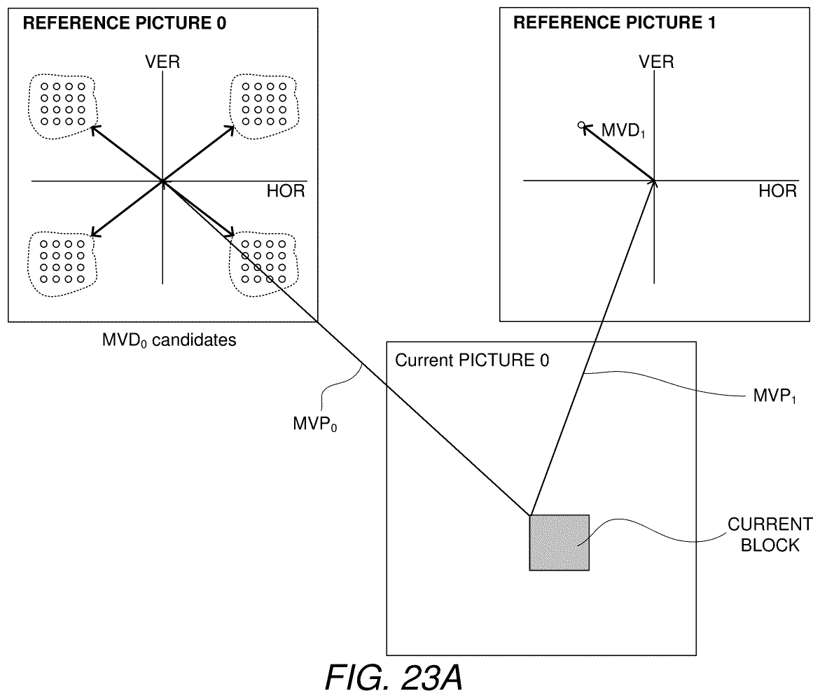

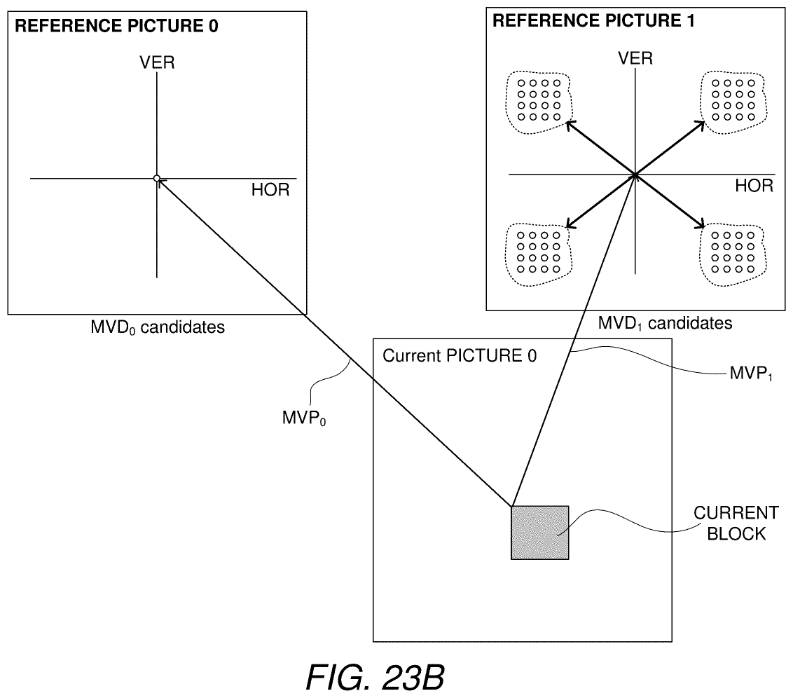

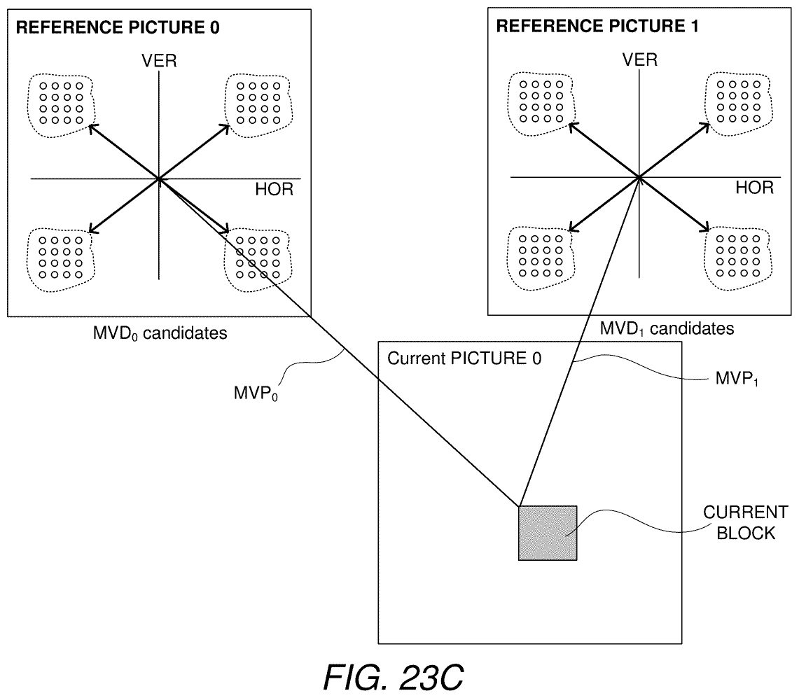

FIGS. 23A-C illustrate examples of candidate vectors for translational models of motion compensation, according to some embodiments. For example, FIG. 23A illustrates an example of sign and/or suffixes of one of L0 MVDs or L1 MVDs (e.g., L0) being predicted. FIG. 23B illustrates an example of sign and/or suffixes of one of L0 MVDs or L1 MVDs (e.g., L1) being predicted. In a further example, FIG. 23C illustrates an example of signs and/or suffixes of both L0 MVDs and L1 MVDs being predicted.

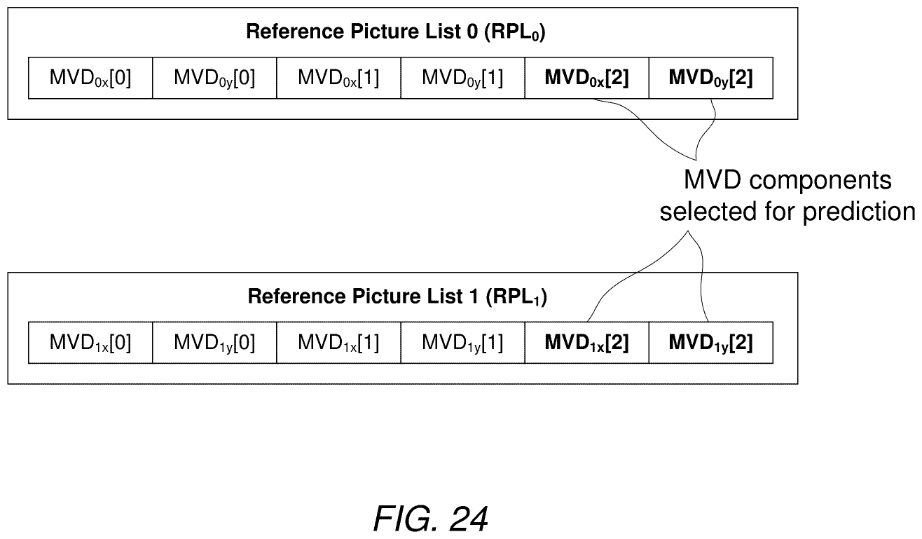

As explained above, expanding selection of bins of a BVD to predict to a MVD significantly increases the types of numbers of vector components. FIG. 24 illustrates an example of candidate vectors, from both L0 MVDs and/or L1 MVDs for an affine model of motion compensation, where MVD signs and/or magnitude symbols are predicted, according to some embodiments. Due to the two lists, L0 and L1, and the motion compensation mode (e.g., the affine mode), there may be 12 or more component vectors from which symbols including signs and/or suffix bins may be selected for prediction.

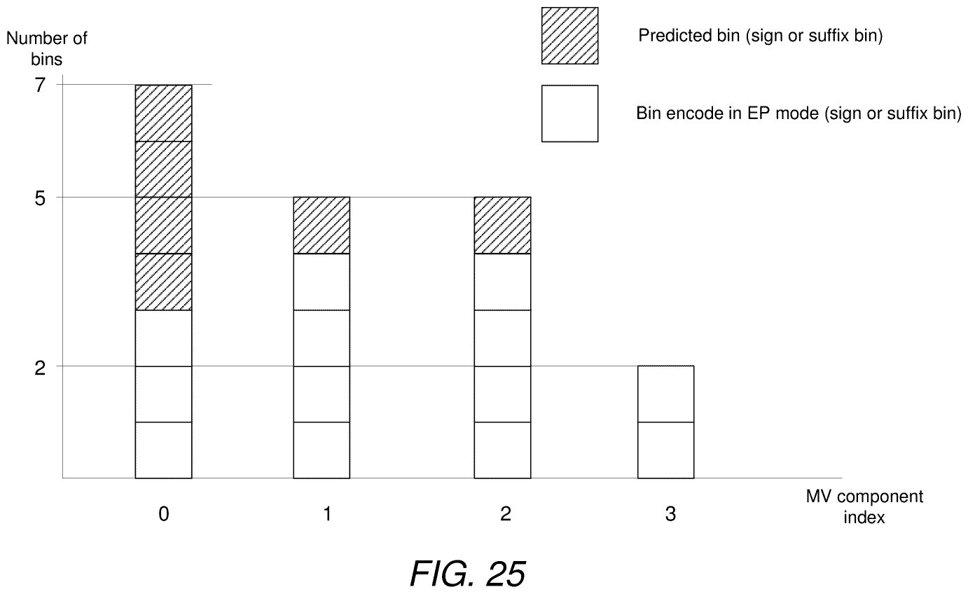

In some examples, for a number of symbols to be predicted, selection of one or more symbols (which may include sign symbols or magnitude symbols) up to the number of symbols may be based on one or more of: an MV component index (e.g., based on a reference list), and/or a significance of the bin. For example, a sign of each vector component may be considered as the most significant bin of a syntax element representing a value of that vector component. FIG. 25 illustrates an example of selection of bins to be predicted for a subset of non-zero MV components, with an example total bin prediction target of 6 bins, according to some embodiments.

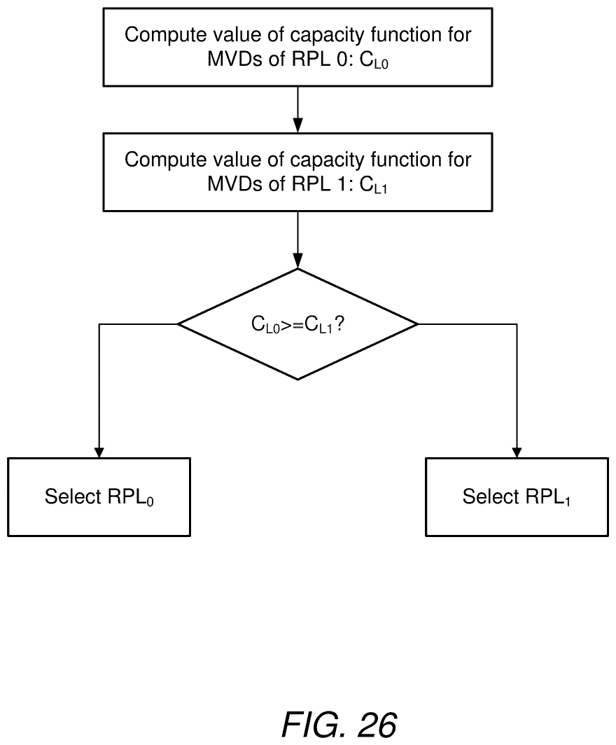

In some embodiments, an RPL list from which suffix bins and signs of MVD vector components can be selected. For example, an RPL list may be selected based on numbers of available bins (from which one or more bins may be selected to be predicted) of vector components within each RPL list, as will be further described below. When a block is performed using bi-prediction, MVDs of two reference picture lists are indicated in a bitstream, from which on RPL list may be selected. FIG. 26 illustrates a flowchart of a method for selecting a reference picture list (RPL) for prediction of symbols of an MVD, according to some embodiments.

In some examples, values of capacity function may be calculated for reference picture list 0 and reference picture list 1. Based on these values, prediction of suffix and sign bins may be determined/selected based on a RPL selected from reference picture list 0 (“RPL₀”) or in reference picture list 1 (“RPL₁”). For example, capacity values may be calculated and compared such that a RPL with higher capacity function value may be selected to have signs and/or suffix bins be predicted. In some embodiments, when the value of capacity function for RPL₀ is equal to the value of capacity function for RPL₁, one or more of the following methods may be applied to select the RPL for prediction.

In some examples, a set of bin counters may be initialized, where one bit counter corresponds to a nonzero MVD component of the input RPL. A resulting value binWeightSum may be initialized to 0. The initial value of the bin counter is set equal to the number of bins for the corresponding MVD component. In some examples, the following steps may be performed in iterations, the number of iterations being equal to the total bin budget “curBinBudget”. Firstly, a maximum value “maxVal” is determined among the values of bin counters belonging to the set of bin counters. Secondly, if maxVal is equal to 0, the process ends and the value of the capacity function is set equal to binWeightSum. Thirdly, the value of the bin counter, for which “maxVal” was found is decreased by 1. Fourthly, binWeightSum is increased by the value of weight determined for the “maxVal” value. Fifthly, if the last iteration is performed, the value of binWeightSum is returned as the result.

Herein, a total bin budget (e.g., “curBinBudget” above) may also be referred to as a prediction target value. For example, a prediction target value may indicate how may total bins may be allocated for prediction, as described further herein.

In some examples, determination of the weight value may be based on the bin significance “binPos” (which is equal to the “maxValue”). For example, this could be performed according to (24) below:

$$W ( binPos ) = Offset + binPos - 1 \qquad ( 24 )$$

In an example, the value of the “Offset” may be set equal to 10. Herein, the “Offset” may also be referred to as a predetermined offset value. The input argument “binPos” in “W(binPos)” may be set equal to maxValue defined in the iterations described above.

In some examples, bins with different significance levels (and located at different positions indicated by, e.g., “binPos”) may have different probabilities of being predicted correctly. For example, the more significant position(s) of the bin inside a suffix may correspond to a higher probability of being predicted correctly, because its value provides greater displacement of an MVD along the direction of the MVD component.

In some embodiments, the value of a capacity function for an RPL may be calculated. For example, the number of non-zero MVD components may be determined. For each non-zero MVD component, the number of bins per component may be calculated. The value of the capacity function may be set equal to the sum of the determined numbers of bins per component. Herein determining the value of the capacity function may also be referred to as determining a first prediction capacity or a second prediction capacity.

In some examples, a selection between a weighted and a non-weighted method of RPL selection may be determined by comparing the total bin budget “curBinBudget” with the sum of the number of bins of MVD components for RPL₀ and RPL₁. When the curBinBudget is less than at least one sum of bins defined for RPL₀ or for RPL₁, a weighted method may be used to select an RPL for bin prediction. Otherwise, an RPL for bin prediction may be selected using a non-weighted method.

In some embodiments, when “curBinBudget” is not greater than the sum of the number of bins of MVD components for RPL₀ and when “curBinBudget” is greater than the sum of the number of bins of MVD components for RPL₁, RPL₀ is used for bin and sign prediction. When “curBinBudget” is greater than the sum of the number of bins of MVD components for RPL₀ and when “curBinBudget” is not greater than the sum of the number of bins of MVD components for RPL₁, RPL₁ is used for bin and sign prediction.

In some embodiments, determining which bins and signs of MVD components (and specifically which MV components) are predicted may be based on a given number of bins that may be predicted, or a given number of bins available for prediction. For a block, a number of predicted bins (e.g., a total bin budget, or a prediction target value) may be defined. In an embodiment, it may be set to some constant value (e.g., to 6 bins), or it may be determined with respect to some property of a predicted block (or reference block). For example, for a block of size 8×8 (comprising 64 samples) and larger, a total bin budget may be set equal to 6 bins. For blocks that are smaller than 8×8 (comprising less than 64 samples) a total bin budget may be defined to be equal to 2 bins. In another embodiment, for a block of size 8×8 (comprising 64 samples) and larger, a total bin budget of 8 bins may be defined.

In an embodiment, a maximum of 6 bins (including sign bins) are predicted for blocks with width and height larger than 4 samples (affine motion compensation is enabled for these block sizes), and maximum of 2 bins are predicted for blocks that have either width or height equal to 4 samples (affine motion compensation is disabled for these block sizes). In this embodiment, a total bin budget is defined in accordance with the block size. In case a block has at least one side equal to 4, a total bin budget is equal to 2. In case a block has both sides greater than, a total bin budget is equal to 6.

In some embodiments, a maximum of 6 bins (including sign bins) are predicted for blocks with width and height larger than 4 samples (affine motion compensation is enabled for these block sizes), and maximum of 4 bins are predicted for blocks that have either width or height equal to 4 samples (affine motion compensation is disabled for these block sizes). In this embodiment, a total bin budget is defined in accordance with the block size. In case a block has at least one side equal to 4, a total bin budget is equal to 2. In case a block has both sides greater than, a total bin budget is equal to 6.

In some embodiments, a total bin budget is defined in accordance with the number of samples inside a block. In case a block has at least 64 samples, a total bin budget is equal to 6. In case a block has less than 64 samples, a total bin budget is equal to 2.

In some embodiments, a total bin budget is defined in accordance with the number of samples inside a block. In case a block has at least 64 samples, a total bin budget is equal to 6. In case a block has less than 64 samples, a total bin budget is equal to 4.

The size constraint for the total bin budget determination is aligned with constraint on whether affine motion compensation is allowed for a block. If affine motion compensation is used, 3 MVDs may be used for a block, and hence, 6 sign values could be predicted in case of sign prediction. Hence, a total bin budget of 6 bins do not extend the worst case. After the total bin budget “curBinBudget” is defined, for each non-zero component of all the MVDs that are specified for a reference picture list (RPL0 or RPL1) a total number of bins per component is defined. This number may comprise the sign bin and the number of suffix bins. In some embodiments, when a non-zero component of MVD is encoded using exponential Golomb code, a number of bins in suffix is set equal to the number of bins in the prefix (including the separator bin). When the number of components is equal to 1, the number of predicted bins for this component is determined as a minimum between the total bin budget and the determined number of bins in this component. When the number of components is greater than 1, remaining bins number “remBinNum” is initialized to current bin budget, and the number of affected components “usedNumMvComp” is set equal to the number of processed MV components.

In some embodiments, the following operations may be performed:

In a first operation, components are sorted in descending order based on the determined number of bins per component values.

In a second operation, “deriv[ ]” array of differences between components are calculated for the sorted components. The last element in the “deriv[ ]” array is set equal to the number of bins for in the last component in the sorted list obtained in step 1.

In a third operation, if total number of bins is smaller or equal than the first element of the differences array (“deriv[0]”).

In a fourth operation, current sum “curPartSum” is initialized to 0. Further, a “deriv[ ]” array is scanned, to find the value of mvCompCnt and corresponding sum “curPartSum” of the following elements: (mvCompCnt_i+1)*deriv[mvCompCnt_i], mvCompCnt_i=0 . . . mvCompCnt−1, such that the following conditions are satisfied: curPartSum<=curBinBudget; and, curBinBudget<curPartSum+((mvCompCnt+2)*deriv[mvCompCnt+1]), i.e. the value of curPartSum sum at next iteration is greater than the bin budget. The number of affected components “usedNumMvComp” is set equal to mvCompCnt+2 (the value of next index (mvCompCnt+1)

In a fifth operation, the value of the threshold level “maxLevel” is set equal to the number of bins for the component next to the one determined in step 4.

In a sixth operation, the number of predicted bins for components with indices mvCompCnt_i=0 . . . usedNumMvComp−1 are set equal to the difference between the number of bins per component and maxLevel. The numbers of predicted bins for components with indices mvCompCnt_i=usedNumMvComp . . . mvCompCnt−1 are set equal to 0. In some examples, the remaining bins number “remBinNum” is set equal to a difference of total bin budget “curBinBudget” and determined sum “curPartSum”.

In a seventh operation, integer and fractional parts of remBinNum are determined as follows: intPart=remainedBinNum/usedNumMvComp; remPart=remainedBinNum-intPart*usedNumMvComp; wherein “/” is an integer division operation. For motion vector components with indices mvCompCnt_i=0 . . . usedNumMvComp−1 the number of predicted bins may be incremented by intPart+ (mvCompCnt_i<remPart? 1:0).

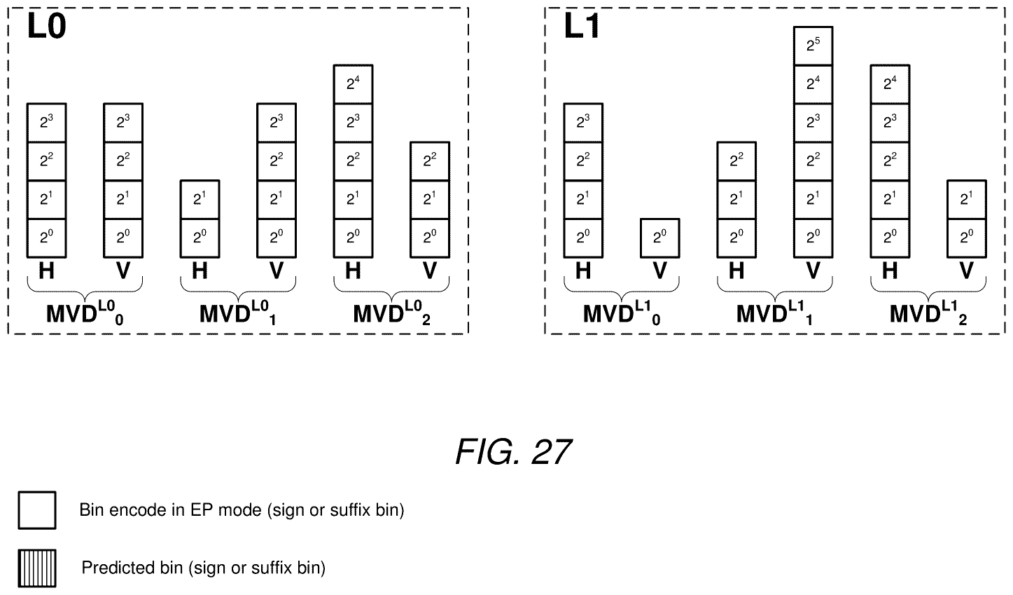

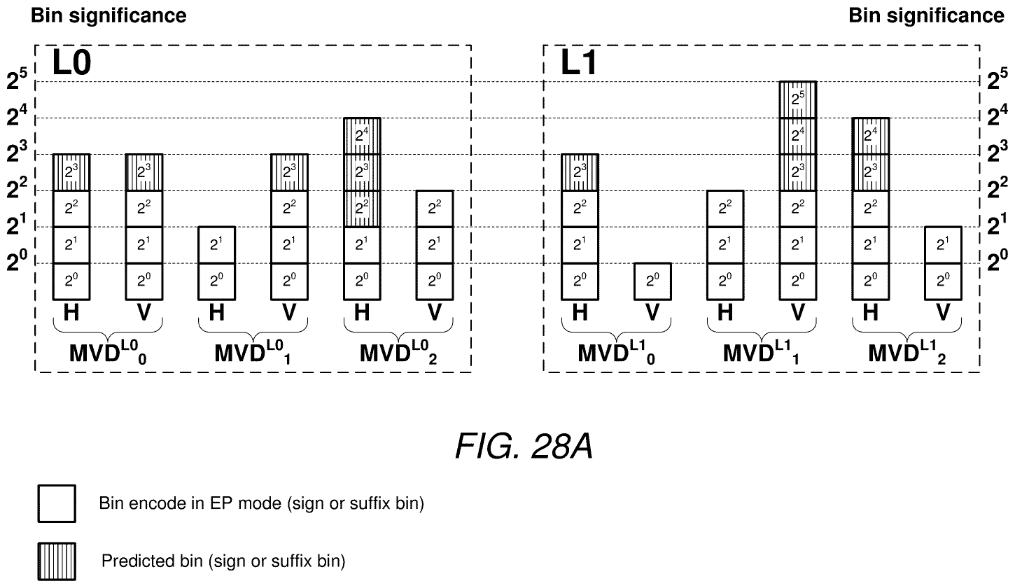

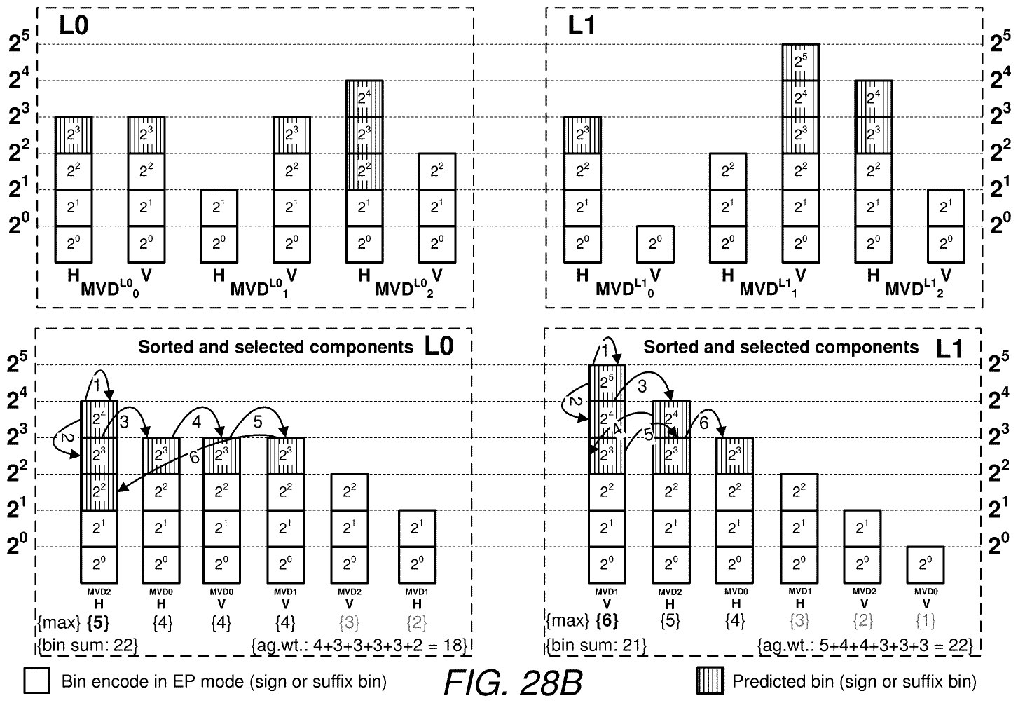

FIG. 27 illustrates an example of number of bins for 6 MVD components in RPL₀ and RPL₁, according to some embodiments. In the example illustrated by FIG. 27, each bin of the MVD component has a significance value determined by its position in a suffix. FIG. 28 extends the example of FIG. 27 as discussed further below.

FIG. 28A illustrates an example of positions of bins of the 6 MVD components obtained for prediction from RPL₀ and RPL₁ for an example total bin prediction target of 6 bins, according to some embodiments. For example, most significant bins are selected for prediction so as the distance between templates is increased, and thus, the probability of correct suffix bin prediction also increases. Additionally, for a PU, the maximum number of template matching operations is equal to 2^{N}, where N is the total bin budget for an RPL list. Hence, the maximum number of matching operations could be kept the same for bins and suffix prediction as compared to a method of predicting just signs. Therefore, the proposed mechanism for selection of suffix and sign bins for predicting may have the same worst-case number of template matching operations (and overall complexity) as a mechanism of just sign bin prediction. For affine motion compensation, 3 MVDs are used, and sign prediction operates on 6 MVD components. Hence, for a minimum block size of 8×8, 6 sign bins could be predicted, i.e. 64 template matching operations. If motion compensation is translational and uni-prediction mode is in use for a block of size 8×8 and larger, there could be just 1 MVD in an RPL. However, in this case, a total budget of 6 bins could still be applied, since the same number of template matching operations will be performed as in the case of affine prediction mode.

FIG. 28B illustrates an example of selecting positions of bins for prediction among the 6 MVD components obtained from RPL₀ and RPL₁ according to an example total bin prediction target of 6 bins, according to some embodiments. Extending the example of FIG. 28A, FIG. 28B illustrates an example order of sorting and selecting MVD components from L0 and L1. For example, in a first step, the MVD components of L0 and of L1 may be sorted in descending order by the maximum level of bin significance (illustrated as “{max}”) within each MVD component. For example, the sum of these maximum values is 22 for L0 and 21 for L1. In another example, an aggregate weight (illustrated as “{ag.wt.}”) of the bins may be determined based on the number of bins at each significance level within all of the MVD components of each of L0 and L1 respectively. For example, as illustrated, for L0 the aggregate weight may be equal to 18, and for L1 aggregate weight may be equal to 22. The measures of aggregate weight for each of L0 and L1 may be used for selecting between RPL₀ (L0) and RPL₁ (L1) for prediction as further described herein. The example of FIG. 28B is simplified for purposes of illustration, and other manners of calculating aggregate weights are further described herein. FIG. 28B also illustrates an example order of selecting bins for prediction from each of the MVD components of each of L0 and L1, within a total bin budget, or a prediction target value. The example selection order is illustrated by the numerals (1)-(6) in FIG. 28B, which is discussed in further detail below.

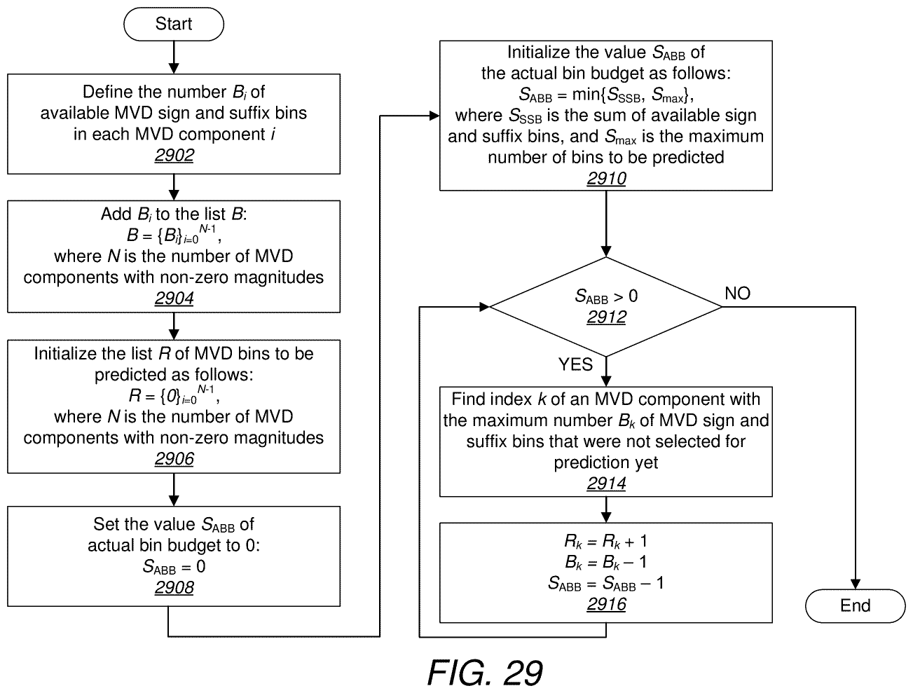

FIG. 29 illustrates a flowchart of a method for selecting, within each of one or more MVD components of a selected RPL, a subset of most significant symbols for prediction according to some embodiments. At 2902, the method includes the step of defining the number Bᵢ of available MVD sign and suffix bins in each MVD component i. At 2904, the method includes the step of adding Bᵢ to the list B as follows: B={Bᵢ}ᵢ₌₀^{N-1}, where N is the number of MVD components with non-zero magnitudes. At 2906, the method includes the step of initializing the list R of MVD bins to be predicted as follows: R={0}ᵢ₌₀^{N-1}, where N is the number of MVD components with non-zero magnitudes. At 2908, the method includes the step of setting the value S_{ABB} of actual bin budget to 0, i.e., S_{ABB}=0. At 2910, the method includes the step of Initialize the value S_{ABB} of the actual bin budget as follows: S_{ABB}=min{S_{SSB}, Sₘₐₓ}, where S_{SSB} is the sum of available sign and suffix bins, and Sₘₐₓ is the maximum number of bins to be predicted. At 2912, the method includes the step of iteratively determining whether S_{ABB}>0. If no (S_{ABB}<=0), the process ends, as the list R is complete. If yes, the method includes the steps of 2914 and 2916 before returning to step 2912. At step 2914, the method includes the step of finding an index k of an MVD component with the maximum number Bₖ of MVD sign and suffix bins that were not selected for prediction yet. At step 2916, the method includes the step of incrementing Rₖ by one (Rₖ=Rₖ+1), decrementing Bₖ by one (Bₖ=Bₖ−1), and decrementing S_{ABB} by one (S_{ABB}=S_{ABB}−1).

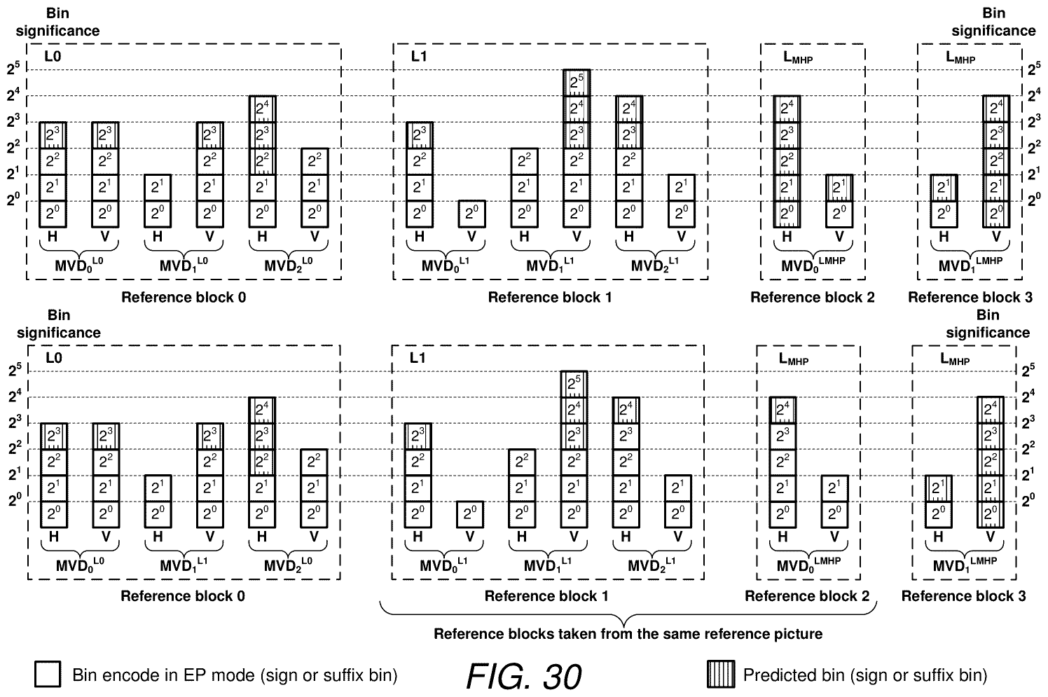

FIG. 30 illustrates examples of positions of bins of MVD components obtained for prediction from RPL₀ and RPL₁, as well as additional reference blocks according to a multi-hypothesis prediction example, with a total bin prediction target of 6 bins, according to some embodiments.

In an example, for a multi-hypothesis inter prediction mode (also referred to as “MHP” herein), one or more additional motion-compensated prediction signals may be signaled, in addition to a bi-prediction signal. The resulting overall prediction signal may be obtained by sample-wise weighted superposition. With the bi-prediction signal p_{bi} and the first additional inter prediction signal/hypothesis h₃, the resulting prediction signal p₃ is obtained according to (25) per below:

$${p}_{3} = ( 1 - α ) {p}_{b i} + α {h}_{3} \qquad ( 25 )$$

The weighting factor α is specified by the new syntax element add_hyp_weight_idx, according to the following mapping illustrated in Table 3 below:

TABLE 3

| add_hyp_weight_idx | α |
|---|---|
| 0 | ¼ |
| 1 | −⅛ |

Analogously to above, more than one additional prediction signals may be used. The resulting overall prediction signal may be accumulated iteratively with each additional prediction signal according to (26) per below:

$${p}_{n + 1} = ( 1 - {α}_{n + 1} ) {p}_{n} + {α}_{n + 1} {h}_{n + 1} \qquad ( 26 )$$

The resulting overall prediction signal is obtained as the last pₙ (i.e., the pₙ having the largest index n). In an example, up to two additional prediction signals may be used (i.e., n may be limited to 2).

The motion parameters of each additional prediction hypothesis may be signaled either explicitly by specifying the reference index, the motion vector predictor index, and the motion vector difference, or implicitly by specifying a merge index. A separate multi-hypothesis merge flag distinguishes between these two signaling modes.

For inter AMVP mode, MHP is only applied if a non-equal weight in BCW is selected in bi-prediction mode. A combination of MHP and BDOF is possible, however the BDOF may be only applied to the bi-prediction signal part of the prediction signal (i.e., the first two hypotheses). An indication of a MVD for a multi-hypothesis prediction (MHP) mode may be performed as shown in Table 4 below:

TABLE 4

| | Descriptor |
|---|---|
| mh_pred_data ( x0, y0, refList, cpIdx ) { | |
| NumAddHyp = 0 | |
| while (NumAddHyp<maxNumAddHyps ) { | ae(v) |
| mh_flag[NumAddHyp] | ae(v) |
| if ( mh_flag[NumAddHyp] ) { | |
| mh_merge_flag[NumAddHyp] | ae(v) |
| if ( maxNumMHPCand > 0 && mh_merge_flag[NumAddHyp] ) { | |
| mh_merge_idx[NumAddHyp] | ae(v) |
| } else { | |
| mvd_coding( x0, y0, refList, cpIdx ) | ae(v) |
| mh_mvp_idx[NumAddHyp] | ae(v) |
| } | ae(v) |
| add_hyp_weight_idx[NumAddHyp] | ae(v) |
| NumAddHyp ++ | |
| } | |
| } | |
| } | |

Further regarding the example of Table 4, the syntax elements have the following semantics. The mh_flag[NumAddHyp] specifies whether an additional hypothesis with index NumAddHyp is used to predict the current coding unit in the multi-hypothesis prediction mode. The array indices x0, y0 specify the location (x0, y0) of the top-left luma sample of the considered coding block relative to the top-left luma sample of the picture. The mh_merge_flag[NumAddHyp] specifies whether a merge mode is used to encode parameters of the additional hypothesis with index NumAddHyp. The mh_merge_idx[NumAddHyp] specifies the merge index in the list of merge parameters for the additional hypothesis with index NumAddHyp. The add_hyp_weight_idx[NumAddHyp] specifies weighting factor α for the additional hypothesis with index NumAddHyp. The mh_mvp_idx[NumAddHyp] specifies the index in the list of motion vector predictors for the additional hypothesis with index NumAddHyp.

In another example, MVDs may be signaled for additional prediction hypotheses although a general_merge_flag[x0][y0] is set to 1 for a current block, which MHP is applied to. The general_merge_flag[x0][y0] specifies whether the inter prediction parameters for the current coding unit are inferred from a neighboring inter-predicted partition. The array indices x0, y0 specify the location (x0, y0) of the top-left luma sample of the considered coding block relative to the top-left luma sample of the picture.

Further regarding Table 4, it should be noted that mvd_coding( ) structure may be encoded for each additional hypotheses signaled. If a current coding block is predicted in translational bi-prediction mode and the maximum number of additional hypotheses maxNumAddHyps is equal to 2, up to 4 MVDs could be specified for the current coding block. If a current coding block is predicted in affine bi-prediction mode and the maximum number of additional hypotheses maxNumAddHyps is equal to 2, up to 8 MVDs could be specified for the current coding block. In an example, MHP may be applicable to blocks that have: an area of more than 64 samples; and/or the minimal side length of, at least, 8 samples.

In a further example, for MHP, one more reference picture lists (L_{MHP} or RPL_{MHP}) may be available to retrieve additional reference blocks used as a 3^{rd} hypothesis for prediction and a 4^{th} hypothesis for prediction. RPL_{MHP} differs from reference picture list L0 (also referred to as RPL₀) and reference picture list L1 (also referred to as RPL₁). However, RPL_{MHP} may contain reference pictures that are already available in L0 or L1.

In embodiments, for multi-hypotheses prediction, in addition to MVDs indicated for RPL₀ and RPL₁, a set of MVDs for additional hypotheses for prediction are indicated. In an example, embodiments may further apply the sign and suffix bins prediction mechanism to MVDs of MHP-predicted blocks. For example, in contrast to non-MHP blocks, MVDs can be independently signaled for each reference block, i.e., in case of MHP, the location of some reference blocks can be indicated with MVDs, whereas for other reference blocks, MVDs may not be signaled (e.g., if merge mode is used) as shown in Table 4. Thus, a decision to predict MVD sign and suffix bins or not may be made independently for each reference block that differs from the non-MHP design where this decision is made for a current block as a whole. Hence, the selection between reference picture lists for MHP may be omitted if a MVD is only signaled for one reference block.

In another example, the mechanism of selecting MVD sign and suffix bins to be predicted may be different from the non-MHP design when just 2 reference picture lists (L₀ and L₁) are available. In the case of MHP, 3 reference picture lists (L₀, L₁, and L_{MHP}) may be used to retrieve reference blocks. Note that additional reference blocks that correspond to additional hypotheses may only refer to L_{MHP}. Thus, in the case of MHP, the process of selecting MVD bins to be predicted may be based on the selection between reference blocks rather than between reference picture lists. Because two or more reference blocks may belong to the same reference picture, a MVD bin prediction budget (or target) may be distributed over MVDs associated with different reference blocks but taken from the same reference picture.

FIG. 30 illustrates a first example embodiment (top) when a current block is predicted using MHP and combining 4 reference blocks. In this case, reference block 2 and reference block 3, that correspond to additional hypotheses and are also available for MVD sign and suffix bin prediction, are always uni-predicted. In this embodiment, these MVDs may be used for the purpose of sign and suffix bins prediction that are associated with the same reference blocks. So, in contrast to bi-predicted blocks, some reference blocks used in MHP may belong to the same reference list.

FIG. 30 further illustrates a second example embodiment (bottom) when 2 reference blocks (reference block 1 and reference block 2) are taken from the same reference picture. For example, MVDs associated with these 2 blocks may share the MVD bin prediction budget (or target) whereas in the first embodiment (top of FIG. 30), this bin budget has to be distributed over MVDs associated with just one reference block.

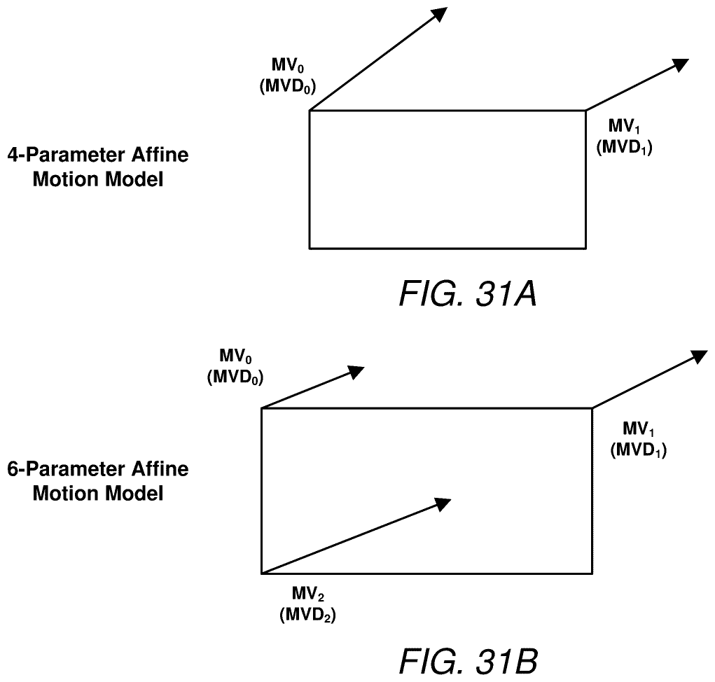

FIGS. 31A-B illustrate examples of prioritizing sign and suffix bins for predicting MVDs for a 4-parameter affine motion model and a 6-parameter affine motion model, according to some embodiments. In the case of affine motion model depicted in FIGS. 31A-B, a MVD₀ corresponding to the top-left corner of a reference block is used to compute the remaining MVDs. For example, for both 4-parameter and 6-parameter models, a MVD₁ corresponding to the top-right corner of a reference block is calculated as MVD₁=MVD₁^{ind}+MVD₀, where MVD₁^{ind} is the MVD value indicated in a bitstream for parsing from the top-right corner of a reference block. Further for example, for a 6-parameter model, a MVD₂ corresponding to the below-left corner of a reference block is calculated as MVD₂=MVD₂^{ind}+MVD₀, where MVD₂^{ind} is the MVD value indicated in a bitstream for parsing from the below-left corner of a reference block.

Thus, in this example, MVD₀ affects not just the location of the top-left corner of a reference block, but also the location of the top-right corner and, in the case of 6-parameter affine motion model, the below-left corner as well. Therefore, MVD₀ impacts a candidate template position to a greater extent than is greater than MVD₁ or MVD₂. Hence, when selecting sign and suffix bins for MVD prediction, MVD₀ sign and suffix bins may be prioritized compared to MVD₁ or MVD₂. For example, for the same significance level, MVD sign and suffix bins belonging to MVD₀ may be preferably selected for the purpose of MVD prediction compared to MVD sign and suffix bins belonging to MVD₁ or MVD₂.

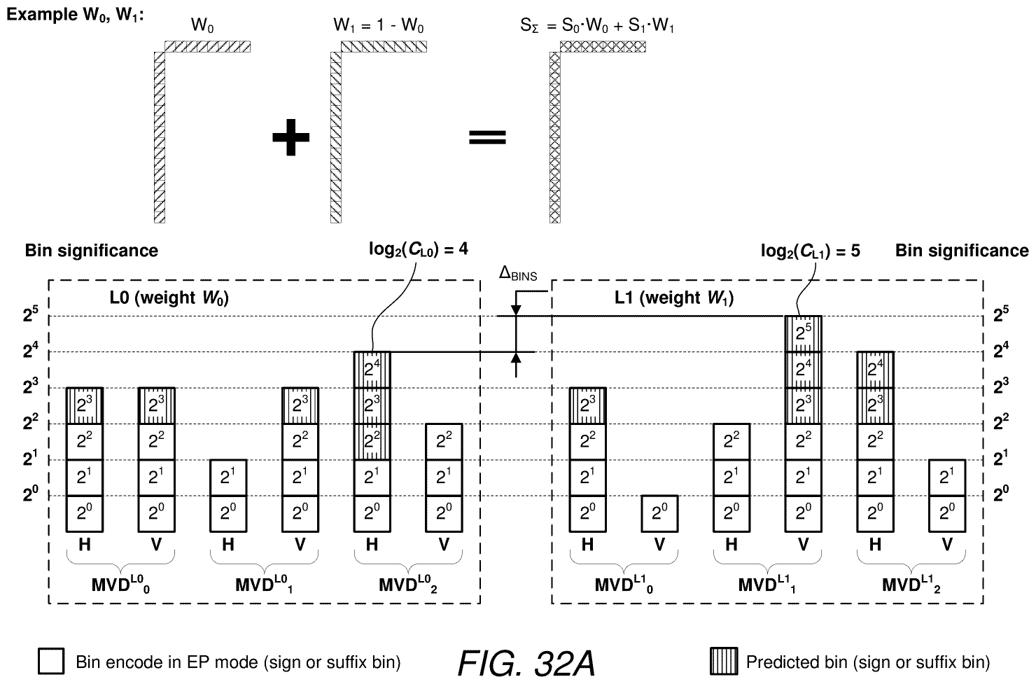

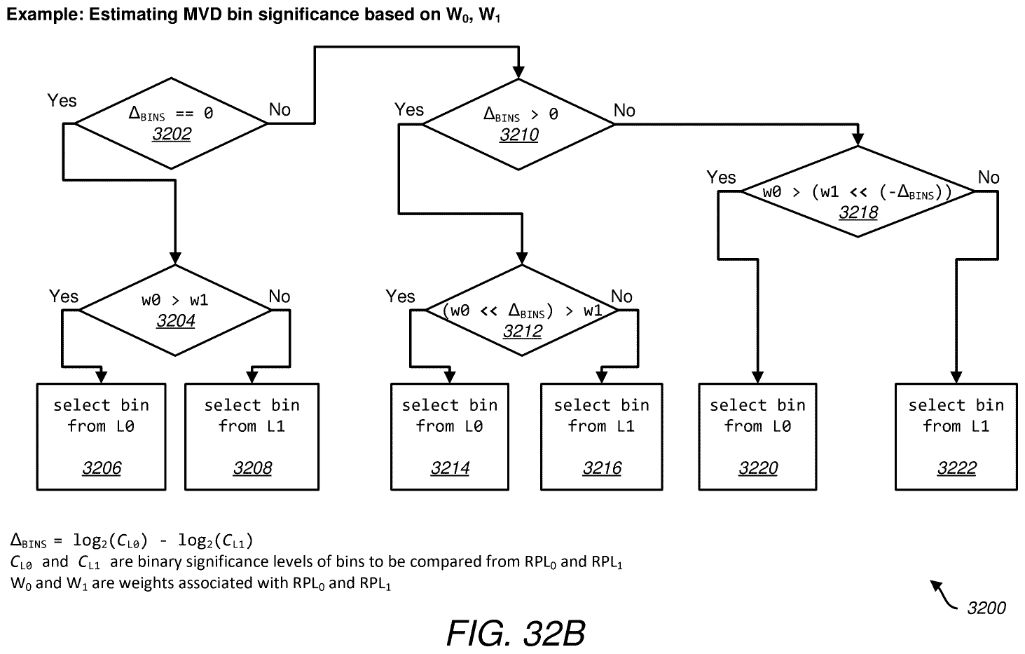

FIGS. 32A-B illustrate examples of determining weighting values for significance levels of bin symbols from RPL₀ and RPL₁ based on a binary coding weight (BCW) or multi-hypothesis prediction (MHP) index, according to some embodiments.

Bidirectional Prediction with Coding Unit Weights (BCW) (also known as generalized bi-prediction (GBi)) is a weighted bi-prediction technique for predicting a block by weighted-averaging two motion-compensated blocks. BCW extends the concept of weighted bi-prediction to the CU level, allowing bi-prediction weights to be determined per CU. The determined bi-prediction weights are applied to bi-prediction PUs, across all color components, to bi-predict the CU. In an example for BCW, a list of pre-defined candidate weights may be used. At the encoder, one of the pre-defined candidate weights is selected as a BCW weight for a bi-predicted CU. For a non-merge coded CU (a CU for which merge mode is not used to code the motion vector), a BCW index associated with the selected BCW weight is signaled to the decoder. The BCW index points to the entry of the selected BCW weight in the list of pre-defined candidate weights. For a merge coded CU, the BCW index is inherited from neighboring blocks based on a signaled merge candidate index. The merge candidate index points to a merge candidate of the merge coded CU.

When BCW is enabled, weighted averaging of the L0 and L1 prediction signals may be performed. An exemplary set of BCW weights is W={1/8, 3/8, 4/8, 5/8, 7/8}. Thus, the sample values S_{Σ} of a combined predictor are calculated according to (27) per below:

$${S}_{\sum } = ( {w}_{0} \cdot {S}_{0} + {w}_{1} \cdot {S}_{1} + 4 ) / 8 = ( {w}_{0} \cdot {S}_{0} + {w}_{1} \cdot {S}_{1} + 4 ) ≫ 3 \qquad ( 27 )$$

In this example, S₀ and S₁ are samples belonging to reference block 0 and reference block 1, respectively; w₀ and w₁ are weights associated with reference block 0 and reference block 1, respectively; and, “/” and “>>” are an integer division operation and a right shift operation, respectively.

The BCW index may be signaled for non-merge coded CUs, whereas for merge coded CUs, the BCW index may be inherited from neighboring blocks according to the signaled merge candidate index. Further, for example, BCW weights may be applied to every color plane belonging to a given coding unit (CU), i.e., to luma and both chroma blocks. MVD sign and suffix bin prediction is applicable to non-merge coded CUs because MVDs may not be signaled in a bitstream if merge mode is selected for a current CU. BCW weights may be involved in the reconstruction process of candidate templates for MVD sign and suffix bin prediction as illustrated in FIG. 32A (“Example W₀, W₁”).

In an example illustrated by FIG. 32B, in order to estimate MVD bin significance based on weights W₀ and W₁, MVD bins may be compared according to the process 3200 of FIG. 32B. In this example, Δ_{BINS}=log₂(C_{L0})−log₂(C_{L1}), where C_{L0} and C_{L1} are binary levels of bins to be compared from reference picture list L₀ and reference picture list L₁, respectively; and, w₀ and w₁ are weights associated with reference picture list L₀ and reference picture list L₁, respectively. In an example, when distributing a total bin prediction budget over available non-zero MVD components, BCW and MHP weights may be considered because these weights may impact MVD bin prediction probability through the template matching (TM) cost (e.g., measured as Sum of Absolute Differences) that is defined as the difference between a candidate template and the template of a current block.

In another example relating to MHP, when the example process of FIG. 32B for estimating the MVD bin significance is applied to additional hypotheses, additional aspects regarding merge flags may be considered. For example, when general_merge_flag, mh_flag[0] and mh_flag[1] (i.e. in the general case, mh_flag[NumAddHyp] for, at least, 2 additional hypotheses) are set to 1 for the current coding, then mh_merge_flag[0] and mh_merge_flag[1] (i.e. in the general case, mh_merge_flag[NumAddHyp] for, at least, 2 additional hypotheses) are set to 0. Thus, MVDs may be signaled just for, at least, 2 additional hypotheses, whereas MVDs may not be indicated for other hypotheses predictions. For example, this may avoid complex arithmetic operations for weighting at the entropy coding (parsing) stage.

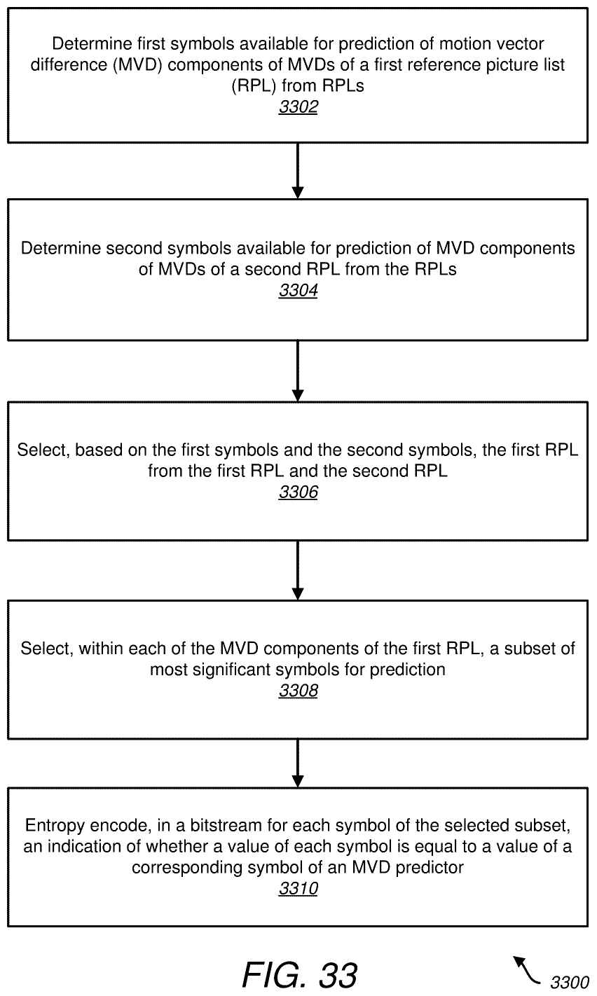

FIG. 33 illustrates a flowchart of a method for selecting a reference picture list (RPL) and selecting within each MVD component of the selected RPL a subset of most significant symbols for prediction in accordance with embodiments of the present disclosure. The method of flowchart 3300 may be implemented by an encoder, such as encoder 200 in FIG. 2.

The method of flowchart 3300 begins at 3302. At 3302, the encoder determines first symbols available for prediction of motion vector difference (MVD) components of MVDs of a first reference picture list (RPL) from RPLs. At 3304, the encoder determines second symbols available for prediction of MVD components of MVDs of a second RPL from the RPLs. At 3306, the encoder selects, based on the first symbols and the second symbols, the first RPL from the first RPL and the second RPL. At 3308, the encoder selects, within each of the MVD components of the first RPL, a subset of most significant symbols for prediction. And, at 3310, the encoder entropy encodes, in a bitstream for each symbol of the selected subset, an indication of whether a value of each symbol is equal to a value of a corresponding symbol of an MVD predictor.

In an example, the selecting, based on the first symbols and the second symbols, may further comprise selecting the first RPL, among the first RPL and the second RPL, based on a number of the first symbols available for prediction being greater than a number of the second symbols available for prediction.

In another example, the selecting, based on the first symbols and the second symbols, may comprise: selecting, from the first symbols and based on first symbol positions of the first symbols of the MVD components of the first RPL, a first number of first candidate symbols having the highest symbol positions of the first symbol positions; selecting, from the second symbols and based on second symbol positions of the second symbols of the MVD components of the second RPL, a second number of second candidate symbols having the highest symbol positions of the second symbol positions; calculating first weights of the first candidate symbols based on symbol positions of the first candidate symbols, wherein each weight of the first weights is calculated for each respective candidate symbol of the first candidate symbols based on a respective symbol position of the first candidate symbols; calculating second weights of the second candidate symbols based on symbol positions of the second candidate symbols, wherein each weight of the second weights is calculated for each respective candidate symbol of the second candidate symbols based on a respective symbol position of the second candidate symbols; and wherein the first RPL is selected based on a sum of the first weights being greater than a sum of the second weights. In an example, the first candidate symbols having the highest symbol positions may be the most significant symbols of the MVD components of the first RPL. In an example, the second candidate symbols having the highest symbol positions may be the most significant symbols of the MVD components of the second RPL.

In an example, the calculating the first weights of the first candidate symbols based on the symbol positions of the first candidate symbols may further comprise adjusting the first weights based on a first weighting factor value. In an example, the calculating the second weights of the second candidate symbols based on the symbol positions of the second candidate symbols may further comprise adjusting the second weights based on a second weighting factor value. In an example, the calculating the first weights and the second weights may further comprise scaling the first weighting factor value relative to the second weighting factor value based on an indication of a binary coding weight (BCW) index. In an example, the scaling may further be based on a respective first symbol position of the first candidate symbols of the first RPL compared to a respective second symbol position of the second candidate symbols of the second RPL.

In another example, the selecting, based on the first symbols and the second symbols, may further comprise: selecting, from the first symbols and based on first symbol positions of the first symbols of the MVD components of the first RPL, a first number of first candidate symbols having the highest symbol positions of the first symbol positions; selecting, from the second symbols and based on second symbol positions of the second symbols of the MVD components of the second RPL, a second number of second candidate symbols having the highest symbol positions of the second symbol positions; calculating a first prediction capacity for the first candidate symbols based on symbol positions of the first candidate symbols; calculating a second prediction capacity for the second candidate symbols based on symbol positions of the second candidate symbols; and, wherein the first RPL is selected based on the first prediction capacity being greater than the second prediction capacity.

In an example, the first candidate symbols having the highest symbol positions may be the most significant symbols of the MVD components of the first RPL. In an example, the second candidate symbols having the highest symbol positions may be the most significant symbols of the MVD components of the second RPL. In an example, the selecting the first number of first candidate symbols having the highest symbol positions of the first symbol positions may further be based on selecting symbols from each non-zero MVD component of the first RPL. In an example, the selecting the second number of second candidate symbols having the highest symbol positions of the second symbol positions may further be based on selecting symbols from each non-zero MVD component of the second RPL.

In another example, the selecting, based on the first symbols and the second symbols, may further comprise initializing: a first array comprising each non-zero MVD component of the first RPL, wherein the first array is sorted in descending order by a total number of symbol bins of each non-zero MVD component of the first RPL; a second array comprising each non-zero MVD component of the second RPL, wherein the second array is sorted in descending order by a total number of symbol bins of each non-zero MVD component of the second RPL; a first target significance value, set equal to a maximum value of the total number of symbol bins of each non-zero MVD component in the first array; a second target significance value, set equal to a maximum value of the total number of symbol bins of each non-zero MVD component in the second array; a first aggregate weight value, set equal to zero; a second aggregate weight value, set equal to zero; a first number of remaining symbol bins selected for prediction set equal to a prediction target value; and a second number of remaining symbol bins selected for prediction set equal to the prediction target value.

In an example, the selecting, based on the first symbols and the second symbols, may further comprise: for each symbol bin within each MVD component of the first array, and while the first number of remaining symbol bins selected for prediction is greater than zero, and for each symbol bin within each MVD component at a position equal to the first target significance value: incrementing the first aggregate weight value by a value of the symbol bin at the position and a predetermined offset value; decrementing the first number of remaining symbol bins selected for prediction. The method may further include, based on the first number of remaining symbol bins selected for prediction being greater than zero, decrementing the first target significance value.

In an example, the selecting, based on the first symbols and the second symbols, may further comprise: for each symbol bin within each MVD component of the second array, and while the second number of remaining symbol bins selected for prediction is greater than zero, and for each symbol bin within each MVD component of the second at a position equal to the second target significance value: incrementing the second aggregate weight value by a value of the symbol bin at the position and the predetermined offset value; and decrementing the second number of remaining symbol bins selected for prediction. The method may further include, based on the second number of remaining symbol bins selected for prediction being greater than zero, decrementing the second target significance value; and wherein the first RPL is selected based on the first aggregate weight value being greater than or equal to the second aggregate weight value.

In an example, the predetermined offset value may further be based on: increasing the predetermined offset value when the symbol bin is at a higher position within each MVD component; and decreasing the predetermined offset value when the symbol bin is at a lower position within each MVD component. In an example, the prediction target value may further be based on determining a predetermined threshold value based on one or more of: a size of a predicted block; and a number of samples of the predicted block. In an example, the prediction target value may further be based on comparing the predetermined threshold value with the first aggregate weight value and the second aggregate weight value.

In an example, the selecting, within each of the MVD components of the first RPL, the subset of most significant symbols for prediction may further comprise: determining a first total value equal to a total number of non-zero MVD components within the first RPL; determining a second total value equal to a total number of available symbol bins of each non-zero MVD component within the first RPL; determining a first list comprising each non-zero MVD component of the first RPL, and a number of available symbol bins within each non-zero MVD component; initializing a second list of symbol bins to be selected for prediction; and initializing a prediction threshold counter based on a minimum value between the second total value and a prediction target value.

In an example, the selecting, within each of the MVD components of the first RPL, the subset of most significant symbols for prediction may further comprise, for each of the non-zero MVD components in the first list, and based on the prediction threshold counter being greater than zero: determining an index of an MVD component with a maximum number of symbol bins that have not been selected for prediction in the second list; for each symbol bin of the MVD component at the index, selecting the symbol bin for prediction based on adding the symbol bin to the second list; decrementing the index; decrementing the prediction threshold counter. The method may further include returning the second list as the selected subset of symbols for prediction.

In an example, the RPLs may further comprise at least one of a third RPL and a fourth RPL. In an example, the first RPL and at least one of the third RPL and the fourth RPL may be of a same reference picture. In another example, the second RPL and at least one of the third RPL and the fourth RPL may be of a same reference picture.

In an example, the one or more MVD components may comprise one or more of a horizontal MVD component and a vertical MVD component. In an example, the method may further include: determining MVD candidates based on one or more symbols of the MVD to be encoded; determining template matching costs for the MVD candidates, wherein each template matching cost is between a current template of a current block (CB) and a reference template of a reference block (RB) candidate indicated by a respective MVD candidate of the MVD candidates; and selecting one of the MVD candidates as the MVD predictor based on the template matching costs. In an example, the symbols may be in a suffix portion of a codeword corresponding to the MVD. In an example, the method may further include signaling, in the bitstream, each symbol not selected for prediction as an indication of the value of the symbol encoded in equiprobable (EP) bypass mode.

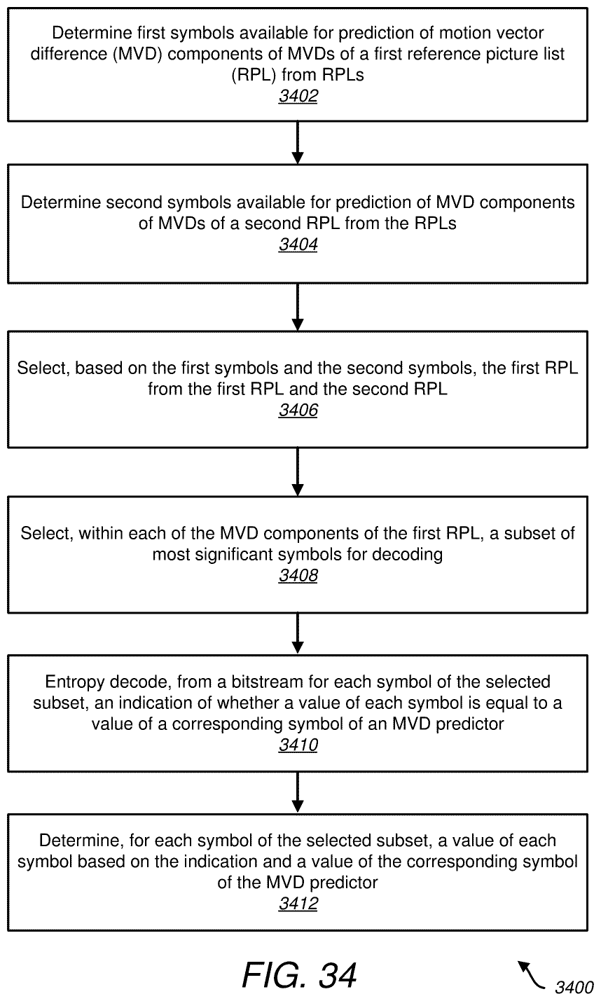

FIG. 34 illustrates a flowchart of a method for selecting a reference picture list (RPL) and selecting within each MVD component of the selected RPL a subset of most significant symbols for decoding in accordance with embodiments of the present disclosure. The method of flowchart 3400 may be implemented by a decoder, such as decoder 300 in FIG. 3.

The method of flowchart 3400 begins at 3402. At 3402, the decoder determines first symbols available for prediction of motion vector difference (MVD) components of MVDs of a first reference picture list (RPL) from RPLs. At 3404, the decoder determines second symbols available for prediction of MVD components of MVDs of a second RPL from the RPLs. At 3406, the decoder selects, based on the first symbols and the second symbols, the first RPL from the first RPL and the second RPL. At 3408, the decoder selects, within each of the MVD components of the first RPL, a subset of most significant symbols for decoding. At 3410, the decoder entropy decodes, from a bitstream for each symbol of the selected subset, an indication of whether a value of each symbol is equal to a value of a corresponding symbol of an MVD predictor. And, at 3412, the decoder determines, for each symbol of the selected subset, a value of each symbol based on the indication and a value of the corresponding symbol of the MVD predictor.

In an example, the selecting, based on the first symbols and the second symbols, may further comprise selecting the first RPL, among the first RPL and the second RPL, based on a number of the first symbols available for prediction being greater than a number of the second symbols available for prediction.

In another example, the selecting, based on the first symbols and the second symbols, may comprise: selecting, from the first symbols and based on first symbol positions of the first symbols of the MVD components of the first RPL, a first number of first candidate symbols having the highest symbol positions of the first symbol positions; selecting, from the second symbols and based on second symbol positions of the second symbols of the MVD components of the second RPL, a second number of second candidate symbols having the highest symbol positions of the second symbol positions; calculating first weights of the first candidate symbols based on symbol positions of the first candidate symbols, wherein each weight of the first weights is calculated for each respective candidate symbol of the first candidate symbols based on a respective symbol position of the first candidate symbols; calculating second weights of the second candidate symbols based on symbol positions of the second candidate symbols, wherein each weight of the second weights is calculated for each respective candidate symbol of the second candidate symbols based on a respective symbol position of the second candidate symbols; and wherein the first RPL is selected based on a sum of the first weights being greater than a sum of the second weights. In an example, the first candidate symbols having the highest symbol positions may be the most significant symbols of the MVD components of the first RPL. In an example, the second candidate symbols having the highest symbol positions may be the most significant symbols of the MVD components of the second RPL.

In an example, the calculating the first weights of the first candidate symbols based on the symbol positions of the first candidate symbols may further comprise adjusting the first weights based on a first weighting factor value. In an example, the calculating the second weights of the second candidate symbols based on the symbol positions of the second candidate symbols may further comprise adjusting the second weights based on a second weighting factor value. In an example, the calculating the first weights and the second weights may further comprise scaling the first weighting factor value relative to the second weighting factor value based on an indication of a binary coding weight (BCW) index. In an example, the scaling may further be based on a respective first symbol position of the first candidate symbols of the first RPL compared to a respective second symbol position of the second candidate symbols of the second RPL.

In another example, the selecting, based on the first symbols and the second symbols, may further comprise: selecting, from the first symbols and based on first symbol positions of the first symbols of the MVD components of the first RPL, a first number of first candidate symbols having the highest symbol positions of the first symbol positions; selecting, from the second symbols and based on second symbol positions of the second symbols of the MVD components of the second RPL, a second number of second candidate symbols having the highest symbol positions of the second symbol positions; calculating a first prediction capacity for the first candidate symbols based on symbol positions of the first candidate symbols; calculating a second prediction capacity for the second candidate symbols based on symbol positions of the second candidate symbols; and, wherein the first RPL is selected based on the first prediction capacity being greater than the second prediction capacity.

In an example, the first candidate symbols having the highest symbol positions may be the most significant symbols of the MVD components of the first RPL. In an example, the second candidate symbols having the highest symbol positions may be the most significant symbols of the MVD components of the second RPL. In an example, the selecting the first number of first candidate symbols having the highest symbol positions of the first symbol positions may further be based on selecting symbols from each non-zero MVD component of the first RPL. In an example, the selecting the second number of second candidate symbols having the highest symbol positions of the second symbol positions may further be based on selecting symbols from each non-zero MVD component of the second RPL.

In another example, the selecting, based on the first symbols and the second symbols, may further comprise initializing: a first array comprising each non-zero MVD component of the first RPL, wherein the first array is sorted in descending order by a total number of symbol bins of each non-zero MVD component of the first RPL; a second array comprising each non-zero MVD component of the second RPL, wherein the second array is sorted in descending order by a total number of symbol bins of each non-zero MVD component of the second RPL; a first target significance value, set equal to a maximum value of the total number of symbol bins of each non-zero MVD component in the first array; a second target significance value, set equal to a maximum value of the total number of symbol bins of each non-zero MVD component in the second array; a first aggregate weight value, set equal to zero; a second aggregate weight value, set equal to zero; a first number of remaining symbol bins selected for decoding set equal to a prediction target value; and a second number of remaining symbol bins selected for decoding set equal to the prediction target value.

In another example, the selecting, based on the first symbols and the second symbols, may further comprise: for each symbol bin within each MVD component of the first array, and while the first number of remaining symbol bins selected for decoding is greater than zero, and for each symbol bin within each MVD component at a position equal to the first target significance value: incrementing the first aggregate weight value by a value of the symbol bin at the position and a predetermined offset value; and decrementing the first number of remaining symbol bins selected for decoding. The method may further include, based on the first number of remaining symbol bins selected for decoding being greater than zero, decrementing the first target significance value.

In an example, the selecting, based on the first symbols and the second symbols, may further comprise: for each symbol bin within each MVD component of the second array, and while the second number of remaining symbol bins selected for decoding is greater than zero, and for each symbol bin within each MVD component of the second at a position equal to the second target significance value: incrementing the second aggregate weight value by a value of the symbol bin at the position and the predetermined offset value; and decrementing the second number of remaining symbol bins selected for decoding. The method may further include, based on the second number of remaining symbol bins selected for decoding being greater than zero, decrementing the second target significance value; and wherein the first RPL is selected based on the first aggregate weight value being greater than or equal to the second aggregate weight value.

In an example, the predetermined offset value may further be based on: increasing the predetermined offset value when the symbol bin is at a higher position within each MVD component; and decreasing the predetermined offset value when the symbol bin is at a lower position within each MVD component. In an example, the prediction target value may further be based on determining a predetermined threshold value based on one or more of: a size of a predicted block; and a number of samples of the predicted block. In an example, the prediction target value may further be based on comparing the predetermined threshold value with the first aggregate weight value and the second aggregate weight value.

In an example, the selecting, within each of the MVD components of the first RPL, the subset of most significant symbols for decoding may further comprise: determining a first total value equal to a total number of non-zero MVD components within the first RPL; determining a second total value equal to a total number of available symbol bins of each non-zero MVD component within the first RPL; determining a first list comprising each non-zero MVD component of the first RPL, and a number of available symbol bins within each non-zero MVD component; initializing a second list of symbol bins to be selected for decoding; and initializing a prediction threshold counter based on a minimum value between the second total value and a prediction target value.

In an example, the selecting, within each of the MVD components of the first RPL, the subset of most significant symbols for decoding may further comprise, for each of the non-zero MVD components in the first list, and based on the prediction threshold counter being greater than zero: determining an index of an MVD component with a maximum number of symbol bins that have not been selected for decoding in the second list; for each symbol bin of the MVD component at the index, selecting the symbol bin for decoding based on adding the symbol bin to the second list; decrementing the index; and decrementing the prediction threshold counter. The method may further include returning the second list as the selected subset of symbols for decoding.

In an example, the RPLs may further comprise at least one of a third RPL and a fourth RPL. In an example, the first RPL and at least one of the third RPL and the fourth RPL may be of a same reference picture. In another example, the second RPL and at least one of the third RPL and the fourth RPL may be of a same reference picture.

In an example, the one or more MVD components may comprise one or more of a horizontal MVD component and a vertical MVD component. In an example, the method may further include: determining MVD candidates based on one or more symbols of the MVD to be decoded; determining template matching costs for the MVD candidates, wherein each template matching cost is between a current template of a current block (CB) and a reference template of a reference block (RB) candidate indicated by a respective MVD candidate of the MVD candidates; and selecting one of the MVD candidates as the MVD predictor based on the template matching costs. In an example, the symbols may be in a suffix portion of a codeword corresponding to the MVD. In an example, the method may further include receiving, in the bitstream, each symbol not selected for decoding as an indication of the value of the symbol coded in equiprobable (EP) bypass mode.

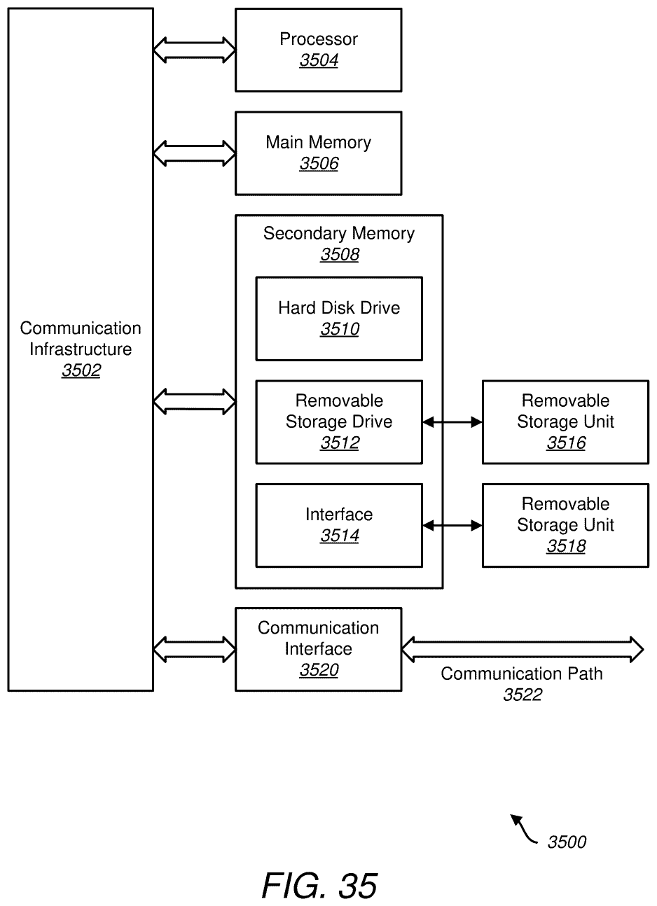

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 3500 is shown in FIG. 35. Blocks depicted in the figures above, such as the blocks in FIGS. 1, 2, and 3, may execute on one or more computer systems 3500. Furthermore, each of the steps of the flowcharts depicted in this disclosure may be implemented on one or more computer systems 3500.

Computer system 3500 includes one or more processors, such as processor 3504. Processor 3504 may be, for example, a special purpose processor, general purpose processor, microprocessor, or digital signal processor. Processor 3504 may be connected to a communication infrastructure 3502 (for example, a bus or network). Computer system 3500 may also include a main memory 3506, such as random access memory (RAM), and may also include a secondary memory 3508.

Secondary memory 3508 may include, for example, a hard disk drive 3510 and/or a removable storage drive 3512, representing a magnetic tape drive, an optical disk drive, or the like. Removable storage drive 3512 may read from and/or write to a removable storage unit 3516 in a well-known manner. Removable storage unit 3516 represents a magnetic tape, optical disk, or the like, which is read by and written to by removable storage drive 3512. As will be appreciated by persons skilled in the relevant art(s), removable storage unit 3516 includes a computer usable storage medium having stored therein computer software and/or data.

In alternative implementations, secondary memory 3508 may include other similar means for allowing computer programs or other instructions to be loaded into computer system 3500. Such means may include, for example, a removable storage unit 3518 and an interface 3514. Examples of such means may include a program cartridge and cartridge interface (such as that found in video game devices), a removable memory chip (such as an EPROM or PROM) and associated socket, a thumb drive and USB port, and other removable storage units 3518 and interfaces 3514 which allow software and data to be transferred from removable storage unit 3518 to computer system 3500.

Computer system 3500 may also include a communications interface 3520. Communications interface 3520 allows software and data to be transferred between computer system 3500 and external devices. Examples of communications interface 3520 may include a modem, a network interface (such as an Ethernet card), a communications port, etc. Software and data transferred via communications interface 3520 are in the form of signals which may be electronic, electromagnetic, optical, or other signals capable of being received by communications interface 3520. These signals are provided to communications interface 3520 via a communications path 3522. Communications path 3522 carries signals and may be implemented using wire or cable, fiber optics, a phone line, a cellular phone link, an RF link, and other communications channels.

As used herein, the terms “computer program medium” and “computer readable medium” are used to refer to tangible storage media, such as removable storage units 3516 and 3518 or a hard disk installed in hard disk drive 3510. These computer program products are means for providing software to computer system 3500. Computer programs (also called computer control logic) may be stored in main memory 3506 and/or secondary memory 3508. Computer programs may also be received via communications interface 3520. Such computer programs, when executed, enable the computer system 3500 to implement the present disclosure as discussed herein. In particular, the computer programs, when executed, enable processor 3504 to implement the processes of the present disclosure, such as any of the methods described herein. Accordingly, such computer programs represent controllers of the computer system 3500.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the art.

What is claimed is:

1. A method comprising:
determining first symbols and second symbols available for prediction of respective first and second motion vector difference (MVD) components of a first reference picture list (RPL) and a second RPL, respectively;
selecting, based on the first and the second symbols available for prediction, one of the first RPL or the second RPL;
selecting, within each of the first MVD components of the selected RPL, a subset of most significant symbols for decoding;
entropy decoding, from a bitstream for each symbol of the selected subset, an indication of whether a value of the each symbol is equal to a value of a corresponding symbol of an MVD predictor; and
determining, for the each symbol of the selected subset, a value of the each symbol based on the indication and a value of the corresponding symbol of the MVD predictor.

2. The method of claim 1, wherein the selecting, based on the first and the second symbols available for prediction, further comprises selecting the first RPL, among the first RPL and the second RPL, based on a number of the first symbols available for prediction being greater than a number of the second symbols available for prediction.

3. The method of claim 2, wherein the selecting, based on the first and the second symbols available for prediction, further comprises:
selecting, from the first symbols, a first number of first candidate symbols having the highest symbol positions of first symbol positions of the first MVD components of the first RPL; and
selecting, from the second symbols, a second number of second candidate symbols having the highest symbol positions of second symbol positions of the second MVD components of the second RPL.

4. The method of claim 3, wherein the selecting, based on the first and the second symbols available for prediction, further comprises:
calculating a first prediction capacity of the first candidate symbols based on respective symbol positions of the first candidate symbols;
calculating a second prediction capacity of the second candidate symbols based on respective symbol positions of the second candidate symbols; and
wherein the first RPL is selected based on the first prediction capacity being greater than the second prediction capacity.

5. The method of claim 4, wherein the calculating the first prediction capacity comprises summing first weights of the first candidate symbols determined based on the respective symbol positions of the first candidate symbols, and wherein the calculating the second prediction capacity comprises summing second weights of the second candidate symbols determined based on the respective symbol positions of the second candidate symbols.

6. The method of claim 1, further comprising:
determining MVD candidates based on one or more symbols of the MVD to be decoded;
determining template matching costs for the MVD candidates, wherein each template matching cost is between a current template, of a current block, and a reference template of a reference block (RB) candidate indicated by a respective MVD candidate of the MVD candidates; and
selecting one of the MVD candidates as the MVD predictor based on the template matching costs.

7. The method of claim 1, wherein the first and second MVD components indicate a first and a second reference block, and wherein the method further comprises:
decoding a current block based on a prediction block generated from a combination of the first and second reference blocks.

8. A decoder comprising:
one or more processors; and
memory storing instructions that, when executed by the one or more processors, cause the decoder to:
determine first symbols and second symbols available for prediction of respective first and second motion vector difference (MVD) components of a first reference picture list (RPL) and a second RPL, respectively;
select, based on the first and the second symbols available for prediction, one of the first RPL or the second RPL;
select, within each of the first MVD components of the selected RPL, a subset of most significant symbols for decoding;
entropy decode, from a bitstream for each symbol of the selected subset, an indication of whether a value of the each symbol is equal to a value of a corresponding symbol of an MVD predictor; and
determine, for the each symbol of the selected subset, a value of the each symbol based on the indication and a value of the corresponding symbol of the MVD predictor.

9. The decoder of claim 8, wherein to select the one of the first RPL or the second RPL, the instructions further cause the decoder to:
select the first RPL, among the first RPL and the second RPL, based on a number of the first symbols available for prediction being greater than a number of the second symbols available for prediction.

10. The decoder of claim 9, wherein to select the one of the first RPL or the second RPL, the instructions further cause the decoder to:
select, from the first symbols, a first number of first candidate symbols having the highest symbol positions of first symbol positions of the first MVD components of the first RPL; and
select, from the second symbols, a second number of second candidate symbols having the highest symbol positions of second symbol positions of the second MVD components of the second RPL.

11. The decoder of claim 10, wherein to select the one of the first RPL or the second RPL, the instructions further cause the decoder to:
calculate a first prediction capacity of the first candidate symbols based on respective symbol positions of the first candidate symbols;
calculate a second prediction capacity of the second candidate symbols based on respective symbol positions of the second candidate symbols; and
wherein the first RPL is selected based on the first prediction capacity being greater than the second prediction capacity.

12. The decoder of claim 11, wherein the calculating the first prediction capacity comprises summing first weights of the first candidate symbols determined based on the respective symbol positions of the first candidate symbols, and wherein the calculating the second prediction capacity comprises summing second weights of the second candidate symbols determined based on the respective symbol positions of the second candidate symbols.

13. The decoder of claim 8, wherein the instructions further cause the decoder to:
determine MVD candidates based on one or more symbols of the MVD to be decoded;
determine template matching costs for the MVD candidates, wherein each template matching cost is between a current template, of a current block, and a reference template of a reference block (RB) candidate indicated by a respective MVD candidate of the MVD candidates; and
select one of the MVD candidates as the MVD predictor based on the template matching costs.

14. The decoder of claim 8, wherein the first and second MVD components indicate a first and a second reference block, and wherein the instructions further cause the decoder to:
decode a current block based on a prediction block generated from a combination of the first and second reference blocks.

15. A non-transitory computer-readable medium comprising instructions that, when executed by one or more processors of a decoder, cause the decoder to:
determine first symbols and second symbols available for prediction of respective first and second motion vector difference (MVD) components of a first reference picture list (RPL) and a second RPL, respectively;
select, based on the first and the second symbols available for prediction, one of the first RPL or the second RPL;
select, within each of the first MVD components of the selected RPL, a subset of most significant symbols for decoding;
entropy decode, from a bitstream for each symbol of the selected subset, an indication of whether a value of the each symbol is equal to a value of a corresponding symbol of an MVD predictor; and
determine, for the each symbol of the selected subset, a value of the each symbol based on the indication and a value of the corresponding symbol of the MVD predictor.

16. The non-transitory computer-readable medium of claim 15, wherein to select the one of the first RPL or the second RPL, the instructions further cause the decoder to:
select the first RPL, among the first RPL and the second RPL, based on a number of the first symbols available for prediction being greater than a number of the second symbols available for prediction.

17. The non-transitory computer-readable medium of claim 16, wherein to select the one of the first RPL or the second RPL, the instructions further cause the decoder to:
select, from the first symbols, a first number of first candidate symbols having the highest symbol positions of first symbol positions of the first MVD components of the first RPL; and
select, from the second symbols, a second number of second candidate symbols having the highest symbol positions of second symbol positions of the second MVD components of the second RPL.

18. The non-transitory computer-readable medium of claim 17, wherein to select the one of the first RPL or the second RPL, the instructions further cause the decoder to:
calculate a first prediction capacity of the first candidate symbols based on respective symbol positions of the first candidate symbols;
calculate a second prediction capacity of the second candidate symbols based on respective symbol positions of the second candidate symbols; and
wherein the first RPL is selected based on the first prediction capacity being greater than the second prediction capacity.

19. The non-transitory computer-readable medium of claim 18, wherein the calculating the first prediction capacity comprises summing first weights of the first candidate symbols determined based on the respective symbol positions of the first candidate symbols, and wherein the calculating the second prediction capacity comprises summing second weights of the second candidate symbols determined based on the respective symbol positions of the second candidate symbols.

20. The non-transitory computer-readable medium of claim 15, wherein the first and second MVD components indicate a first and a second reference block, and wherein the instructions further cause the decoder to:
decode a current block based on a prediction block generated from a combination of the first and second reference blocks.
